(19) United States
(12) Patent Application Publication
(10) Pub. No.: US 2014/0188451 A1
(43) Pub. Date: Jul. 3, 2014

(54) DISTRIBUTED PROCESSING MANAGEMENT SERVER, DISTRIBUTED SYSTEM AND DISTRIBUTED PROCESSING MANAGEMENT METHOD

(71) Applicants: Masato Asahara, Tokyo (JP); Shinji Nakadai, Tokyo (JP)

(72) Inventors: Masato Asahara, Tokyo (JP); Shinji Nakadai, Tokyo (JP)

(73) Assignee: NEC CORPORATION, Tokyo (JP)

(21) Appl. No.: 14/234,779

(22) PCT Filed: Jul. 31, 2012
(86) PCT No.: PCT/JP2012/069936

§ 371 Date: Jan. 24, 2014

(30) Foreign Application Priority Data
Aug. 1, 2011 (JP) 2011-168203

(51) Int. Cl. H04L 12/24

(52) U.S. Cl. CPC H04L 41/145
USPC 703/13

(57) ABSTRACT

Information for determining a data transfer route which maximizes a total amount of data processed on all of processing servers per unit time is generated.

A distributed processing management server generates a network model in which a device in a network and a piece of data to be processed is respectively represented by a node, the node representing the piece of data and the node representing a data server storing the piece of data are connected by an edge, the nodes representing the device in the network are connected by an edge, and an available bandwidth for a communication channel among the devices are set as a restriction of the edge connecting the nodes representing the devices, and generates, when one or more pieces of data are specified, data-flow information that indicates a route between a processing server and each of the specified pieces of data and a data-flow rate of the route to maximize a total amount of data received per unit time by at least a part of the processing servers indicated by a set of processing server identifiers, on the basis of the network model.

### TECHNICAL FIELD

The present invention relates to a management technique of distributed processing of data in a system in which a server storing data and a server for processing the data are arranged in a distributed manner.

### BACKGROUND ART

Non-patent literatures 1 to 3 disclose a distributed system which determines a calculation server which processes data stored in a plurality of computers. This distributed system determines communication routes of all data by determining an available calculation server which is nearest neighbor to a computer storing each data, sequentially.

Patent literature 1 discloses a system which moves a relay server used for transmission processing when transmitting data stored in one computer to one client. This system calculates a data transfer time between each computer and each client which is taken to transmit the data and moves the relay server based on the calculated data transfer time.

Patent literature 2 discloses a system which divides a file according to line speed and load status of a transfer route in which the file is transmitted at the time of a file transfer from a file transfer source machine to a file transfer destination machine, and transmits the divided file.

Patent literature 3 discloses a stream processing device which determines allocation of resources with a sufficient utilization ratio for a short time to a stream input/output request to which various speeds are specified.

Patent literature 4 discloses a system which changes shares of a plurality of I/O nodes, which access a file system storing data, dynamically according to an execution process of a job, to a plurality of computers.

### CITATION LIST

### Non-Patent Literature

[Non-patent literature 1] Jeffrey Dean and Sanjay Ghemawat, “MapReduce: Simplified Data Processing on Large Clusters”, Proceedings of the sixth Symposium on Operating System Design and Implementation (OSDI'04), Dec. 6, 2004
[Non-patent literature 2] Sanjay Ghemawat, Howard Gobioff, and Shun-Tak Leung, “The Google File System”, Proceedings of the nineteenth ACM symposium on Operatingsystems principles (SOSP'03), Oct. 19, 2003
[Non-patent literature 3] Keisuke Nishida, Technology supporting Google, p. 74 and p. 136 to p. 163, Apr. 25, 2008

### Patent Literature

[Patent literature 1] Japanese Patent Application Laid-Open No. H8-202726
[Patent literature 2] Japanese Patent Publication No. 3390406
[Patent literature 3] Japanese Patent Application Laid-Open No. H8-147234
[Patent literature 4] Japanese Patent Publication No. 4569846

### SUMMARY OF INVENTION

### Technical Problem

The technology of the above-mentioned patent literatures and non-patent literatures cannot generate information for determining a transfer route of data, which maximizes a total amount of data processed on all the processing servers per unit time in a system in which a plurality of data servers storing data, and a plurality of processing servers which can process the data are arranged in a distributed manner.

The reason is as follows. The technology of patent literatures 1 and 2 only minimizes a transfer time in one to one data transfer. The technology of non-patent literatures 1 to 3 only minimizes a one to one data transfer, sequentially. The technology of patent literature 3 only discloses a one-to-many data transfer technology. The technology of patent literature 4 only determines a share of a required I/O node needed to access the file system.

In other words, the reason of the above-mentioned problem is because the technologies disclosed in the above-mentioned patent literatures and non-patent literatures do not take into consideration a total amount of data processed in the whole processing servers per unit time in a system in which data are transmitted from a plurality of data servers to a plurality of processing servers.

An object of the present invention is to provide a distributed processing management server, a distributed system, a storage medium and a distributed processing management method which can solve the above-mentioned problem.

### Solution to Problem

A first distributed processing management server according to an exemplary aspect of the invention includes: a model generation means for generating a network model in which a device in a network and a piece of data to be processed is respectively represented by a node, the node representing the piece of data and the node representing a data server storing the piece of data are connected by an edge, the nodes representing the device in the network are connected by an edge, and an available bandwidth for a communication channel among the devices are set as a restriction of the edge connecting the nodes representing the devices; and an optimum arrangement calculation means for generating, when one or more pieces of data are specified, data-flow information that indicates a route between a processing server and each of the specified pieces of data and a data-flow rate of the route to maximize a total amount of data received per unit time by at least a part of the processing servers indicated by a set of processing server identifiers, on the basis of the network model.

A first distributed system according to an exemplary aspect of the invention includes: a data server for storing a piece of data; a processing server for processing the piece of data; and a distributed processing management server, wherein the distributed processing management server includes: a model generation means for generating a network model in which a device in a network and the piece of data to be processed is respectively represented by a node, the node representing the piece of data and the node representing the data server storing the piece of data are connected by an edge, the nodes representing the device in the network are connected by an edge, and an available bandwidth for a communication channel among the devices are set as a restriction of the edge connecting the nodes representing the devices; an optimum arrangement calculation means for generating, when one or more pieces of data are specified, data-flow information that indicates a route between the processing server and each of the specified pieces of data and a data-flow rate of the route to maximize a total amount of data received per unit time by at least a part of the processing servers indicated by a set of processing server identifiers, on the basis of the network model; and a processing allocation means for transmitting decision information indicating the piece of data to be acquired by the processing server and a data processing amount per unit time to the processing server on the basis of the data-flow information generated by the optimum arrangement calculation means, the processing server includes a processing execution means for receiving the piece of data specified by the decision information from the data server via a route based on the decision information, with a speed indicated by a data amount per unit time based on the decision information, and executing the received piece of data, and the data server includes a processing data storing means for storing the piece of data.

A first distributed processing management method according to an exemplary aspect of the invention includes: generating a network model in which a device in a network and a piece of data to be processed is respectively represented by a node, the node representing the piece of data and the node representing a data server storing the piece of data are connected by an edge, the nodes representing the device in the network are connected by an edge, and an available bandwidth for a communication channel among the devices are set as a restriction of the edge connecting the nodes representing the devices; and generating, when one or more pieces of data are specified, data-flow information that indicates a route between a processing server and each of the specified pieces of data and a data-flow rate of the route to maximize a total amount of data received per unit time by at least a part of the processing servers indicated by a set of processing server identifiers, on the basis of the network model.

A first distributed processing method according to an exemplary aspect of the invention includes: generating a network model in which a device in a network and a piece of data to be processed is respectively represented by a node, the node representing the piece of data and the node representing a data server storing the piece of data are connected by an edge, the nodes representing the device in the network are connected by an edge, and an available bandwidth for a communication channel among the devices are set as a restriction of the edge connecting the nodes representing the devices; generating, when one or more pieces of data are specified, data-flow information that indicates a route between a processing server and each of the specified pieces of data and a data-flow rate of the route to maximize a total amount of data received per unit time by at least a part of the processing servers indicated by a set of processing server identifiers, on the basis of the network model; transmitting decision information indicating the piece of data to be acquired by the processing server and a data processing amount per unit time to the processing server on the basis of the generated data-flow information; and receiving the piece of data specified by the decision information from the data server via a route based on the decision information, with a speed indicated by a data amount per unit time based on the decision information, and executing the received piece of data, in the processing server.

A first computer readable storage medium according to an exemplary aspect of the invention records thereon a distributed processing management program, causing a computer to perform a method including: generating a network model in which a device in a network and a piece of data to be processed is respectively represented by a node, the node representing the piece of data and the node representing a data server storing the piece of data are connected by an edge, the nodes representing the device in the network are connected by an edge, and an available bandwidth for a communication channel among the devices are set as a restriction of the edge connecting the nodes representing the devices; and generating, when one or more pieces of data are specified, data-flow information that indicates a route between a processing server and each of the specified pieces of data and a data-flow rate of the route to maximize a total amount of data received per unit time by at least a part of the processing servers indicated by a set of processing server identifiers, on the basis of the network model.

### Advantageous Effect of Invention

The present invention can generate information for determining a data transfer route which maximizes a total amount of data processed on all the processing servers per unit time in a system in which a plurality of data servers storing data and a plurality of processing servers which process the data are arranged in a distributed manner.

### BRIEF DESCRIPTION OF THE DRAWINGS

FIG. 1A is a schematic diagram showing a configuration of a distributed system 350 in a first exemplary embodiment.

FIG. 1B is a diagram showing an exemplary configuration of the distributed system 350.

FIG. 2A is a diagram showing an example of inefficient communication in the distributed system 350.

FIG. 2B is a diagram showing an example of efficient communication in the distributed system 350.

FIG. 3 is a diagram showing an example of a Table 220 indicating a bandwidth of each memory disk and a network.

FIG. 4 is a diagram showing a configuration of a distributed processing management server 300, a network switch 320, a processing server 330 and a data server 340.

FIG. 5 is a diagram exemplifying information stored in a data location storing unit 3070.

FIG. 6 is a diagram exemplifying information stored in an input/output communication channel information storing unit 3080.

FIG. 7 is a diagram exemplifying information stored in a server status storing unit 3060.

FIG. 8A is a diagram exemplifying a table of model information outputted by a model generation unit 301.

FIG. 8B is a conceptual diagram showing an example of model information generated by the model generation unit 301.

FIG. 9 is a diagram exemplifying a corresponding table of route information and a flow rate composing data-flow Fi outputted by an optimum arrangement calculation unit 302.

FIG. 10 is a diagram exemplifying a configuration of decision information determined by a processing allocation unit 303.

FIG. 11 is a flow chart showing whole operation of the distributed system 350.

FIG. 12 is a flow chart showing operation of the distributed processing management server 300 in Step S401.

FIG. 13 is a flow chart showing operation of the distributed processing management server 300 in Step S404.

FIG. 14 is a flow chart showing operation of the distributed processing management server 300 in Step S404-10 of Step S404.

FIG. 15 is a flow chart showing operation of the distributed processing management server 300 in Step S404-20 of Step S404.

FIG. 16 is a flow chart showing operation of the distributed processing management server 300 in Step S404-30 of Step S404.

FIG. 17 is a flow chart showing operation of the distributed processing management server 300 in Step S404-40 of Step S404.

FIG. 18A is a flow chart showing operation of the distributed processing management server 300 in Step S404-430 of Step S404-40.

FIG. 18B is a flow chart showing operation of the distributed processing management server 300 in Step S404-430 of Step S404-40.

FIG. 19 is a flow chart showing operation of the distributed processing management server 300 in step 404-50 of Step S404.

FIG. 20 is a flow chart showing operation of the distributed processing management server 300 in Step S405.

FIG. 21 is a flow chart showing operation of the distributed processing management server 300 in Step S406.

FIG. 22 is a flow chart showing operation of the distributed processing management server 300 in Step S404-20 in a second exemplary embodiment.

FIG. 23 is a flow chart showing operation of the distributed processing management server 300 in Step S404-30 in the second exemplary embodiment.

FIG. 24 is a flow chart showing operation of the distributed processing management server 300 in Step S404-40 in the second exemplary embodiment.

FIG. 25 is a flow chart showing operation of the distributed processing management server 300 in Step S406 in the second exemplary embodiment.

FIG. 26 is a flow chart showing operation of the distributed processing management server 300 in Step S404-50 in a third exemplary embodiment.

FIG. 27 is a block diagram showing a configuration of the distributed system 350 in a fourth exemplary embodiment.

FIG. 28A is a diagram exemplifying configuration information stored in a job information storing unit 3040.

FIG. 28B is a diagram exemplifying configuration information stored in a band limit information storing unit 3090.

FIG. 28C is a diagram exemplifying configuration information stored in a band limit information storing unit 3100.

FIG. 29 is a flow chart showing operation of the distributed processing management server 300 in Step S401 of the fourth exemplary embodiment.

FIG. 30 is a flow chart showing operation of the distributed processing management server 300 in Step S404 of the fourth exemplary embodiment.

FIG. 31 is a flow chart showing operation of the distributed processing management server 300 in Step S404-10-1 of the fourth exemplary embodiment.

FIG. 32 is a block diagram showing a configuration of the distributed system 350 in a fifth exemplary embodiment.

FIG. 33 is a flow chart showing an operation of the distributed processing management server 300 in Step S406 of the fifth exemplary embodiment.

FIG. 34 is a block diagram showing a configuration of the distributed processing management server 600 in a sixth exemplary embodiment.

FIG. 35 is a diagram showing an example of a set of identifiers of processing servers.

FIG. 36 is a diagram showing an example of a set of pieces of data location information.

FIG. 37 is a diagram showing an example of a set of pieces of input/output communication route information.

FIG. 38 is a diagram showing a hardware configuration of the distributed processing management server 600 and peripheral devices in the sixth exemplary embodiment.

FIG. 39 is a flow chart showing an outline of operation of the distributed processing management server 600 in the sixth exemplary embodiment.

FIG. 40 is a diagram showing a configuration of a distributed system 650 in a first modification of the sixth exemplary embodiment.

FIG. 41 is a block diagram showing a configuration of the distributed system 350 used in a specific example of the first exemplary embodiment.

FIG. 42 is a diagram showing an example of information stored in the server status storing unit 3060 in the distributed processing management server 300 in the specific example of the first exemplary embodiment.

FIG. 43 is a diagram showing an example of information stored in the input/output communication channel information storing unit 3080 provided in the distributed processing management server 300 in the specific example of the first exemplary embodiment.

FIG. 44 is a diagram showing an example of information stored in the data location storing unit 3070 in the distributed processing management server 300 in the specific example of the first exemplary embodiment.

FIG. 45 is a diagram showing a table of model information generated by the model generation unit 301 in the specific example of the first exemplary embodiment.

FIG. 46 is a conceptual diagram of a network (G, u, s, t) shown by the table of model information in FIG. 45 in the specific example of the first exemplary embodiment.

FIG. 47A is a diagram exemplifying a case when an objective function is maximized by using the flow increase method in the maximum flow problem in the specific example of the first exemplary embodiment.

FIG. 47B is a diagram exemplifying the case when the objective function is maximized by using the flow increase method in the maximum flow problem in the specific example of the first exemplary embodiment.

FIG. 47C is a diagram exemplifying the case when the objective function is maximized by using the flow increase method in the maximum flow problem in the specific example of the first exemplary embodiment.

FIG. 47D is a diagram exemplifying the case when the objective function is maximized by using the flow increase method in the maximum flow problem in the specific example of the first exemplary embodiment.

FIG. 47E is a diagram exemplifying the case when the objective function is maximized by using the flow increase method in the maximum flow problem in the specific example of the first exemplary embodiment.

FIG. 47F is a diagram exemplifying the case when the objective function is maximized by using the flow increase method in the maximum flow problem in the specific example of the first exemplary embodiment.

FIG. 47G is a diagram exemplifying the case when the objective function is maximized by using the flow increase method in the maximum flow problem in the specific example of the first exemplary embodiment.

FIG. 48 is a diagram showing data-flow information obtained as a result of maximization of the objective function in the specific example of the first exemplary embodiment.

FIG. 49 is a diagram showing an example of data transmission/reception determined based on the data-flow information of FIG. 48.

FIG. 50 is a diagram showing a configuration of the distributed system 350 used in a specific example of the second exemplary embodiment.

FIG. 51 is a diagram showing an example of information stored in the data location storing unit 3070 in the distributed processing management server 300.

FIG. 52 is a diagram showing a table of model information generated by the model generation unit 301 in the specific example of the second exemplary embodiment.

FIG. 53 is a conceptual diagram of a network (G, u, s, t) shown by the table of model information in FIG. 52.

FIG. 54A is a diagram exemplifying a case when the objective function is maximized by using the flow increase method in the maximum flow problem in the specific example of the second exemplary embodiment.

FIG. 54B is the case when the objective function is maximized by using the flow increase method in the maximum flow problem in the specific example of the second exemplary embodiment.

FIG. 54C is the case when the objective function is maximized by using the flow increase method in the maximum flow problem in the specific example of the second exemplary embodiment.

FIG. 54D is the case when the objective function is maximized by using the flow increase method in the maximum flow problem in the specific example of the second exemplary embodiment.

FIG. 54E is the case when the objective function is maximized by using the flow increase method in the maximum flow problem in the specific example of the second exemplary embodiment.

FIG. 54F is the case when the objective function is maximized by using the flow increase method in the maximum flow problem in the specific example of the second exemplary embodiment.

FIG. 54G is the case when the objective function is maximized by using the flow increase method in the maximum flow problem in the specific example of the second exemplary embodiment.

FIG. 55 is a diagram showing data flow information obtained as a result of maximization of the objective function in the specific example of the second exemplary embodiment.

FIG. 56 is a diagram showing an example of data transmission/reception determined based on the data flow information of FIG. 55.

FIG. 57 is a diagram showing an example of information stored in the server status storing unit 3060 in the distributed processing management server 300.

FIG. 58 is a diagram showing a table of model information generated by the model generation unit 301 in a specific example of the third exemplary embodiment.

FIG. 59 is a conceptual diagram of the network (G, u, s, t) shown by the table of model information in FIG. 58.

FIG. 60A is a diagram exemplifying a case when the objective function is maximized by using the flow increase method in the maximum flow problem in the specific example of the third exemplary embodiment.

FIG. 60B is a diagram exemplifying the case when the objective function is maximized by using the flow increase method in the maximum flow problem in the specific example of the third exemplary embodiment.

FIG. 60C is a diagram exemplifying the case when the objective function is maximized by using the flow increase method in the maximum flow problem in the specific example of the third exemplary embodiment.

FIG. 60D is a diagram exemplifying the case when the objective function is maximized by using the flow increase method in the maximum flow problem in the specific example of the third exemplary embodiment.

FIG. 60E is a diagram exemplifying the case when the objective function is maximized by using the flow increase method in the maximum flow problem in the specific example of the third exemplary embodiment.

FIG. 60F is a diagram exemplifying the case when the objective function is maximized by using the flow increase method in the maximum flow problem in the specific example of the third exemplary embodiment.

FIG. 60G is a diagram exemplifying the case when the objective function is maximized by using the flow increase method in the maximum flow problem in the specific example of the third exemplary embodiment.

FIG. 61 is a diagram showing data flow information obtained as a result of the maximization of the objective function in the specific example of the third exemplary embodiment.

FIG. 62 is a diagram showing an example of data transmission/reception determined based on the data flow information of FIG. 61.

FIG. 63 is a diagram showing a configuration of the distributed system 350 used in a specific example of the fourth exemplary embodiment.

FIG. 64 is a diagram showing an example of information stored in the server status storing unit 3060 in the distributed processing management server 300.

FIG. 65 is a diagram showing an example of information stored in the job information storing unit 3040 in the distributed processing management server 300.

FIG. 66 is a diagram showing an example of information stored in the data location storing unit 3070 in the distributed processing management server 300.

FIG. 67 is a diagram showing a table of model information generated by the model generation unit 301 in the specific example of the fourth exemplary embodiment.

FIG. 68 is a conceptual diagram of the network (G, l, u, s, t) shown by the table of model information in FIG. 67.

FIG. 69A is a diagram showing an example of a calculation procedure of an initial flow which satisfies a lower limit flow rate restriction.

FIG. 69B is a diagram showing an example of the calculation procedure of an initial flow which satisfies a lower limit flow rate restriction.

FIG. 69C is a diagram showing an example of the calculation procedure of an initial flow which satisfies a lower limit flow rate restriction.

FIG. 69D is a diagram showing an example of the calculation procedure of an initial flow which satisfies a lower limit flow rate restriction.

FIG. 69E is a diagram showing an example of the calculation procedure of an initial flow which satisfies a lower limit flow rate restriction.

FIG. 69F is a diagram showing an example of the calculation procedure of an initial flow which satisfies a lower limit flow rate restriction.

FIG. 70A is a diagram exemplifying a case when the objective function is maximized by using the flow increase method in the maximum flow problem in the specific example of the fourth exemplary embodiment.

FIG. 70B is a diagram exemplifying the case when the objective function is maximized by using the flow increase method in the maximum flow problem in the specific example of the fourth exemplary embodiment.

FIG. 70C is a diagram exemplifying the case when the objective function is maximized by using the flow increase method in the maximum flow problem in the specific example of the fourth exemplary embodiment.

FIG. 70D is a diagram exemplifying the case when the objective function is maximized by using the flow increase method in the maximum flow problem in the specific example of the fourth exemplary embodiment.

FIG. 70E is a diagram exemplifying the case when the objective function is maximized by using the flow increase method in the maximum flow problem in the specific example of the fourth exemplary embodiment.

FIG. 70F is a diagram exemplifying the case when the objective function is maximized by using the flow increase method in the maximum flow problem in the specific example of the fourth exemplary embodiment.

FIG. 71 is a diagram showing data-flow information obtained as a result of the maximization of the objective function in the specific example of the fourth exemplary embodiment.

FIG. 72 shows an example of data transmission/reception determined based on the data flow information of FIG. 71.

FIG. 73 shows an example of information stored by the input/output communication channel information storing unit 3080 in a specific example of the fifth exemplary embodiment.

### DESCRIPTION OF EMBODIMENTS

Next, exemplary embodiments of the present will be described in detail with reference to a drawing. Note that, the same reference sign is given to components having the similar function in each exemplary embodiment described in each drawing and a specification.

### First Exemplary Embodiment

First, an outline of a configuration and an operation of a distributed system 350 in a first exemplary embodiment and a point of difference with a related technology of the distributed system 350 will be described.

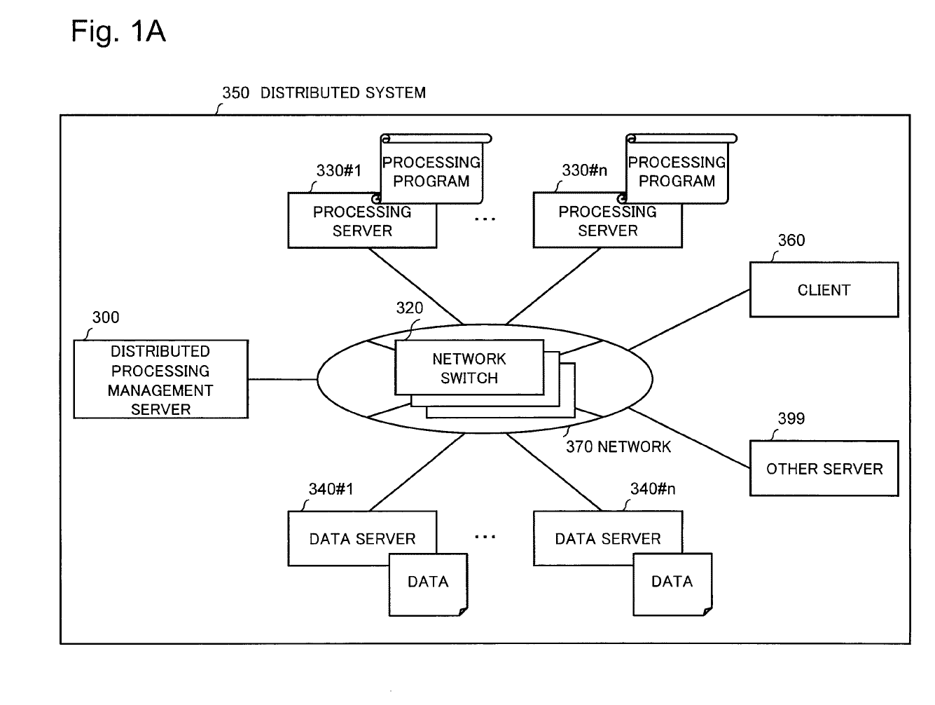

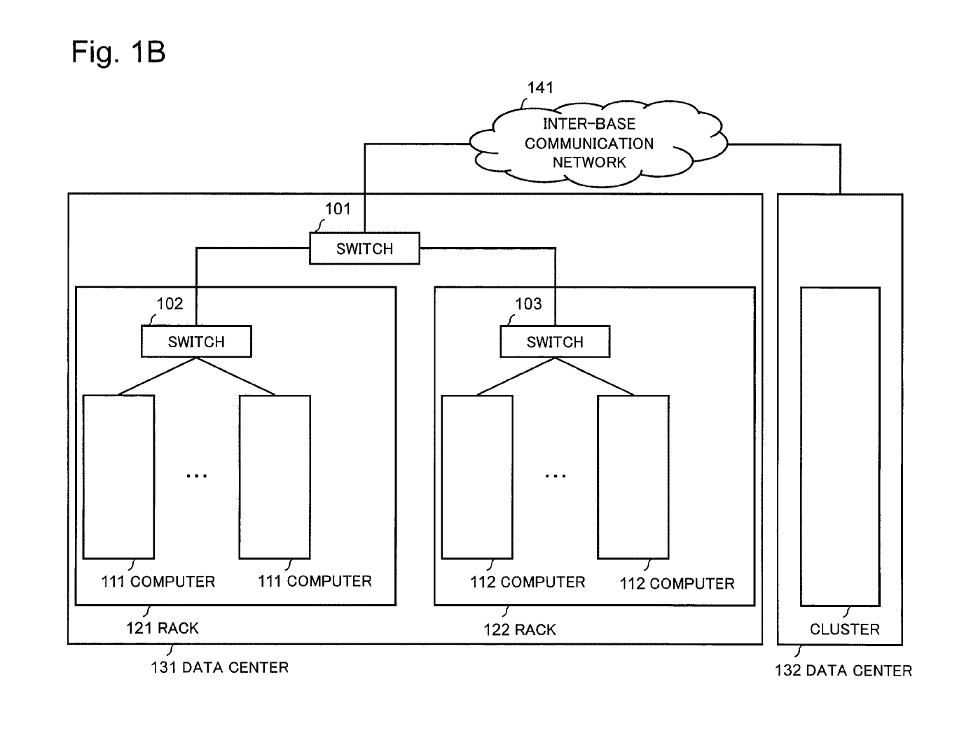

FIG. 1A is a schematic diagram showing a configuration of a distributed system 350 in a first exemplary embodiment. The distributed system 350 includes a distributed processing management server 300, a network switch 320, a plurality of processing servers 330#1 to 330#n and a plurality of data servers 340#1 to 340#n, and they are connected by a network 370. The distributed system 350 may include a client 360 and other server 399.

In this specification, the data servers 340#1 or 340#n are collectively represented by a data server 340. The processing servers 330#1 to 330#n are collectively represented by a processing server 330.

The data server 340 stores data to be processed by the processing server 330. The processing server 330 receives the data from the data server 340, and processes the data by executing a processing program to the received data.

The client 360 transmits request information which is information for requesting a start of data processing to the distributed processing management server 300. The request information includes a processing program and data which the processing program uses. This data is a logical data set, partial data, a data element, or a set of them, for example. The logical data set, the partial data, and the data element are described later. The distributed processing management server 300 determines the processing server 330 by which one or more pieces of data is processed among pieces of data stored in the data server 340, for each piece of data. And the distributed processing management server 300 generates decision information including information which shows the data and the data server 340 storing the data and including information which shows a data processing amount per unit time, for each processing server 330 which processes data, and outputs the decision information. The data server 340 and the processing server 330 transmit and receive data based on the decision information. The processing server 330 processes the received data.

Here, the distributed processing management server 300, the processing server 330, the data server 340 and the client 360 may be devices for exclusive use respectively, or may be general-purpose computers. One device or computer may possess a plurality of functions among the distributed processing management server 300, the processing server 330, the data server 340 and the client 360. Hereinafter, one device and computer are collectively represented as a computer or the like. The distributed processing management server 300, the processing server 330, the data server 340 and the client 360 are collectively also represented as “distributed processing management server 300 or the like”. In many cases, one computer or the like functions as both of the processing server 330 and the data server 340.

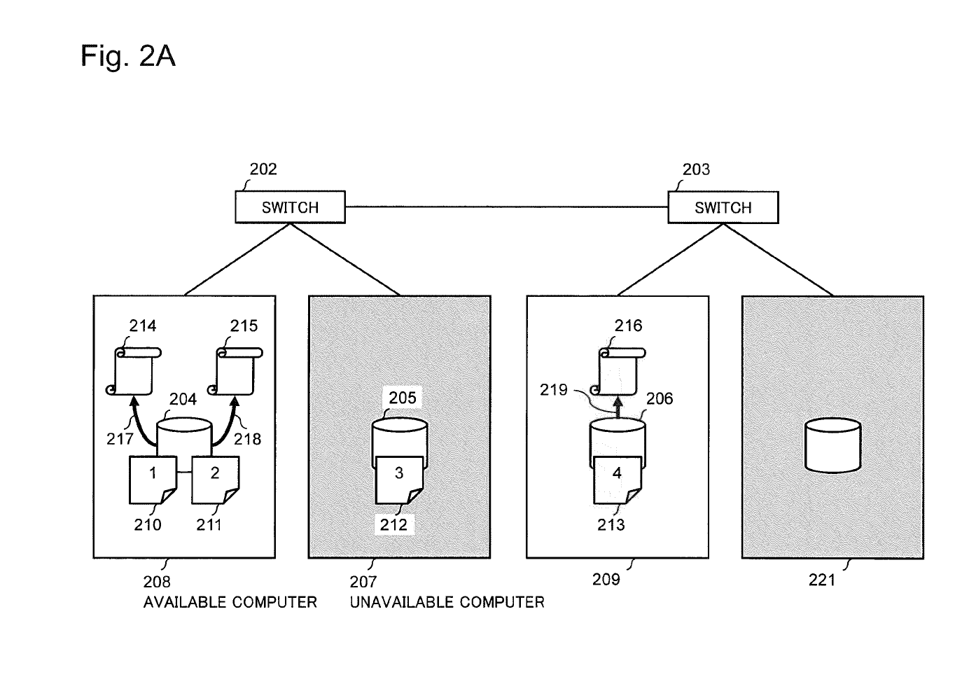

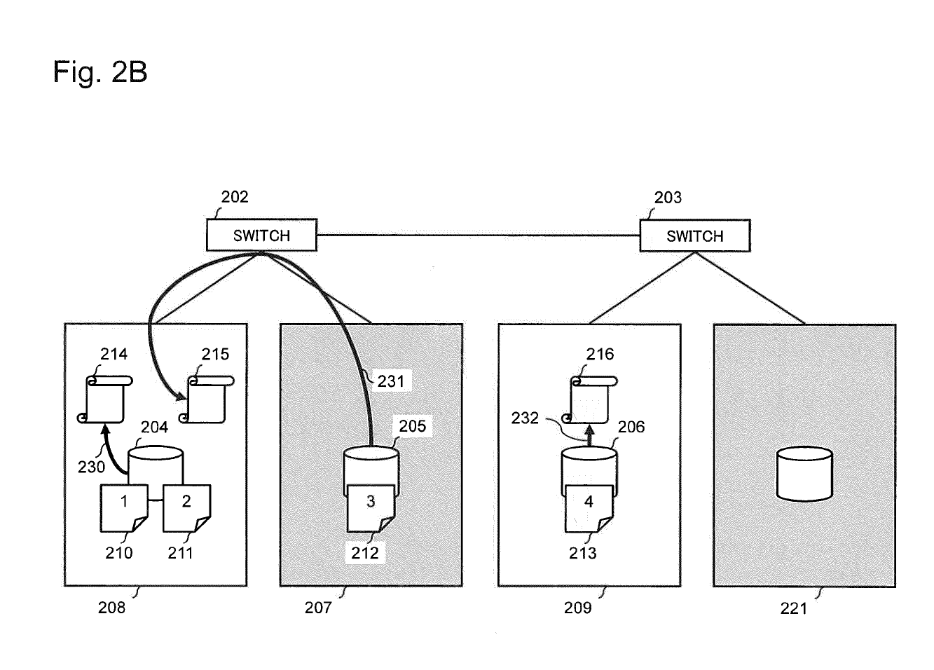

FIG. 1B, FIG. 2A and FIG. 2B are diagrams showing exemplary configurations of the distributed system 350. In these diagrams, the processing server 330 and the data server 340 are described as computers. The network 370 is described as data transmission/reception routes via switches. The distributed processing management server 300 is not specified.

In FIG. 1B, for example, the distributed system 350 includes computers 111 and 112 and the switches 101 to 103 connecting them. The computers and the switches are accommodated in racks 121 and 122. The racks 121 and 122 are accommodated in data centers 131 and 132. The data centers 131 and 132 are connected by an inter-base communication network 141.

FIG. 1B exemplifies the distributed system 350 which connected the switch and the computers in a star form. FIG. 2A and FIG. 2B exemplify the distributed system 350 including the switches connected in cascade.

FIG. 2A and FIG. 2B show an example of data transmission/reception between the data server 340 and the processing server 330. In two diagrams, computers 207 to 209 function as the data server 340, and the computers 208 and 209 also function as the processing servers 330. Note that a computer 221 functions as the distributed processing management server 300 in those diagrams, for example.

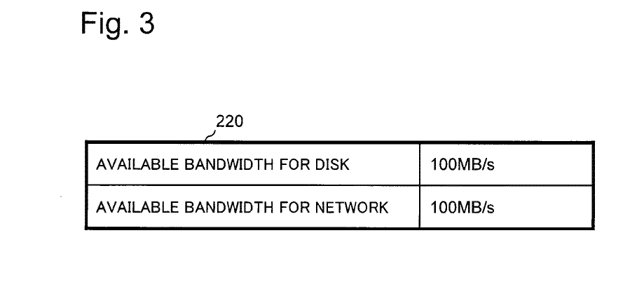

In FIG. 2A and FIG. 2B, a computer besides the computers 208 and 209, among computers connected by the switches 202 and 203, is performing other processing, and use for further data processing is impossible. The unavailable computer 207 stores data 212 to be processed in a memory disk 205. On the other hand, the available computer 208 for further data processing stores data 210 and 211 to be processed in a memory disk 204. Similarly, the available computer 209 stores data 213 to be processed in a memory disk 206. The available computer 208 is executing processes 214 and 215 in parallel. And the available computer 209 is executing a process 216. Available bandwidths of each memory disk and the network are as shown in a table 220 in FIG. 3.

That is, referring to the table 220 in FIG. 3, the available bandwidth of each memory disk is 100 MB/s, and that of the network is 100 MB/s. It is assumed that the available bandwidth of the above-mentioned memory disk is assigned equally to each of the data transmission/reception routes connected to the memory disks in this case. It is also assumed that the available bandwidth of the above-mentioned network is assigned equally to each of the data transmission/reception routes connected to the switches in this case.

In FIG. 2A, the data 210 to be processed is transmitted via a data transmission/reception route 217, and is processed in the available computer 208. The data 211 to be processed is transmitted via a data transmission/reception route 218, and is processed in the available computer 208. The data 213 to be processed is transmitted via a data transmission/reception route 219, and is processed in the available computer 209. The data 212 to be processed is not allocated to any process and is in a standby state.

On the other hand, in FIG. 2B, the data 210 to be processed is transmitted via a data transmission/reception route 230, and is processed in the available computer 208. The data 212 to be processed is transmitted via a data transmission/reception route 231, and is processed in the available computer 208. The data 213 to be processed is transmitted via a data transmission/reception route 232, and is processed in the available computer 209. The data 211 to be processed is not allocated to any process and is in a standby state.

The total throughput of the data transmission/reception in FIG. 2A is the sum of 50 MB/s of the data transmission/reception route 217, 50 MB/s of the data transmission/reception route 218 and 100 MB/s of the data transmission/reception route 219 and is 200 MB/s. On the other hand, the total throughput of the data transmission/reception in FIG. 2B is the sum of 100 MB/s of the data transmission/reception route 230, 100 MB/s of the data transmission/reception route 231 and 100 MB/s of the data transmission/reception route 232 and is 300 MB/s. The data transmission/reception in FIG. 2B is high in total throughput compared with the data transmission/reception in FIG. 2A, and is efficient.

A system which determines a computer performing data transmission/reception based on a constitutive distance (the number of hops, for example) sequentially for each piece of data to be processed may perform inefficient transmission/reception as shown in FIG. 2A. This is because other system in relation to the present invention determines a data transmission/reception route only by the constitutive distance without considering an available bandwidth for a memory disk and a network.

In conditions exemplified in FIG. 2A and FIG. 2B, the distributed system 350 of this exemplary embodiment increases the possibility of performing the efficient data transmission/reception shown in FIG. 2B.

Hereinafter, each component in the distributed system 350 in the first exemplary embodiment will be described.

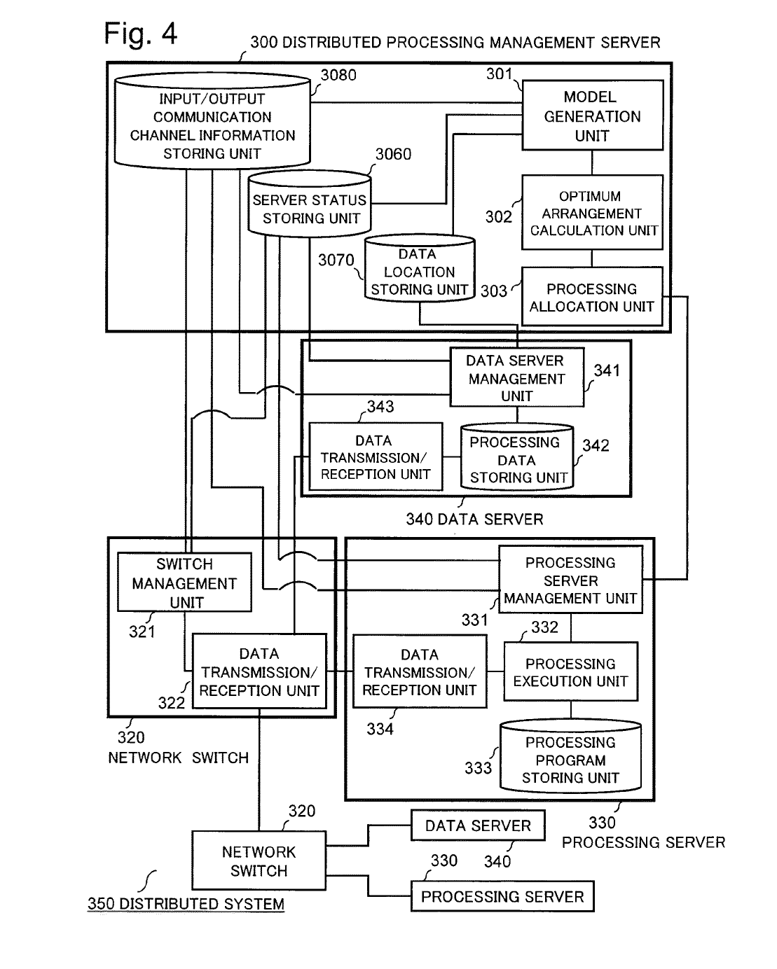

FIG. 4 is a diagram showing a configuration of the distributed processing management server 300, the network switch 320, the processing server 330 and the data server 340. When one computer or the like has a plurality of functions among the distributed processing management server 300 or the like, for example, a configuration of the computer or the like will be one in which at least a part of each of a plurality of configurations of the distributed processing management server 300 or the like is included. Here, the distributed processing management server 300, the network switch 320, the processing server 330 and the data server 340 are also collectively represented as a “distributed processing management server 300 or the like”. In this case, the computer or the like does not need to have a common component redundantly between “distributed processing management server 300 or the like”s, and may share it.

For example, when a certain server operates as the distributed processing management server 300 and the processing server 330, for example, a configuration of the server will be one including at least part of each configuration of the distributed processing management server 300 and the processing server 330.

<Processing Server 330>

The processing server 330 includes a processing server management unit 331, a processing execution unit 332, a processing program storing unit 333 and a data transmission/reception unit 334.

===Processing Server Management Unit 331===

The processing server management unit 331 makes the processing execution unit 332 execute processing, or manages a state of processing under currently executing in accordance with a processing allocation from the distributed processing management server 300.

Specifically, the processing server management unit 331 receives decision information including an identifier of a data element and an identifier of the processing data storing unit 342 of the data server 340 which is a storage location of the data element. The processing server management unit 331 transmits the received decision information to the processing execution unit 332. The decision information may be generated for each processing execution unit 332. The decision information may include a device ID indicating the processing execution unit 332, and the processing server management unit 331 may transmit the decision information to the processing execution unit 332 which is identified by the identifier included in the decision information. The processing execution unit 332 mentioned later receives data to be processed from the data server 340 based on the identifier of the data element and the identifier of the processing data storing unit 342 of the data server 340 which is the storage location of the data element, included in the received decision information, and executes processing to the data. A detailed description of the decision information is mentioned later.

The processing server management unit 331 stores information about a running state of a processing program which is used when the processing execution unit 332 processes data. The processing server management unit 331 updates the information about the running state of the processing program according to the change in the running state of the processing program. As a running state of a processing program, the following states are used. For example, as the running state of the processing program, there is “a state before execution” showing the state that although processing which allocates data in the processing execution unit 332 has ended, the processing execution unit 332 does not execute processing of the data yet. As a running state of a processing program, there is “a state during execution” showing the state that the processing execution unit 332 is executing the data. And, as a running state of a processing program, there is “an execution completion state” showing the state that the processing execution unit 332 has finished processing the data. A running state of a processing program may be the state defined on the basis of a ratio of a processed data amount by the processing execution unit 332 to the total data amount allocated to the processing execution unit 332.

The processing server management unit 331 transmits state information such as an available bandwidth for a disk of the processing server 330 and an available bandwidth for a network to the distributed processing management server 300.

===Processing Execution Unit 332===

The processing execution unit 332 receives data to be processed from the data server 340 via the data transmission/reception unit 334 in accordance with directions of the processing server management unit 331 and executes processing to the data. Specifically, the processing execution unit 332 receives an identifier of a data element and an identifier of the processing data storing unit 342 of the data server 340 which is a storage location of the data element, from the processing server management unit 331. And the processing execution unit 332 requests transmission of the data element indicated by the identifier of the data element received via the data transmission/reception unit 334 to the data server 340 corresponding to the received identifier of the processing data storing unit 342. Specifically, the processing execution unit 332 transmits request information for requesting the transmission of the data element. The processing execution unit 332 receives the data element transmitted based on the request information and executes processing to the data. A description of the data element is mentioned later.

A plurality of processing execution units 332 may exist in the processing server 330 in order to carry out a plurality of processing in parallel.

===Processing Program Storage Unit 333===The processing program storing unit 333 receives a processing program from the other server 399 or the client 360 and stores the processing program.

===Data transmission/reception Unit 334===

The data transmission/reception unit 334 transmits and receives data with other processing server 330 and the data server 340.

A processing server 330 receives the data to be processed, from the data server 340 specified by the distributed processing management server 300, via the data transmission/reception unit 343 of the data server 340, the data transmission/reception unit 322 of the network switch 320 and the data transmission/reception unit 334 of the processing server 330. The processing execution unit 332 of the processing server 330 processes the received data to be processed. When the processing server 330 is a computer or the like identical with the data server 340, the processing server 330 may receive the data to be processed directly from the processing data storing unit 342. The data transmission/reception unit 343 of the data server 340 and the data transmission/reception unit 334 of the processing server 330 may communicate directly without the data transmission/reception unit 322 of the network switch 320.

<Data Server 340>

The data server 340 includes a data server management unit 341 and a processing data storing unit 342.

===Data Server Management Unit 341===

The data server management unit 341 transmits location information on data stored by the processing data storing unit 342 and state information including an available bandwidth for a disk of the data server 340 and an available bandwidth for a network or the like, to the distributed processing management server 300. The processing data storing unit 342 stores data identified uniquely in the data server 340.

===Processing Data Storage Unit 342===

The processing data storing unit 342 includes, as a storage medium for storing data to be processed by the processing server 330, for example, one or a plurality of Hard Disc Drives (HDDs), Solid State Drives (SSDs), USB memories (Universal Serial Bus flash drives) and Random Access Memory (RAM) disks. The data stored in the processing data storing unit 342 may be one which the processing server 330 outputted or is outputting. The data stored in the processing data storing unit 342 may be one which the processing data storing unit 342 received from other server or the like or one which the processing data storing unit 342 read from a storage medium or the like.

===Data Transmission/reception Unit 343===

The data transmission/reception unit 343 performs data transmission/reception with other processing server 330 or other data server 340.

<Network Switch 320>

The network switch 320 includes a switch management unit 321 and a data transmission/reception unit 322.

===Switch Management Unit 321===

The switch management unit 321 acquires information such as an available bandwidth of a communication channel (data transmission/reception route) connected with the network switch 320 from the data transmission/reception unit 322, and transmits it to the distributed processing management server 300.

===Data Transmission/reception Unit 322===

The data transmission/reception unit 322 relays data transmitted and received between the processing server 330 and the data server 340.

<Distributed Processing Management Server 300>

The distributed processing management server 300 includes a data location storing unit 3070, a server status storing unit 3060, an input/output communication channel information storing unit 3080, a model generation unit 301, an optimum arrangement calculation unit 302 and a processing allocation unit 303.

===Data Location Storing Unit 3070===

The data location storing unit 3070 stores a name of a logical data set (logical data set name) and one or more identifiers of the processing data storing units 342 of the data server 340 storing partial data included in the logical data set, in association with each other.

The logical data set is a set of one or more data elements. The logical data set may be defined as a set of identifiers of data elements, a set of identifiers of data element groups including one or more data elements, or a set of pieces of data satisfying a certain common condition, and it may be defined as union or intersection of these sets. The logical data set is identified by the name of the logical data set uniquely in the distributed system 350. That is, the name of the logical data set is set to the logical data set so that it may be identified uniquely in the distributed system 350.

The data element is a minimum unit in the input or the output of one processing program for processing the data element.

The partial data is a set of one or more data elements. The partial data is also an element constituting the logical data set.

In a structure program which specifies a structure of a directory or data, the logical data set may be explicitly specified with a distinguished name, or it may be specified based on other processing result such as an output or the like of the specified processing program. The structure program is information which shows the logical data set itself or the data elements constituting the logical data set. The structure program receives information (name or identifier) which shows a certain data element or logical data set as an input. The structure program outputs a directory name storing the data elements or the logical data set corresponding to the received input, and a file name which shows a file constituting the data elements or the logical data set. The structure program may be a list of directory names or file names.

Although the logical data set and the data elements typically correspond to a file and records in the file, respectively, they are not limited to this correspondence.

When a unit of information received by the processing program as an argument is each distributed file in a distributed file system, the data element is each distributed file. In this case, the logical data set is a set of the distributed files. For example, the logical data set is specified by a directory name on the distributed file system, information listing a plurality of distributed file names or a certain common condition to the distributed file names. That is, the name of the logical data set may be a directory name on the distributed file system, information listing a plurality of distributed file names or a certain common condition to the distributed file names. The logical data set may be specified by information listing a plurality of directory names. That is, the name of the logical data set may be information listing a plurality of directory names.

When a unit of information received by the processing program as an argument is a row or a record, the data element is each row or each record in the distributed file. In this case, for example, the logical data set is the distributed file.

When a unit of information received by the processing program as an argument is “a row” of the table in a relational database, the data element is each row in the table. In this case, the logical data set is a set of rows obtained by a predetermined search on a certain set of tables or a set of rows obtained by a search on the certain set of tables for a certain attribute range.

The logical data set may be a container such as Map, Vector or the like of a program such as C++ and Java (registered trademark), and the data element may be an element of the container. The logical data set may be a matrix, and the data element may be a row, a column, or a matrix element.

A relation between these logical data set and data elements is specified by the contents of the processing program. This relation may be written in the structure program.

For any case of the logical data set and the data element, the logical data set to be processed is determined by specifying a logical data set or registering one or more data elements. The name (logical data set name) of the logical data to be processed, the identifier of the data element included in the logical data set and the identifier of the processing data storing unit 342 of the data server 340 storing the data element, are stored, in association with each other, in the data location storing unit 3070.

Each logical data set may be divided into a plurality of subsets (partial data), and the plurality of subsets may be arranged in a distributed manner in a plurality of data servers 340 respectively.

A data element in a certain logical data set may be multiplexed and arranged in two or more data servers 340, respectively. In this case, the pieces of data multiplexed from one data element are collectively called also a distributed data. The processing server 330 should input any one piece of the distributed data as a data element in order to process the multiplexed data element.

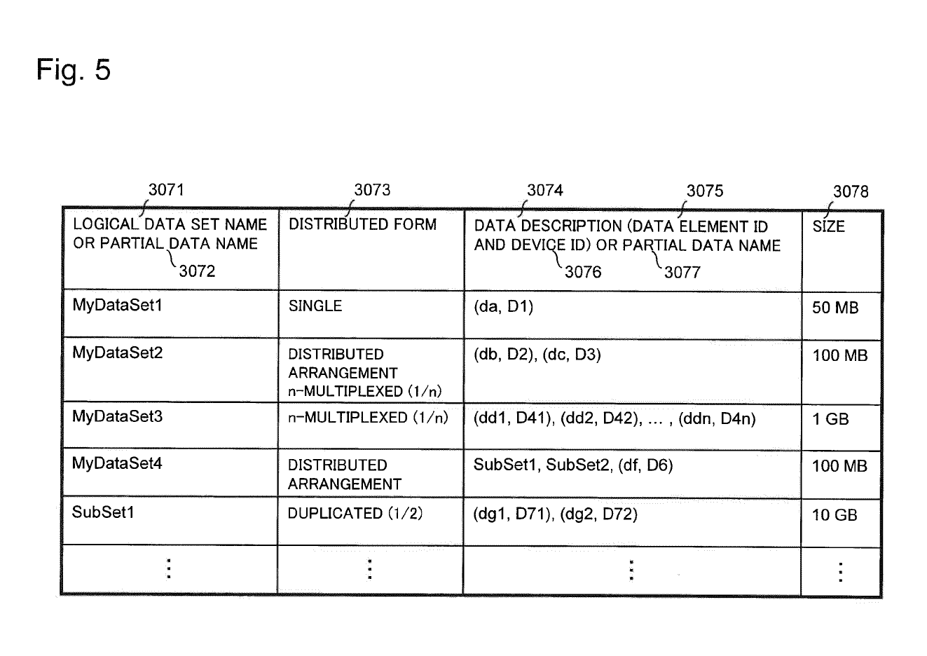

FIG. 5 exemplifies information stored in the data location storing unit 3070. Referring to FIG. 5, the data location storing unit 3070 stores a plurality of pieces of data location information which is information associating a logical data set name 3071 or a partial data name 3072, a distributed form 3073, data description 3074 or a partial data name 3077, and a size 3078, with each other.

The distributed form 3073 is information which shows a form in which a logical data set indicated by the logical data set name 3071 or a data element included in a partial data indicated by the partial data name 3072 is stored. For example, when a logical data set is arranged singly (MyDataSet1, for example), information of “single” is set as the distributed form 3073 in the row (data location information) corresponding to the logical data set. And, for example, when a logical data set is arranged in a distributed manner (MyDataSet2, for example), information of “distributed arrangement” is set as the distributed form 3073 in the row (data location information) corresponding to the logical data set.

The data description 3074 includes a data element ID 3075 and a device ID 3076. The device ID 3076 is an identifier of the processing data storing unit 342 storing each data element. The device ID 3076 may be unique information in the distributed system 350, or may be an IP address allocated for a device. The data element ID 3075 is a unique identifier that indicates the data element in the data server 340 storing each data element.

Information specified by the data element ID 3075 is determined according to a type of the logical data set to be processed. For example, when the data element is a file, the data element ID 3075 is information which specifies the file name. When the data element is a record of a database, the data element ID 3075 may be information which specifies an SQL sentence to extract a record.

The size 3078 is information which shows a size of the logical data set indicated by the logical data set name 3071 or the partial data indicated by the partial data name 3072. When the size thereof is obvious, the size 3078 may be omitted. For example, when all logical data sets or all pieces of partial data have the same sizes, the size 3078 may be omitted.

When a part or all of the data elements of the logical data set are multiplexed (such as MyDataSet4, for example), the logical data set name 3071 of the logical data set, description (distributed form 3073) indicating “distributed arrangement” and partial data names 3077 of partial data (SubSet1, SubSet2, or the like) are stored in association with each other. At that time, the data location storing unit 3070 stores each of the partial data names 3077 as a partial data name 3072, the distributed form 3073 and the partial data description 3074, in association with each other (the 5th line of FIG. 5, for example).

When a partial data is multiplexed (for example, duplicated) (SubSet1, for example), the partial data name 3072, the distributed form 3073, and the data description 3074 for each multiplexed data included in the partial data are stored, in association each other, in the data location storing unit 3070. The data description 3074 includes an identifier of the processing data storing unit 342 which stores the multiplexed data element (device ID 3076) and a unique identifier that indicates the data element in the data server 340 (data element ID3075).

The logical data set may be multiplexed without dividing into a plurality of partial data (MyDataSet3, for example). In this case, the data description 3074 associated with the logical data set name 3071 of the logical data set includes an identifier of the processing data storing unit 342 which stores the multiplexed data (device ID 3076) and a unique identifier that indicates a data element in the data server 340 (data element ID3075).

The information on each row of the data location storing unit 3070 (respective pieces of data location information) is deleted by the distributed processing management server 300 when processing of corresponding data has been completed. This deleting may be performed by the processing server 330 or the data server 340. Instead of deleting the information of each row of the data location storing unit 3070 (respective pieces of data location information), the completion of processing of data may be recorded by adding information representing processing completion or non-completion of data to the information of each row (respective pieces of data location information).

Note that the data location storing unit 3070 does not need to include the distributed form 3073 when the distributed system 350 uses only one type of the distributed form of the logical data set. For a simplification, descriptions of exemplary embodiments below are given by assuming that the type of distributed form of the logical data set is any one of the above mentioned types. The distributed processing management server 300 or the like changes processing described hereinafter on the basis of description of the distributed form 3073 in order to use a plurality of forms.

===Input/output Communication Channel Information Storing Unit 3080===

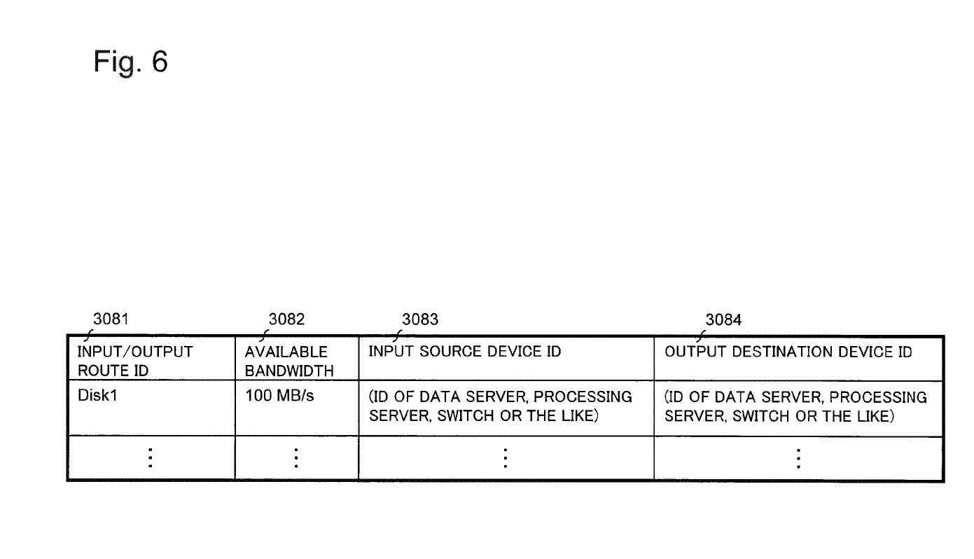

FIG. 6 exemplifies information stored in the input/output communication channel information storing unit 3080. The input/output communication channel information storing unit 3080 stores input/output communication route information which is information associating input/output route ID 3081, an available bandwidth 3082, an input source device ID 3083 and an output destination device ID 3084, with each other, for each input/output communication channel which included in the distributed system 350. In this specification, an input/output communication channel is also represented as a data transmission/reception route or an input/output route. The input/output route ID 3081 is an identifier of an input/output communication channel between devices with which input/output communications are generated. The available bandwidth 3082 is bandwidth information available at present for the input/output communication channel. The bandwidth information may be an actual measurement value or an estimated value.

The input source device ID 3083 is an ID of a device which inputs data to the input/output communication channel. The output destination device ID 3084 is an ID of a device to which the input/output communication channel outputs data. The IDs of the devices indicated by the input source device ID 3083 and the output destination device ID 3084 may be a unique identifier in the distributed system 350, which is allocated to the data server 340, the processing server 330 and the network switch 320, or may be an IP address allocated to respective devices.

The input/output communication channel may be an input/output communication channel shown below. For example, the input/output communication channel may be an input/output communication channel between the processing data storing unit 342 and the data transmission/reception unit 343 of the data server 340. For example, the input/output communication channel may be an input/output communication channel between the data transmission/reception unit 343 of the data server 340 and the data transmission/reception unit 322 of the network switch 320. For example, the input/output communication channel may be an input/output communication channel between the data transmission/reception unit 322 of the network switch 320 and the data transmission/reception unit 334 of the processing server 330. For example, the input/output communication channel may be an input/output communication channel or the like between the data transmission/reception units 322 of the network switch 320. When there is an input/output communication channel between the data transmission/reception unit 343 of the data server 340 and the data transmission/reception unit 334 of the processing server 330 directly without the data transmission/reception unit 322 of the network switch 320, the input/output communication channel is also used as the input/output communication channel in the input/output communication route information.

===Server Status Storing Unit 3060===

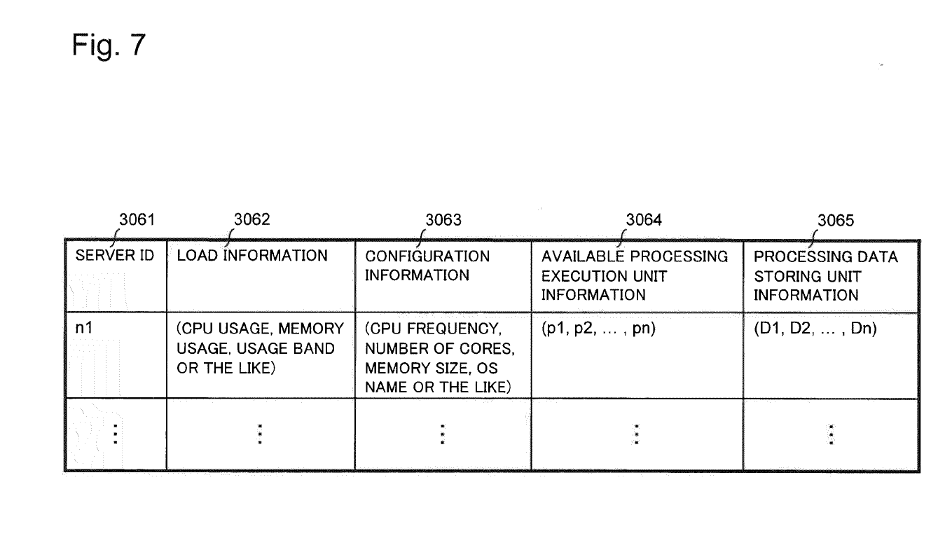

FIG. 7 exemplifies information stored in the server status storing unit 3060. The server status storing unit 3060 stores processing server status information which is information associating a server ID 3061, load information 3062, configuration information 3063, available processing execution unit information 3064 and processing data storing unit information 3065, with each other, for each processing server 330 and each data server 340 operated in the distributed system 350.

The server ID 3061 is an identifier of the processing server 330 or the data server 340. The identifiers of the processing server 330 and the data server 340 may be a unique identifier in the distributed system 350, or may be an IP address allocated to them. The load information 3062 includes information about the processing load of the processing server 330 or the data server 340. For example, the load information 3062 is a usage rate of a CPU (Central Processing Unit), a memory usage or a network usage bandwidth or the like.

The configuration information 3063 includes status information of a configuration of the processing server 330 or the data server 340. For example, the configuration information 3063 is a specification of hardware such as a CPU frequency, the number of cores, and a memory size of the processing server 330, or a specification of software such as OS (Operating System). The available processing execution unit information 3064 is an identifier of the processing execution unit 332 available at present among processing execution units 332 in the processing server 330. The identifier of the processing execution unit 332 may be a unique identifier in the processing server 330, or may a unique identifier in the distributed system 350. The processing data storing unit information 3065 is an identifier of the processing data storing unit 342 in the data server 340.

The information stored in the server status storing unit 3060, the data location storing unit 3070 and the input/output communication channel information storing unit 3080 may be updated based on a status notification transmitted from the network switch 320, the processing server 330, or the data server 340. The information stored in the server status storing unit 3060, the data location storing unit 3070 and the input/output communication channel information storing unit 3080 may be updated based on the response information to the inquiry about the status from the distributed processing management server 300.

Here, details of processing of the update based on the status notification mentioned above will be described.

The network switch 320 generates, for example, information indicating a throughput of communication on each port in the network switch 320 and information indicating the identifier (MAC address: Media Access Control address and an IP address: Internet Protocol address) of a device which is a connection destination of each port, as the above-mentioned status notification. The network switch 320 transmits the generated information to the server status storing unit 3060, the data location storing unit 3070 and the input/output communication channel information storing unit 3080 via the distributed processing management server 300, and each storing unit updates the stored information based on the transmitted information.

The processing server 330 generates, for example, information indicating a throughput of the network interface, information indicating an allocation status of data to be processed to the processing execution unit 332, and information indicating a usage status of the processing execution unit 332, as the above-mentioned status notification. The processing server 330 transmits the generated information to the server status storing unit 3060, the data location storing unit 3070 and the input/output communication channel information storing unit 3080 via the distributed processing management server 300, and each storing unit updates the stored information based on the transmitted information.

The data server 340 generates, for example, information indicating a throughput of the processing data storing unit 342 (disk) or a network interface included in the data server 340, and information indicating a list of data elements stored by the data server 340, as the above-mentioned status notification. The data server 340 transmits the generated information to the server status storing unit 3060, the data location storing unit 3070 and the input/output communication channel information storing unit 3080 via the distributed processing management server 300, and each storing unit updates the stored information based on the transmitted information.

The distributed processing management server 300 transmits information which requests the above-mentioned status notification to the network switch 320, the processing server 330, and the data server 340, and acquires the above-mentioned status notification. The distributed processing management server 300 transmits the received status notification to the server status storing unit 3060, the data location storing unit 3070 and the input/output communication channel information storing unit 3080, as the above-mentioned response information. The server status storing unit 3060, the data location storing unit 3070 and the input/output communication channel information storing unit 3080 update the stored information based on the received response information.

### ===Model Generation Unit 301===

The model generation unit 301 acquires information from the server status storing unit 3060, the data location storing unit 3070 and the input/output communication channel information storing unit 3080. The model generation unit 301 generates a network model based on the acquired information.

This network model is a model showing a data transfer route when the processing server 330 acquires data from the processing data storing unit 342 in the data server 340.

A vertex (a node) included in the network model represents a device and a hardware element composing a network, and data processed by the device and hardware element.

An edge included in the network model represents a data transmission/reception route (input/output routes) which connects between the devices and the hardware elements composing the network. An available bandwidth of the input/output route corresponding to the edge is set to the edge as a restriction.

The edge included in the network model also connects a node representing data and a node representing a set of pieces of data including the data.

The edge included in the network model also connects a node representing data and a node representing a device or hardware element storing the data.

The above-mentioned transfer route is expressed with a sub-graph including an edge and nodes which are end points for the edge in the above-mentioned network model.

The model generation unit 301 outputs model information based on the network model. The model information is used when the optimum arrangement calculation unit 302 determines the processing servers 330 which process a logical data set stored in the respective data server 340.

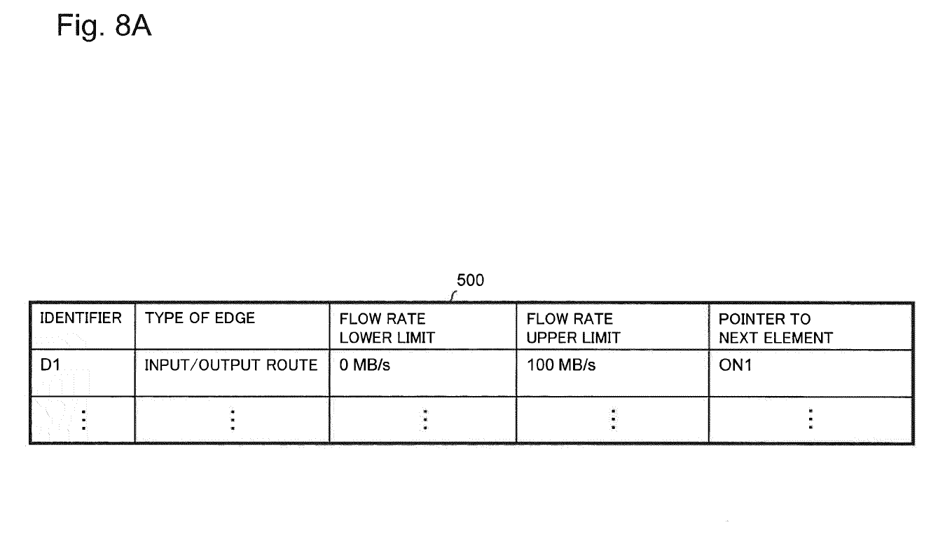

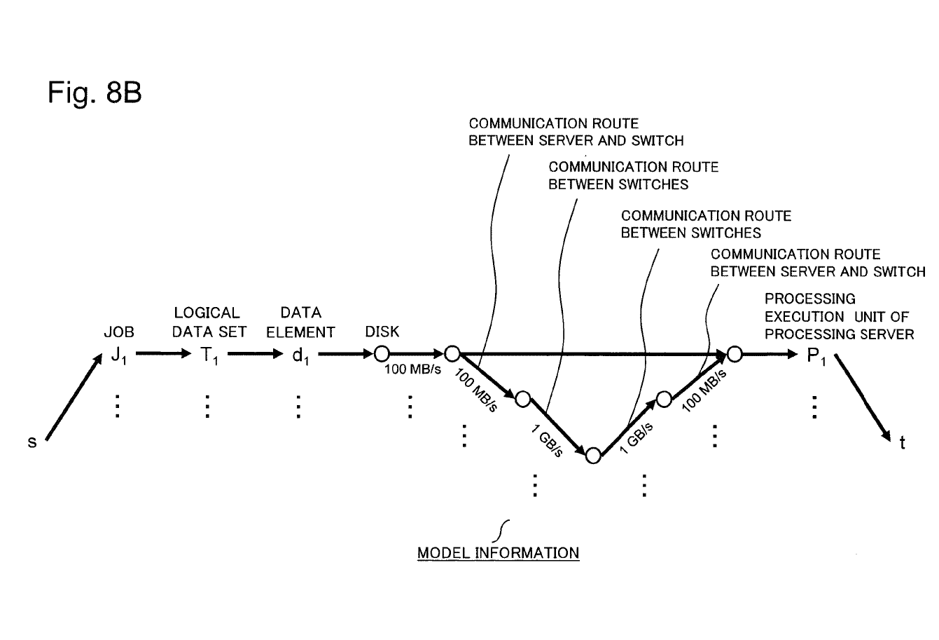

FIG. 8A exemplifies a table of model information outputted by the model generation unit 301. Information of each row of the table of model information includes an identifier, a type of an edge attribute, a lower limit value of a flow rate of the edge (flow rate lower limit), a upper limit value of a flow rate of the edge (flow rate upper limit value) and a pointer to the next element in the graph (network model).

The identifier is an identifier indicating any one of nodes included in the network model.

The type of an edge shows a type of the edge that comes out from the node indicated by the above-mentioned identifier. As the type, “start point route”, “logical data set route”, “partial data route”, “data element route” and “termination point route” which show virtual routes, and “input/output route” which shows a physical communication route (input/output communication channel or data transmission/reception route) are used.

In case that a node indicated by the above-mentioned identifier represents a start point and another node connected to the edge comes out from the node (“pointer to the next element” mentioned later) represents a logical data set, for example, the type of the edge is “start point route”. In case that a node indicated by the above-mentioned identifier represents a logical data set, and another node connected to the edge comes out from the node represents partial data or a data element, the type of the edge is “logical data set route”. In case that a node indicated by the above-mentioned identifier represents partial data, and another node connected to the edge comes out from the node represents a data element or the processing data storing unit 342 of the data server 340, for example, the type of the edge is “partial data route”.

In case that a node indicated by the above-mentioned identifier represents a data element, and another node connected to the edge comes out from the node represents the processing data storing unit 342 of the data server 340, for example, the type of the edge is “data element route”. In case that a node indicated by the above-mentioned identifier represents a real device including the processing data storing unit 342 of the data server 340, and another node connected to the edge comes out from the node represents a real device, for example, the type of the edge is “input/output route”. In case that a node indicated by the above-mentioned identifier represents the processing execution unit 332 of the processing server 330 which is a real device, and another node connected to the edge comes out from the node represents an termination point, for example, the type of the edge is “termination point route”. Note that the type of an edge attribute may be omitted from the table of model information.

The pointer to the next element is an identifier indicating another node connected to the edge comes out from the node indicated by the corresponding identifier. The pointer to the next element may be a row number which shows information about each row in the table of model information, and may be address information of a memory in which information about row in the table of model information is stored.

In FIG. 8A, although the model information is expressed in a table form, the form of the model information is not limited to the table form. For example, the model information may be expressed in any form such as association arrangement, a list and a file.

FIG. 8B exemplifies a conceptual diagram of the model information generated by the model generation unit 301. Notionally, the model information is represented as a graph having a start point s, and a termination point t. This graph represents all routes to the processing execution unit P of the processing server 330 which receives the data element (or partial data) d. Each edge on the graph has an available bandwidth as an attribute value (restriction). For the route without restrictions of the available bandwidth, infinity is used as the available bandwidth. In this case, a specific value other than infinity may be used as the available bandwidth.

The model generation unit 301 may change the model generation method according to status of the device. For example, the model generation unit 301 may exclude the processing server 330 with the high CPU utilization rate, as an unavailable processing server 330, from the model generated by the distributed processing management server 300.

===Optimum Arrangement Calculation unit 302===

The optimum arrangement calculation unit 302 determines a s-t-flow F which maximizes an objective function for a network (G, u, s, t) represented by the model information which is outputted by the model generation unit 301. The optimum arrangement calculation unit 302 outputs a data-flow Fi which satisfies the s-t-flow F.

Here, G in the network (G, u, s, t) is a directed graph G=(V, E). Note that V is a set which satisfies V=P∪D∪T∪R∪{s, t}. P is a set of processing execution units 332 of the processing server 330. D is a set of data elements. T is a set of logical data sets, and R is a set of devices which constitute input/output communication channels. s is a start point, and t is a termination point. The start point s and the termination point t are logical vertexes added in order to make the model calculating easy. The start point s and the termination point t may be omitted. E is a set of edges e on the directed graph G. E includes an edge connecting a node representing a physical communication channel (a data transmission/reception route or an input/output communication channel) and a node representing data, an edge connecting a node representing data and a node representing a set of the data, or an edge connecting a node representing data and a node representing a hardware element storing the data.

u in the network (G, u, s, t) is a capacity function from the edge e on G to an available bandwidth for the e. That is, u is a capacity function u: E→R+. Note that R+ is a set which shows a positive real number.

s-t-flow F is a model representing a communication route and traffic of data transfer communication. The data transfer communication is the data transfer communication which occurs on the distributed system 350 when a certain data is transmitted from a storage device (hardware element) in the data server 340 to the processing server 330.

s-t-flow F is determined by a flow rate function f which satisfies f(e)≦u(e) for all eεE on the graph G except for vertex s and t.

Data-flow Fi is information showing a set of identifiers of devices constituting a communication route of data transfer communication which is performed when the processing server 330 acquires allocated data, and the traffic of the communication route.

An arithmetic expression which makes an objective function (flow rate function f) of the exemplary embodiment maximize is specified by the following Equation (1) of [Mathematical Equation 1]. Constraint expressions to Equation (1) of [Mathematical Equation 1] are Equation (2) of [Mathematical Equation 1] and Equation (3) of [Mathematical Equation 1]

$$\begin{matrix}[ Mathematical Equation 1 ] & \\ max \cdot {\sum }_{e ∈ δ - ( t )} f ( e ) & ( 1 ) \\ s . t . {\sum }_{e ∈ δ - ( v )} f ( e ) = {\sum }_{e ∈ δ + ( v )} f ( e ) ( v ∈ V \backslash \{ s , t \} ) & ( 2 ) \\ s . t . 0 \leq f ( e ) \leq u ( e ) & ( 3 )\end{matrix}$$

In [Mathematical Equation 1], f (e) shows a function (the flow rate function) representing the flow rate on eεE. u (e) is a function (capacity function) representing a upper limit value of the flow rate per unit time which can be transmitted on the edge eεE of the graph G. The value of u (e) is determined according to output of the model generation unit 301. δ−(v) is a set of edges that comes into vertex vεV on the graph G, and δ+(v) is a set of edges that comes out from vεV. max. represents maximization, and s.t. represents a restriction.

According to [Mathematical Equation 1], the optimum arrangement calculation unit 302 determines a function f: E→R+ which maximizes the flow rate on the edge that comes in the termination point t. Note that R+ is a set which shows the positive real number. The flow rate on the edge that comes in the termination point t is, that is, the data amount which the processing server 330 processes per unit time.

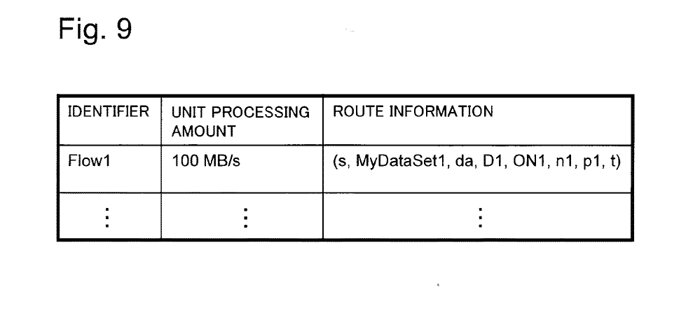

FIG. 9 exemplifies a corresponding table of route information and the flow rate outputted by the optimum arrangement calculation unit 302. The route information and flow rate compose data-flow Fi. That is, the optimum arrangement calculation unit 302 outputs data-flow information (data-flow Fi) which is information associating an identifier representing a flow, the data amount (unit processing amount) processed per unit time on the flow and the route information of the flow, with each other.

The maximization of the objective function can be realized by using a linear programming, a flow increase method or a pre-flow push method in the maximum flow problem. The optimum arrangement calculation unit 302 is constituted so that any one of the above-mentioned methods or other solution may be carried out.

When s-t-flow F is determined, the optimum arrangement calculation unit 302 outputs data-flow information as shown in FIG. 9 based on the s-t-flow F.

===Processing Allocation Unit 303===

The processing allocation unit 303 determines a data element to be acquired by the processing execution unit 332 and unit processing amount based on data-flow information outputted by the optimum arrangement calculation unit 302 and outputs decision information. The unit processing amount is data amount transferred per unit time on the route shown by the data-flow information. That is, the unit processing amount is also the data amount processed by the processing execution unit 332 per unit time, which is shown by the data-flow information.

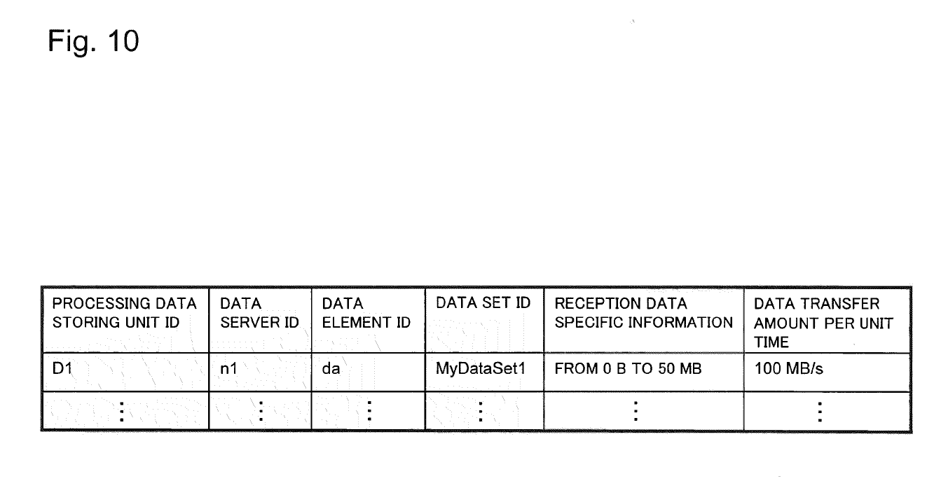

FIG. 10 exemplifies a configuration of the decision information determined by the processing allocation unit 303. The decision information exemplified in FIG. 10 is transmitted by the processing allocation unit 303 to each processing server 330. In case that a plurality of processing execution units 332 are included in each processing server 330, the processing allocation unit 303 may transmit the decision information to each processing execution unit 332 via the processing server management unit 331. The decision information includes an identifier of a data element (data element ID) received by the processing execution unit 332 of the processing server 330 which receives the decision information, and an identifier of the processing data storing unit 342 (processing data storing unit ID) of the data server 340 storing the data element. The decision information may include an identifier that specifies a logical data set (logical data ID) including the above-mentioned data element and an identifier that specifies the above-mentioned data server 340 (the data server ID). The decision information includes information which specifies the data transfer amount per unit time (the data transfer amount per unit time).

As other example of the decision information, when a plurality of processing execution units 332 processes one partial data, the decision information may include reception data specifying information. The reception data specifying information is information which specifies a data element to be received in a certain logical data set. For example, the reception data specifying information is information which specifies a set of identifiers of data elements or a predetermined segment in the local file of the data server 340 (start position of a segment and the transfer amount, for example). When the decision information includes the reception data specifying information, the reception data specifying information is specified based on a size of the partial data included in the data location storing unit 3070 and a ratio of the unit processing amount in each route shown by respective data-flow information.

When each processing server 330 receives the decision information, the processing server 330 requests the data server 340 specified by the decision information of the data transmission. Specifically, the processing server 330 transmits a request of transmitting the data specified by the decision information with the unit processing amount specified by the decision information, to the data server 340.

Note that the processing allocation unit 303 may transmit the decision information to each data server 340. In this case, the decision information includes information specifying a certain data element of a logical data set to be transmitted by the data server 340 which receives the decision information, the processing execution unit 332 of the processing server 330 which processes the data element and the data amount transmitted per unit time.

Next, the processing allocation unit 303 transmits the decision information to the processing server management unit 331 of the processing server 330. In case that the processing server 330 does not store a processing program corresponding to the decision information in the processing program storing unit 333 in advance, the processing allocation unit 303 may distribute the processing program received from a client to the processing server 330, for example. The processing allocation unit 303 may inquire whether the processing program corresponding to the decision information is stored to the processing server 330. In this case, when determining that the processing server 330 does not store the processing program, the processing allocation unit 303 distributes the processing program received from the client to the processing server 330.

Each component in the distributed processing management server 300, the network switch 320, the processing server 330 and the data server 340 may be realized as a dedicated hardware device. Or a CPU on a computer model client or the like may execute a program to function as each component of the above-mentioned distributed processing management server 300, network switch 320, processing server 330 and data server 340. For example, the model generation unit 301, the optimum arrangement calculation unit 302, or the processing allocation unit 303 of the distributed processing management server 300 may be realized as a dedicated hardware device. A CPU of the distributed processing management server 300 which is also a computer may execute the distributed processing management program loaded in a memory to function as the model generation unit 301, the optimum arrangement calculation unit 302 or the processing allocation unit 303 of the distributed processing management server 300.

Information for specifying the model, the constraint expression and the objective function mentioned above may be written in a structure program or the like, and the structure program or the like may be provided to the distributed processing management server 300 from a client. The information for specifying the model, the constraint expression and the objective function mentioned above may be provided to the distributed processing management server 300 from the client as a start parameter or the like. The distributed processing management server 300 may determine the model with reference to the data location storing unit 3070 or the like.

The distributed processing management server 300 may store the model information or the like generated by the model generation unit 301 or the data-flow information or the like generated by the optimum arrangement calculation unit 302 in a memory or the like and add the model information or the data-flow information to an input of the model generation unit 301 or the optimum arrangement calculation unit 302. In this case, the model generation unit 301 or the optimum arrangement calculation unit 302 may use the model information and the data-flow information for model generation and optimum arrangement calculation.

Information to be stored by the server status storing unit 3060, the data location storing unit 3070 and the input/output communication channel information storing unit 3080 may be provided in advance by a client or an administrator of the distributed system 350. The information may be collected by a program such as a crawler which searches the distributed system 350.

The distributed processing management server 300 may be installed in such a way to use all models, constraint expressions and objective functions, or may be installed in such a way to use only a specific model or the like.

Although FIG. 4 shows a case that the distributed processing management server 300 exists in one specific computer or the like, the input/output communication channel information storing unit 3080 and the data location storing unit 3070 may be included in distributed devices using a distributed hash table technology or the like.

Next, operation of the distributed system 350 is described by referring to a flow chart.

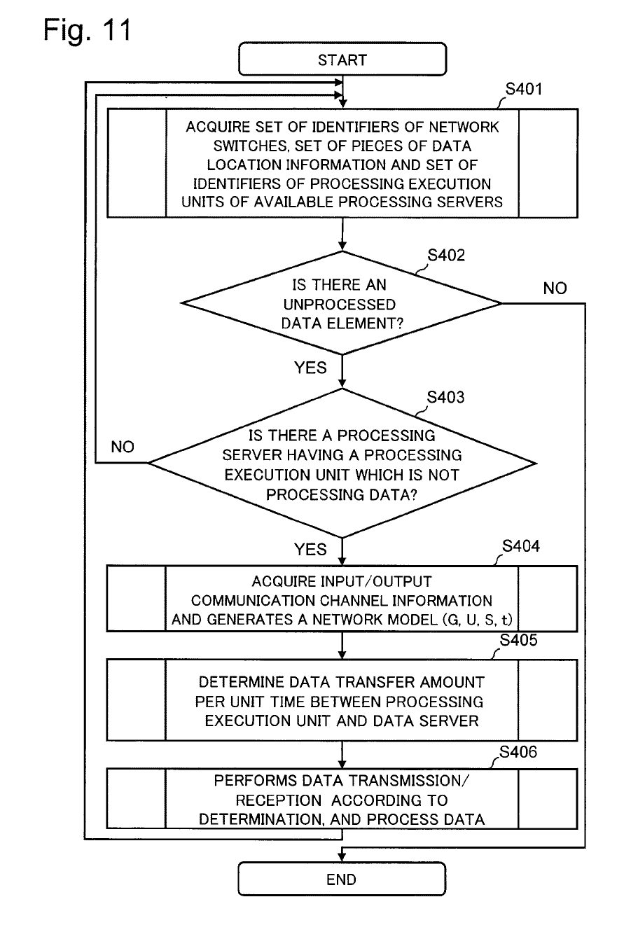

FIG. 11 is a flow chart showing whole operation of the distributed system 350.

When the distributed processing management server 300 receives request information which is an execution request of a processing program from the client 360, the distributed processing management server 300 acquires information mentioned below respectively (Step S401). Firstly, the distributed processing management server 300 acquires a set of identifiers of the network switches 320 included in the network 370 in the distributed system 350. Secondly, the distributed processing management server 300 acquires a set of pieces of data location information associating a data element of a logical data set to be processed and an identifier of the processing data storing units 342 of the data server 340 storing the data element, with each other. Thirdly, the distributed processing management server 300 acquires a set of identifiers of the processing execution units 332 of available processing servers 330.

The distributed processing management server 300 determines whether an unprocessed data element remains in the acquired logical data set to be processed (Step S402). When the distributed processing management server 300 determines that an unprocessed data element does not remain in the acquired logical data set to be processed (“No” in Step S402), processing of the distributed system 350 is ended. When the distributed processing management server 300 determines that an unprocessed data element remains in the acquired logical data set to be processed (“Yes” in Step S402), processing of the distributed system 350 is proceeded to Step S403.

The distributed processing management server 300 determines whether there is a processing server 330 having a processing execution unit 332 which is not processing data among ones shown by the acquired identifiers of the processing execution units 332 of the available processing servers 330 (Step S403). When the distributed processing management server 300 determines that there is no processing server 330 having a processing execution unit 332 which is not processing data (“No” in Step S403), processing of the distributed system 350 is returned to Step S401. When the distributed processing management server 300 determines that there is a processing server 330 having a processing execution unit 332 which is not processing data (“Yes” in Step S403), processing of the distributed system 350 is proceeded to Step S404.

Next, the distributed processing management server 300 acquires input/output communication channel information and processing server status information by using the acquired set of identifiers of network switches 320, the set of identifiers of processing servers 330 and the set of identifiers of processing data storing units 342 of respective data servers 340 as a key. And the distributed processing management server 300 generates a network model (G, u, s, t) based on the acquired input/output communication channel information and processing server status information (Step S404).

Next, the distributed processing management server 300 determines a data transfer amount per unit time between each processing execution unit 332 and each data server 340 based on the network model (G, u, s, t) generated at Step S404 (Step S405). Specifically, the distributed processing management server 300 determines the data transfer amount per unit time, which is specified based on the above-mentioned network model (G, u, s, t), when a predetermined objective function becomes maximum under a predetermined restriction, as a desired value.

Next, each processing server 330 and each data server 340 perform data transmission/reception according to the above-mentioned data transfer amount per unit time determined by the distributed processing management server 300 at Step S405. The processing execution unit 332 of each processing server 330 processes data received by the above-mentioned data transmission/reception (Step S406). Then, processing of the distributed system 350 is returned to Step S401.

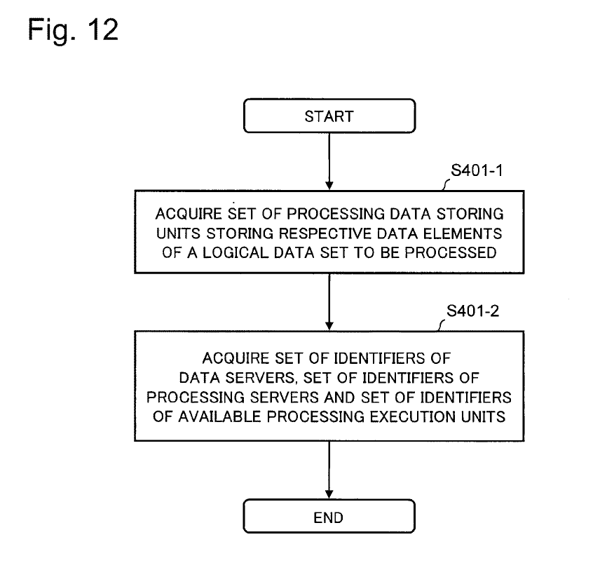

FIG. 12 is a flow chart showing operation of the distributed processing management server 300 in Step S401.

The model generation unit 301 of the distributed processing management server 300 acquires a set of identifiers of the processing data storing units 342 storing respective data elements of a logical data set to be processed which is specified by the request information which is a data processing request (execution request of a program) from the data location storing unit 3070 (Step S401-1). Next, the model generation unit 301 acquires a set of identifiers of the processing data storing units 342 of the data servers 340, a set of identifiers of the processing servers 330 and a set of identifiers of available processing execution units 332 from the server status storing unit 3060 (Step S401-2).

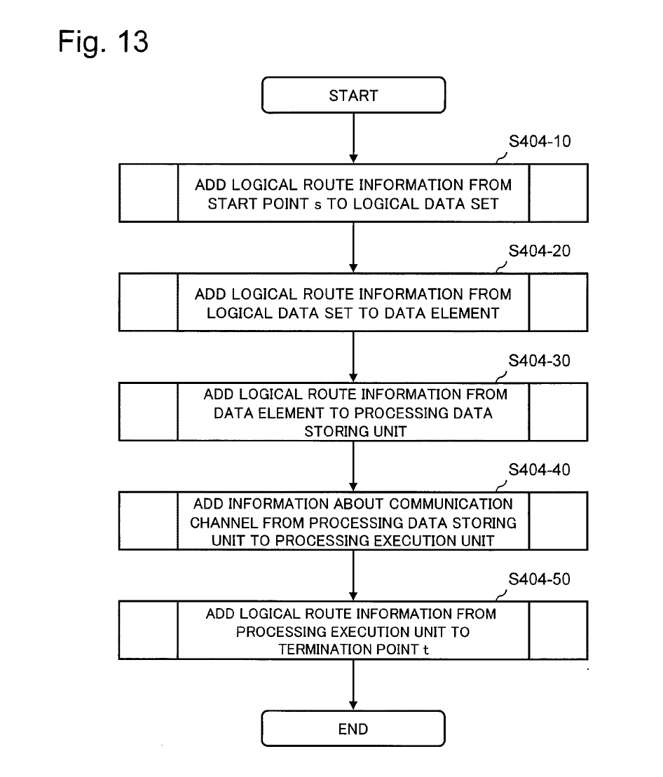

FIG. 13 is a flow chart showing operation of the distributed processing management server 300 in Step S404.

The model generation unit 301 of the distributed processing management server 300 adds logical route information from a start point s to the logical data set to be processed to the table of model information 500 reserved in a memory or the like in the distributed processing management server 300 or the like (Step S404-10). The logical route information is information of a row having a type of an edge as “start point route” in the above-mentioned table of model information 500.

Next, the model generation unit 301 adds logical route information from the logical data set to a data element included in the logical data set on the table of model information 500 (Step S404-20). The logical route information is information of a row having a type of an edge as “logical data set route” in the above-mentioned table 500 of the model information.

Next, the model generation unit 301 adds logical route information from the data element to the processing data storing unit 342 of the data server 340 storing the data element on the table of model information 500. The logical route information is information of a row having a type of an edge as “data element route” in the above-mentioned table of model information 500 (Step S404-30).

The model generation unit 301 acquires input/output route information which indicates information about a communication channel for processing the data element constituting the logical data set by the processing execution unit 332 of the processing server 330, from the input/output communication channel information storing unit 3080. The model generation unit 301 adds information about a communication channel based on the acquired input/output route information on the table of model information 500 (Step S404-40). The information about a communication channel is information of a row having a type of an edge as “input/output route” in the above-mentioned table of model information 500.

Next, the model generation unit 301 adds logical route information from the processing execution unit 332 to a termination point t on the table of model information 500 (Step S404-50). The logical route information is information of a row having a type of the edge as “termination point route” in the above-mentioned table of model information 500.

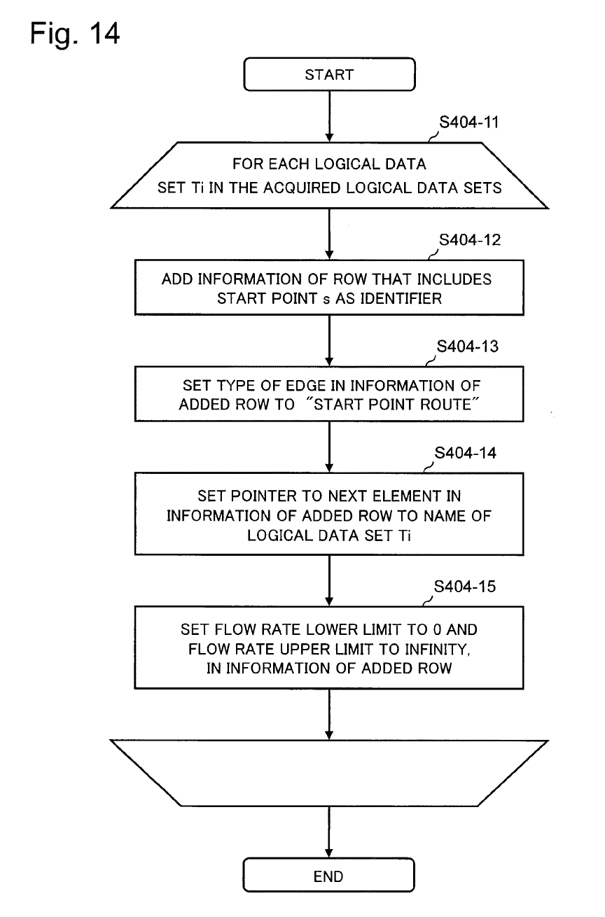

FIG. 14 is a flow chart showing operation of the distributed processing management server 300 in Step S404-10 of Step S404.

The model generation unit 301 in the distributed processing management server 300 processes Step S404-12 to Step S404-15 for each logical data set Ti in the set of logical data sets acquired from the data location storing unit 3070 based on the received request information (Step S404-11).

First, the model generation unit 301 in the distributed processing management server 300 adds information of a row that includes a start point s as an identifier on the table of model information 500 (Step S404-12). Next, the model generation unit 301 sets a type of an edge in the added row to “start point route” (Step 404-13).

Next, the model generation unit 301 sets a pointer to the next element in the added row, to a name of the logical data set Ti (Step S404-14). Next, the model generation unit 301 sets a flow rate lower limit to 0 and a flow rate upper limit to infinity, in the added row information (Step S404-15).

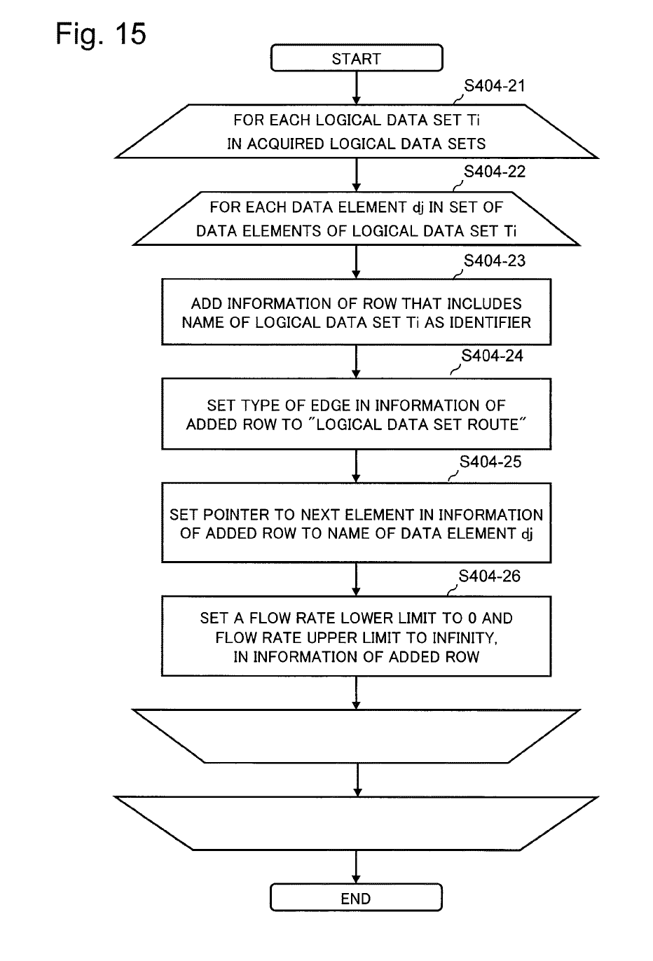

FIG. 15 is a flow chart showing operation in the distributed processing management server 300 in Step S404-20 of Step S404.

The model generation unit 301 in the distributed processing management server 300 processes Step S404-22 for each logical data set Ti in the set of logical data sets acquired from the data location storing unit 3070 based on the received request information (Step S404-21).

The model generation unit 301 processes Step S404-23 to Step S404-26 for each data element dj in the set of data elements of the logical data set Ti (Step S404-22).

The model generation unit 301 adds information of a row that includes the name of the logical data set Ti as an identifier on the table of model information 500 (Step S404-23). Next, the model generation unit 301 sets a type of an edge in the added row to “logical data set route” (Step S404-24). Next, the model generation unit 301 sets a pointer to the next element in the added row to a name (or an identifier) of the data element dj (Step S404-25).

Here, “identifier” and “pointer to the next element” in information of the row should be information which specifies a node in the network model.

Next, the model generation unit 301 sets a flow rate lower limit to 0 and a flow rate upper limit to infinity, in the added row information (Step S404-26).

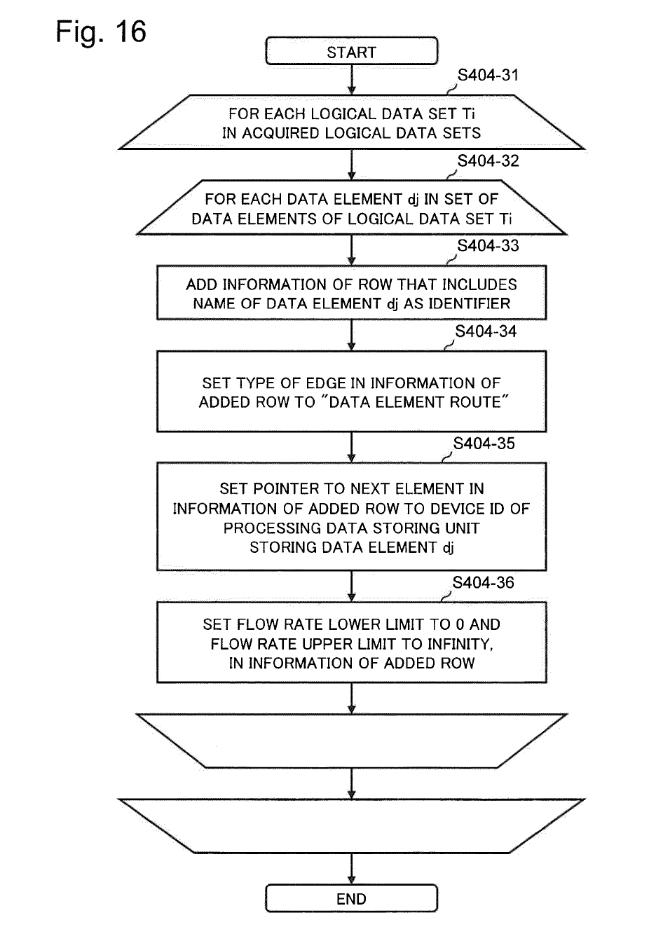

FIG. 16 is a flow chart showing operation of the distributed processing management server 300 in Step S404-30 of Step S404.

The model generation unit 301 in the distributed processing management server 300 processes Step S404-32 for each logical data set Ti in the logical data sets acquired from the data location storing unit 3070 based on the received request information (Step S404-31).

The model generation unit 301 processes Step S404-33 to Step S404-36 for each data element dj in the set of data elements of the logical data set Ti (Step S404-32).

The model generation unit 301 adds information of a row that includes the name of the data element dj as an identifier on the table of model information 500 (Step S404-33). Next, the model generation unit 301 sets a type of an edge in the added row to “data element route” (Step S404-34). Next, the model generation unit 301 sets a pointer to the next element in the added row to a device ID which indicates the processing data storing unit 342 of the data server 340 storing the data element dj (Step S404-35). Next, the model generation unit 301 sets a flow rate lower limit to 0 and sets a flow rate upper limit to infinity, in the added row (Step S404-36).

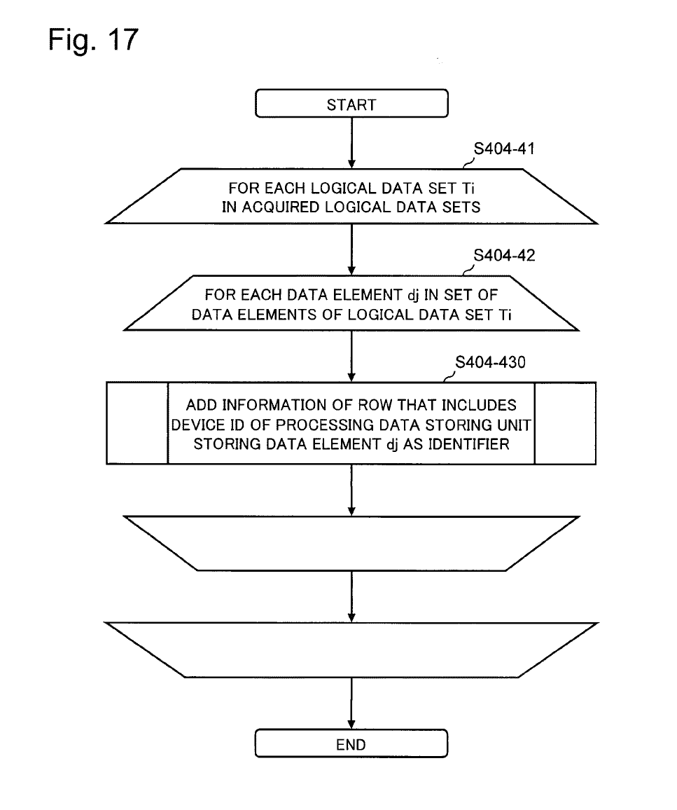

FIG. 17 is a flow chart showing operation of the distributed processing management server 300 in Step S404-40 of Step S404.

The model generation unit 301 in the distributed processing management server 300 processes Step S404-42 for each logical data set Ti in the set of logical data sets acquired from the data location storing unit 3070 based on the received request information (Step S404-41).

The model generation unit 301 processes Step S404-430 for each data element dj in the set of data elements of the logical data set Ti (Step S404-42).

The model generation unit 301 adds information of a row that includes a pointer to the next element of the data element dj as an identifier on the table of model information 500 based on the table of model information 500. That is, the model generation unit 301 adds information of a row that includes the device ID i which indicates the processing data storing unit 342 storing the data element dj as an identifier, on the table of model information 500 (Step S404-430).

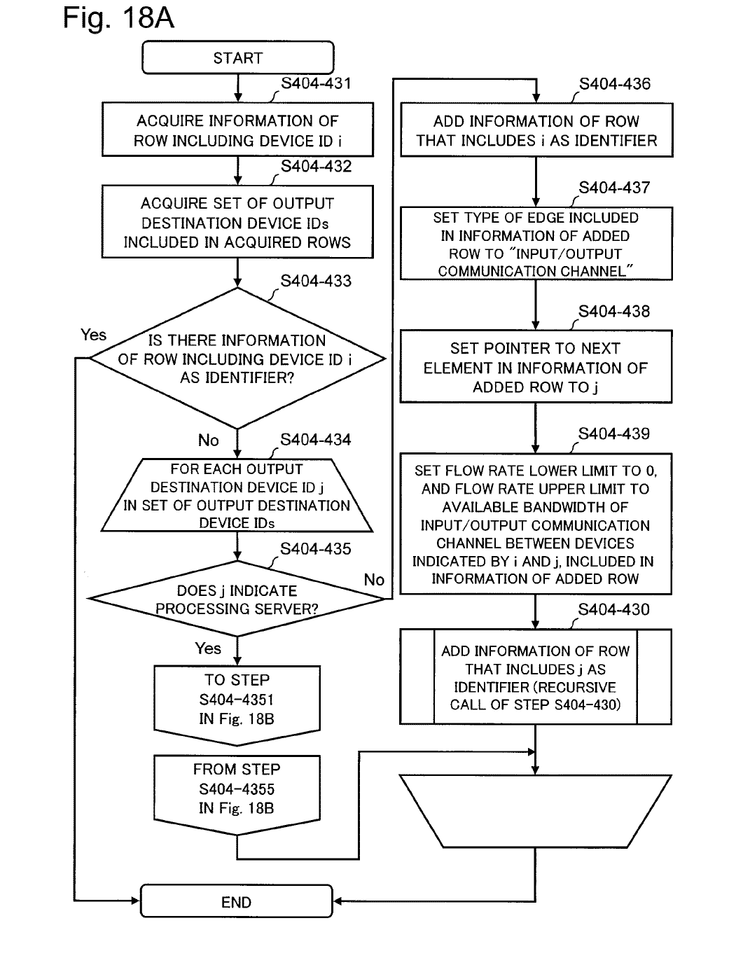

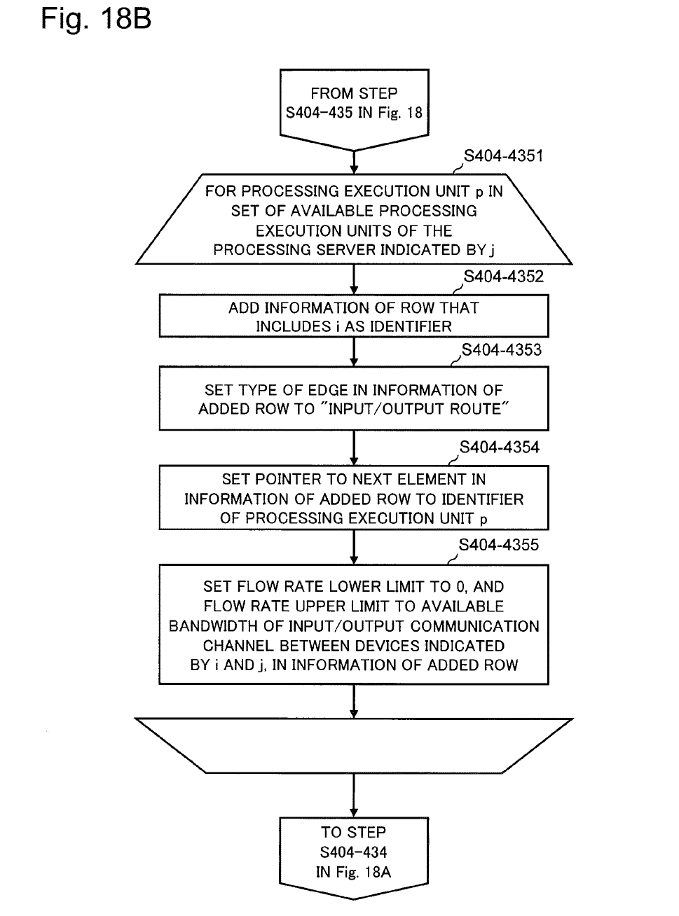

FIG. 18A and FIG. 18B are flow charts showing operation of the distributed processing management server 300 in Step S404-430 of Step S404-40.

The model generation unit 301 in the distributed processing management server 300 acquires, from the input/output communication channel information storing unit 3080, a row (input/output route information) including device ID i given in a call of Step S404-430 as an input source device ID(Step S404-431). Next, the model generation unit 301 specifies a set of output destination device IDs included in the input/output route information acquired in Step S404-431 (Step S404-432).

Next, the model generation unit 301 determines whether information of the row including the device ID i as an identifier is already included in the table of model information 500 (Step S404-433). When the model generation unit 301 determines that such information of the row is already included in the table of model information 500 (“Yes” in Step S404-433), a series of processing (subroutine) which starts from Step S404-430 of the distributed processing management server 300 is ended. On the other hand, when the model generation unit 301 determines that such information of the row is not included in the table of model information 500 yet (“No” in Step S404-433), processing of the distributed processing management server 300 is proceeded to Step S404-434.

Next, the model generation unit 301 performs processes Step S404-435 to Step S439 and recursive execution of S404-430, or processes Step S404-4351 to Step S404-4355 for each output destination device ID j in the set of output device IDs specified in processing Step S404-432 (Step S404-434).

The model generation unit 301 determines whether the output destination device ID j indicates a processing server 330 (Step S404-435).

When determining that the output destination device ID j does not indicate a processing server 330 (“No” in Step S404-435), the model generation unit 301 processes Step S404-435 to Step S404-439, and performs recursive execution of processing Step S404-430. On the other hand, when determining that the output destination device ID j indicates a processing server 330 (“Yes” in Step S404-435), the model generation unit 301 processes Step S404-4351 to Step S404-4355.

When the output destination device ID j indicates a device besides the processing server 330 (“No” in Step S404-435), the model generation unit 301 adds information of a row that includes the input source device ID as an identifier on the table of model information 500 (Step S404-436).

Next, the model generation unit 301 sets a type of an edge in the added row to “input/output route” (Step S404-437). Next, the model generation unit 301 sets a pointer to the next element in the added row to the output destination device ID j (Step S404-438).

Next, the model generation unit 301 sets a flow rate lower limit to 0, and sets a flow rate upper limit to the available bandwidth of the input/output communication channel between the device indicated by the input source device ID i and the device indicated by the output destination device ID j, in the added row information (Step S404-439). Next, the model generation unit 301 adds information of a row that includes the output destination device ID jas an identifier on the table of model information 500 by performing recursive execution of processing Step S404-430 (Step S404-430).

When the output destination device ID j indicates a processing server 330 (“Yes” in Step S404-435), the model generation unit 301 performs the following processing next to the processing of Step S404-435. That is, the model generation unit 301 processes Step S404-4352 to Step S404-4355 for each processing execution unit p in the set of available processing execution units 332 of the processing server 330 (Step S404-4351). The model generation unit 301 adds information of a row that includes the input source device ID i as an identifier on the table of model information 500 (Step S404-4352).

Next, the model generation unit 301 sets a type of an edge in the added row to “input/output route” (Step S404-4353). Next, the model generation unit 301 sets a pointer to the next element in the added row to the identifier of the processing execution unit p (Step S404-4354). Next, the model generation unit 301 sets a flow rate lower limit and a flow rate upper limit in the added row to the following values respectively. That is, the model generation unit 301 sets the flow rate lower limit to 0. And the model generation unit 301 sets the flow rate upper limit to an available bandwidth of an input/output communication channel between the device indicated by the input source device ID i given in a call of Step S404-430 and the processing server 330 indicated by the output destination device ID j (Step S404-4355).

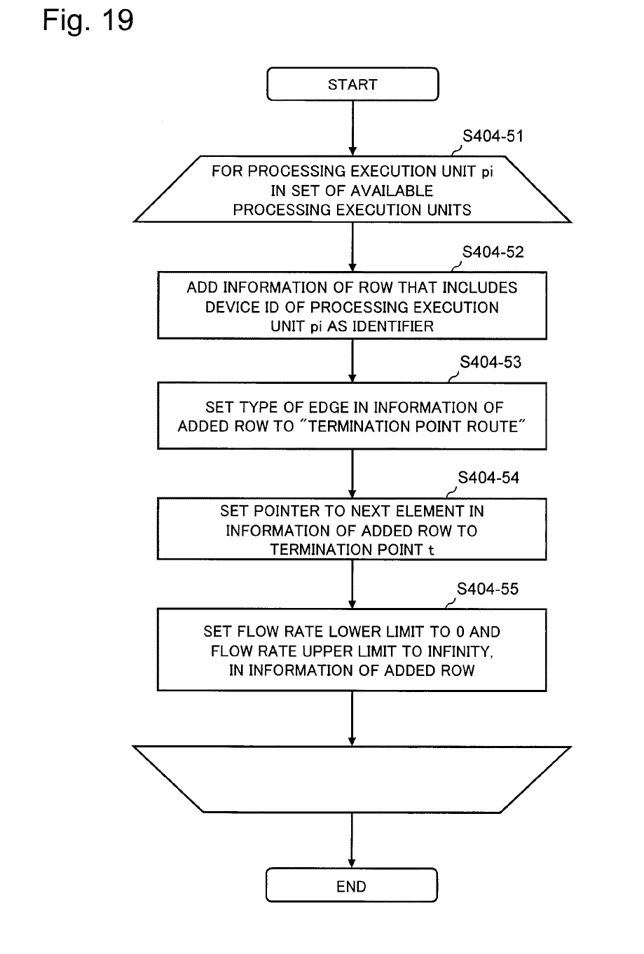

FIG. 19 is a flow chart showing operation of the distributed processing management server 300 in Step S404-50 of Step S404.

The model generation unit 301 in the distributed processing management server 300 processes Step S404-52 to Step S404-55 for each processing execution unit pi in the set of available processing execution units 332 acquired from the server status storing unit 3060 (step small 404-51).

The model generation unit 301 adds information of a row that includes the device ID which shows the processing execution unit pi as an identifier on the table of model information 500 (Step S404-52). Next, the model generation unit 301 sets a type of an edge in the added row to “termination point route” (Step S404-53). Next, the model generation unit 301 sets a pointer to the next element in the added row, to a termination point t (Step S404-54). Next, the model generation unit 301 sets a flow rate lower limit to 0 and sets a flow rate upper limit to infinity, in the added row (Step S404-55).

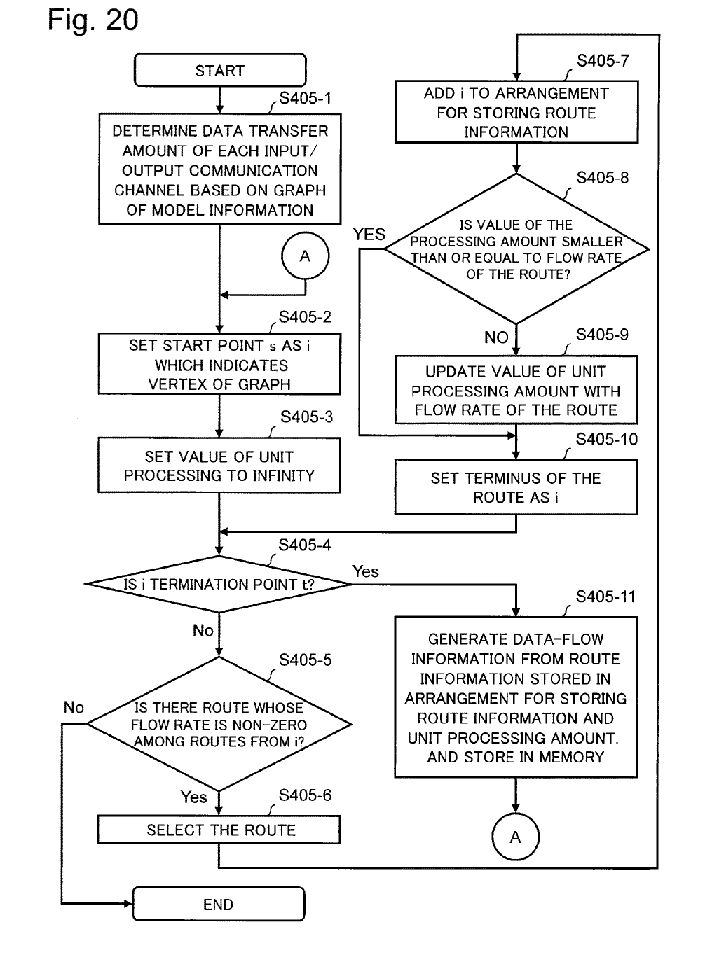

FIG. 20 is a flow chart showing operation of the distributed processing management server 300 in Step S405.

The optimum arrangement calculation unit 302 in the distributed processing management server 300 builds a graph (s-t-flow F) based on the model information generated by the model generation unit 301 in the distributed processing management server 300. The optimum arrangement calculation unit 302 determines a data transfer amount of each communication channel in such a way that the sum of the data transfer amounts per unit time to the processing servers 330 becomes the maximum based on the graph (Step S405-1). Next, the optimum arrangement calculation unit 302 sets a start point s as an initial value of i which indicates a vertex (node) of the graph built in Step S405-1 (Step S405-2). Next, the optimum arrangement calculation unit 302 reserves an area for recording arrangement for storing route information and a value of unit processing amount on the memory and initializes the value of unit processing amount to infinity (Step S405-3).

Next, the optimum arrangement calculation unit 302 determines whether i is the termination point t (Step S405-4). When the optimum arrangement calculation unit 302 determines that i is the termination point t (“Yes” in Step S405-4), processing of the distributed processing management server 300 is proceeded to Step S405-11. On the other hand, when the optimum arrangement calculation unit 302 determines that i is not the termination point t (“No” in Step S405-4), processing of the distributed processing management server 300 is proceeded to Step S405-5.

When i is not the termination point t (“No” in Step S405-4), the optimum arrangement calculation unit 302 determines whether there is a route whose flow rate is non-zero among routes come out from i on the graph (s-t-flow F) (Step S405-5). When the optimum arrangement calculation unit 302 determines that a route whose flow rate is non-zero does not exist (“No” in Step S405-5), processing (subroutine) of Step S403 of the distributed processing management server 300 is ended. On the other hand, when determining that a route whose flow rate is non-zero exists (“Yes” in Step S405-5), the optimum arrangement calculation unit 302 selects the route (Step S405-6). Next, the optimum arrangement calculation unit 302 adds i to the arrangement for storing route information reserved on the memory in Step S405-3 (Step S405-7).

The optimum arrangement calculation unit 302 determines whether the value of unit processing amount on the memory reserved in Step S405-3 is equal to or smaller than the flow rate of the route selected in Step S405-6 (Step S405-8). When the optimum arrangement calculation unit 302 determines that the value of unit processing amount on the memory is equal to or smaller than the flow rate of the route (“Yes” in Step S405-8), processing of the optimum arrangement calculation unit 302 is proceeded to Step S405-10. On the other hand, when the optimum arrangement calculation unit 302 determines that the value of unit processing amount on the memory is larger than the flow rate of the route (“No” in Step S405-8), processing of the optimum arrangement calculation unit 302 is proceeded to Step S405-9.

The optimum arrangement calculation unit 302 updates the value of unit processing amount on the memory reserved in Step S405-3 with the flow rate of the route selected in Step S405-6 (Step S405-9). Next, the optimum arrangement calculation unit 302 sets a terminus of the route selected in Step S405-6 as i (Step S405-10). Here, the terminus of the route is other end point of a route different from the present i. Then, processing of the distributed processing management server 300 is proceeded to Step S405-4.

When i is the termination point t in Step S405-4 (“Yes” in Step S405-4), the optimum arrangement calculation unit 302 generates data-flow information from the route information stored in the arrangement for storing route information and the unit processing amount. The optimum arrangement calculation unit 302 stores the generated data-flow information in a memory (Step S405-11). Then, processing of the distributed processing management server 300 is proceeded to Step S405-2.

The optimum arrangement calculation unit 302 maximizes an objective function based on a network model (G, u, s, t) in Step S405-1 of Step S405. The optimum arrangement calculation unit 302 maximizes the objective function by using a linear programming or a flow increase method in the maximum flow problem as a technique of this maximization.

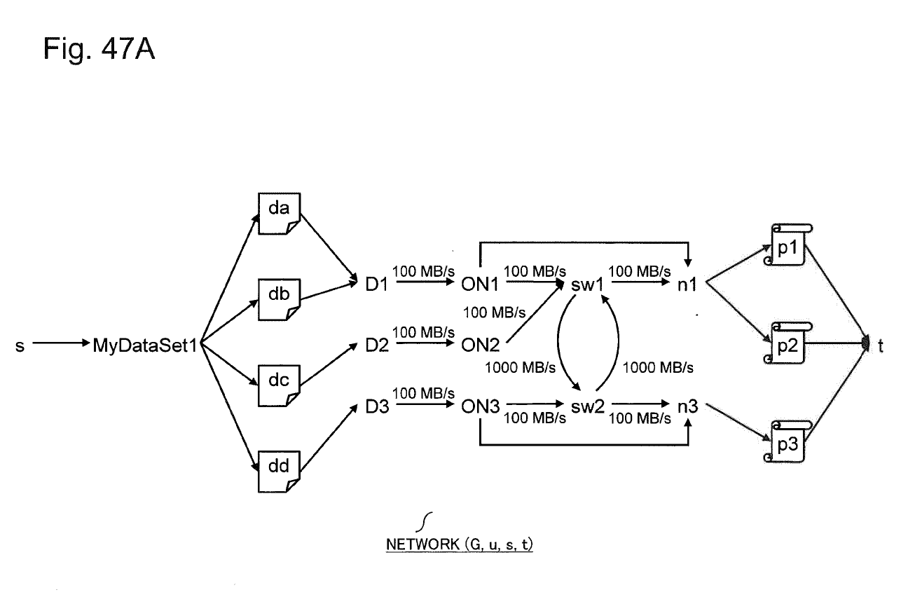

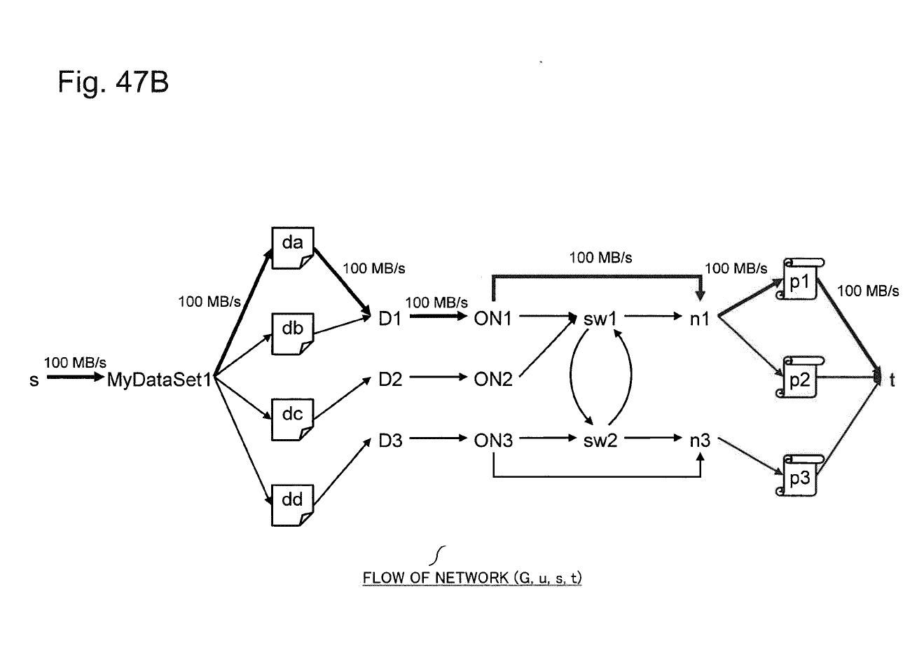

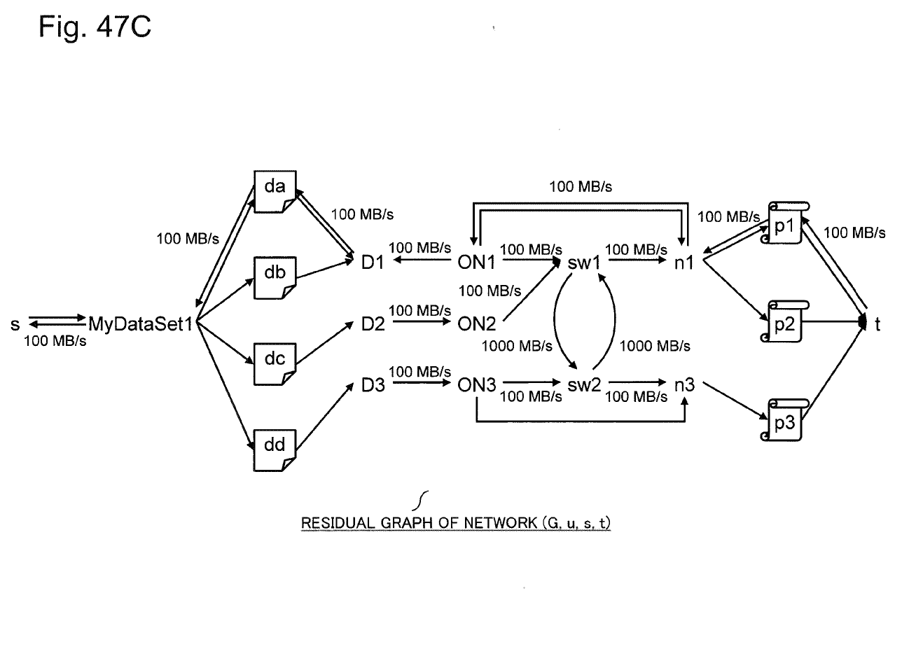

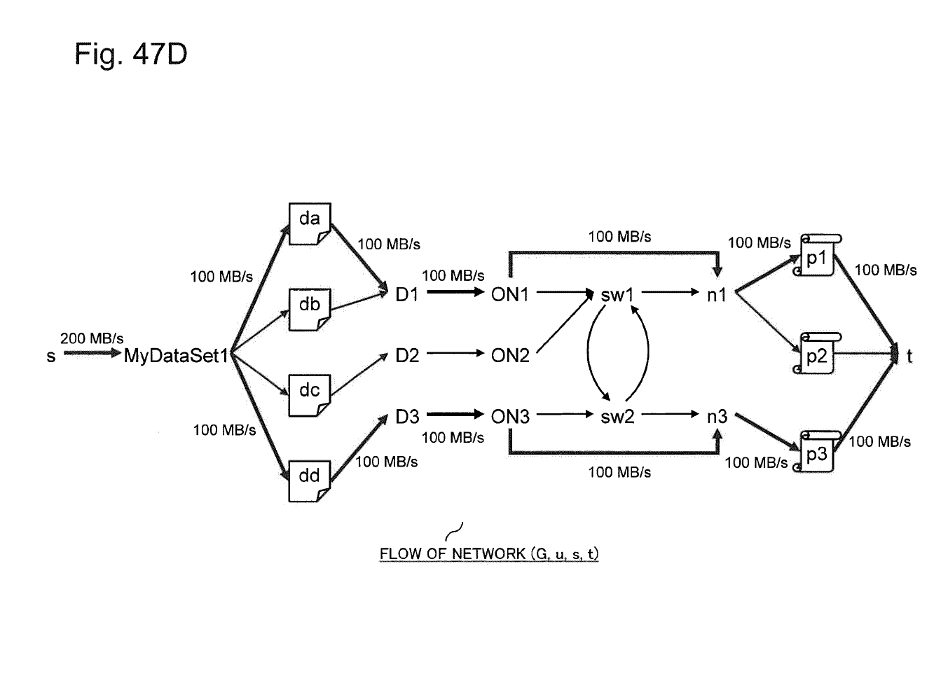

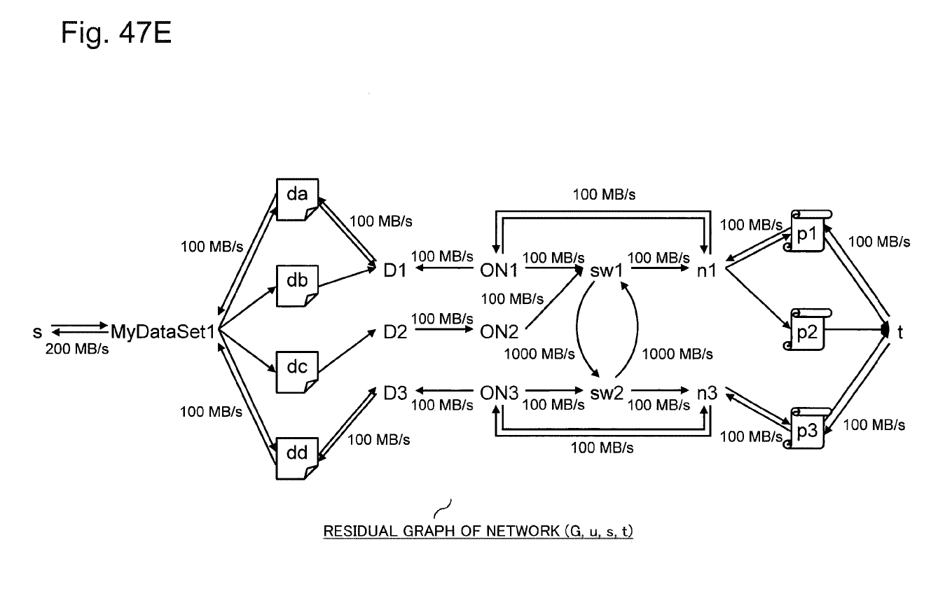

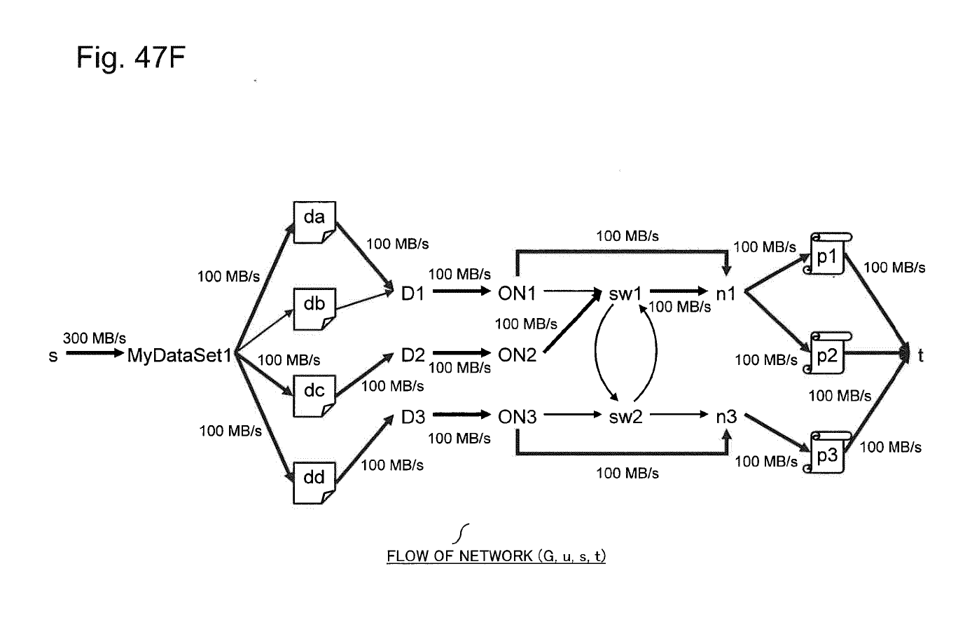

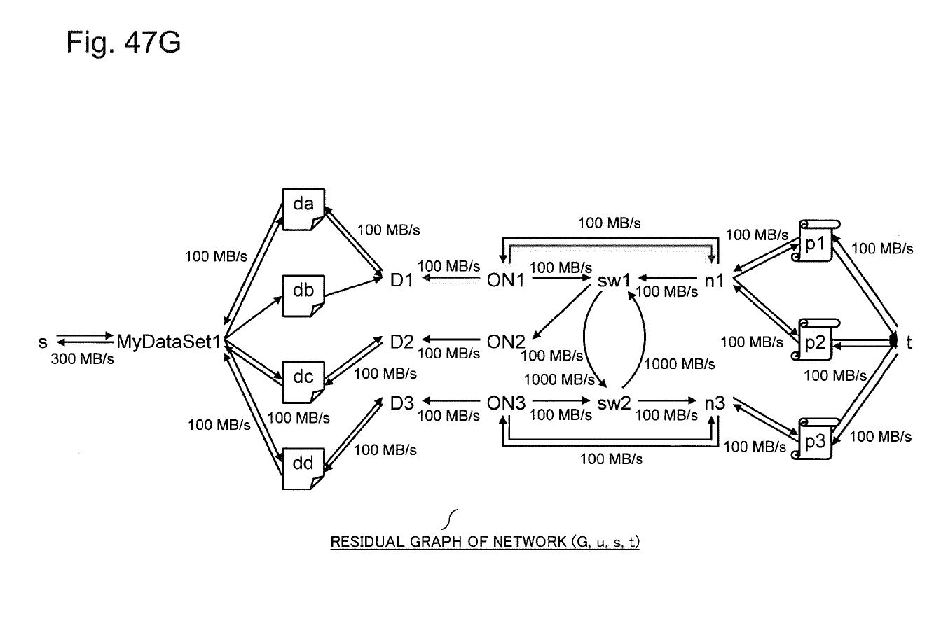

A specific example of operation using the flow increase method in the maximum flow problem is mentioned later with reference to FIGS. 47A to 47G.

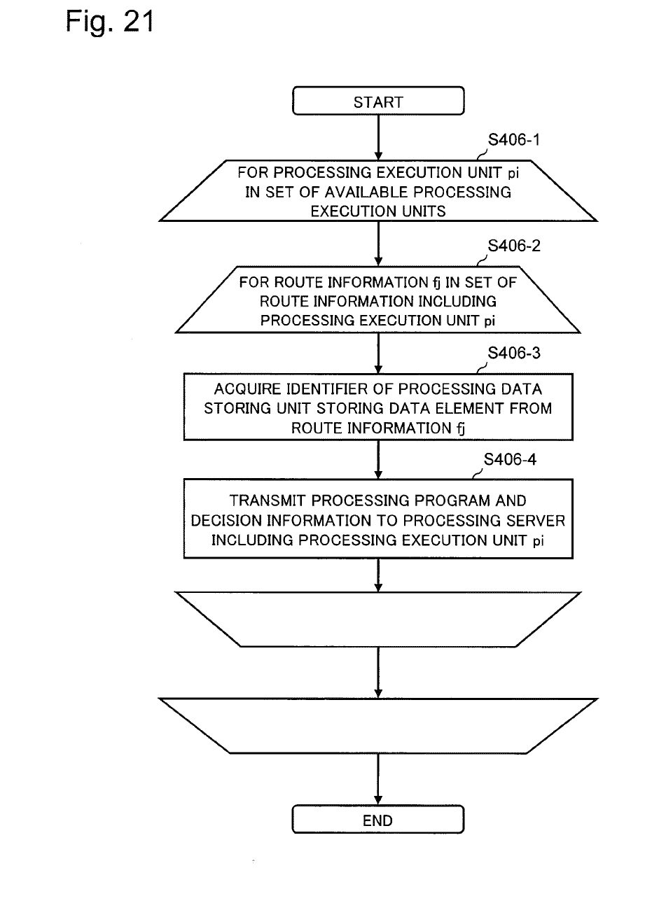

FIG. 21 is a flow chart showing operation of the distributed processing management server 300 in Step S406.

The processing allocation unit 303 in the distributed processing management server 300 processes Step S406-2 for each processing execution unit pi in the set of available processing execution units 332 (Step S406-1).

The processing allocation unit 303 processes Step S406-3 to Step S406-4 for each piece of route information fj in the set of pieces of route information including the processing execution unit pi (Step S406-2). Note that each route information fj is included in the data-flow information generated in Step S405.

The processing allocation unit 303 acquires the identifier of the processing data storing unit 342 of the data server 340, which indicates a storage location of a data element for the route information fj calculated by the optimum arrangement calculation unit 302, from the route information fj (Step S406-3). Next, the processing allocation unit 303 transmits a processing program and decision information to the processing server 330 including the processing execution unit pi (Step S406-4). Here, the processing program is a processing program for directing to transmit a data element from the processing data storing unit 342 of the data server 340 storing the data element with unit processing amount specified by the above-mentioned data-flow information. The data server 340, the processing data storing unit 342, the data element and the unit processing amount are specified by information included in the decision information.

The first effect of the distributed system 350 according to the exemplary embodiment is a system including a plurality of data servers 340 and a plurality of processing servers 330 can realize data transmission/reception between the servers, which maximizes a processing amount per unit time as the whole system.

The reason is because the distributed processing management server 300 determines the data server 340 and the processing execution unit 332 which perform transmission/reception from whole of arbitrary combinations of each data server 340 and a processing execution unit 332 of each processing server 330, taking into consideration a communication bandwidth at the time of the data transmission/reception in the distributed system 350.

The data transmission/reception of the distributed system 350 reduces an adverse effect caused by a bottleneck of a data transfer bandwidth in a device such as a storage device, or a network.

In the distributed system 350 according to the exemplary embodiment, the distributed processing management server 300 takes into consideration a communication bandwidth at the time of data transmission/reception in the distributed system 350 based on arbitrary combinations of each data server 340 and a processing execution unit 332 in each processing server 330. Therefore, the distributed system 350 of this exemplary embodiment can generate information for determining a data transfer route which maximizes the total processing data amount of all processing servers 330 per unit time in a system in which a plurality of data servers 340 storing data and a plurality of processing servers 330 processing the data are arranged in a distributed manner.

In addition, the data transmission/reception of the distributed system 350 according to the exemplary embodiment can improve the utilization efficiency of a data transfer bandwidth in a device such as a storage device or a network, compared with the related technology. It is because the distributed processing management server 300 takes into consideration a communication bandwidth at the time of data transmission/reception in the distributed system 350 based on arbitrary combinations of each data server 340 and a processing execution unit 332 in each processing server 330, in the distributed system 350 according to the exemplary embodiment. Specifically, it is because the distributed system 350 operates as follows. First, the distributed system 350 specifies a combination which utilizes an available communication bandwidth maximally from arbitrary combinations of each data server 340 and a processing execution unit 332 in each processing server 330. That is, the distributed system 350 specifies arbitrary combination of each data server 340 and a processing execution unit 332 in each processing server 330 which maximize a total data amount per unit time received by the processing server 330. Then, the distributed system 350 generates information for determining a data transfer route based on the specified combination. By the above operation, the distributed system 350 according to the exemplary embodiment provides the above-mentioned effects.

### Second Exemplary Embodiment

A second exemplary embodiment will be described in detail with reference to drawings. A distributed processing management server 300 of this exemplary embodiment deals with multiplexed data stored in a plurality of data servers 340. The data is partial data in a logical data set. The partial data includes a plurality of data elements.

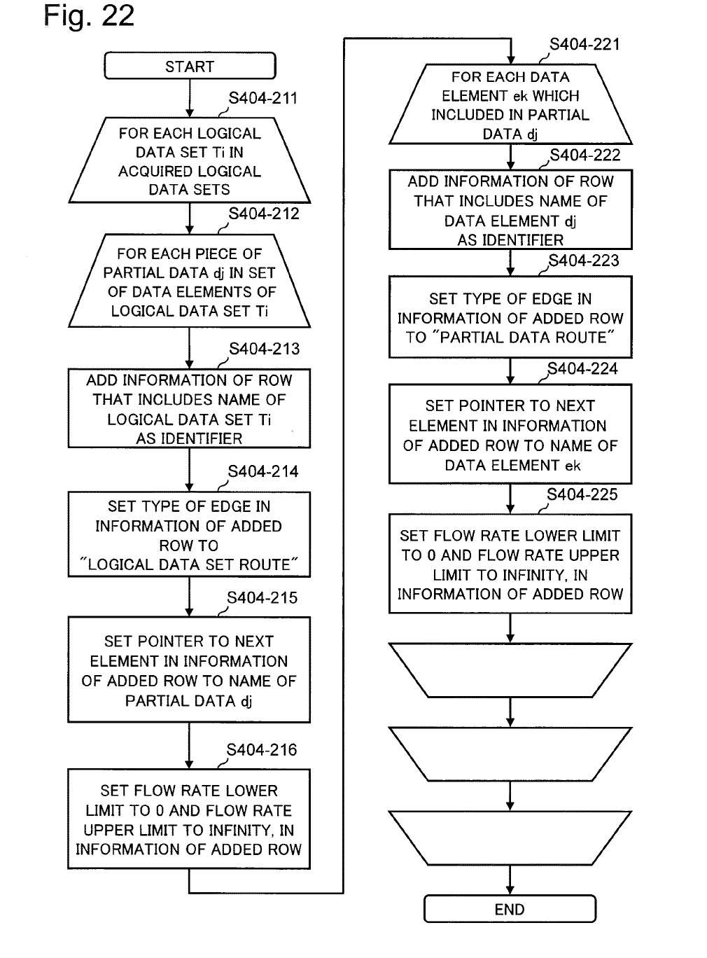

FIG. 22 is a flow chart showing operation of the distributed processing management server 300 in Step S404-20 of the second exemplary embodiment. In this exemplary embodiment, in addition to the processing of the first exemplary embodiment, a plurality of pieces of partial data are added to the model. The model generation unit 301 of the distributed processing management server 300 processes Step S404-212 for each logical data set Ti in the acquired data sets (Step S404-211).

The model generation unit 301 processes Step S404-213 to Step S404-216 and Step S404-221 for each piece of partial data dj in the set of pieces of partial data of a logical data set Ti which is specified based on the received request information (Step S404-212). Here, each piece of partial data dj includes a plurality of data elements ek.

The model generation unit 301 adds information of a row that includes the name of the logical data set Ti as an identifier on the table of model information 500 (Step S404-213). Next, the model generation unit 301 sets a type of an edge in the added row to “logical data set route” (Step S404-214). Next, the model generation unit 301 sets a pointer to the next element in the added row to the name of the partial data dj (Step S404-215).

Next, the model generation unit 301 sets a flow rate lower limit to 0 and sets a flow rate upper limit to infinity, in the added row (Step S404-216).

Next, the model generation unit 301 processes Step S404-222 to Step S404-225 for each data element ek which included in partial data dj (Step S404-221).

The model generation unit 301 adds information of a row that includes the name of the partial data dj as an identifier on the table of model information 500 (Step S404-222). Next, the model generation unit 301 sets a type of an edge in the added row to “partial data route” (Step S404-223). Next, the model generation unit 301 sets a pointer to the next element in the added row to an identifier of the data element ek (Step S404-224). Next, the model generation unit 301 sets a flow rate lower limit to 0 and sets a flow rate upper limit to infinity, in the added row (Step S404-225).

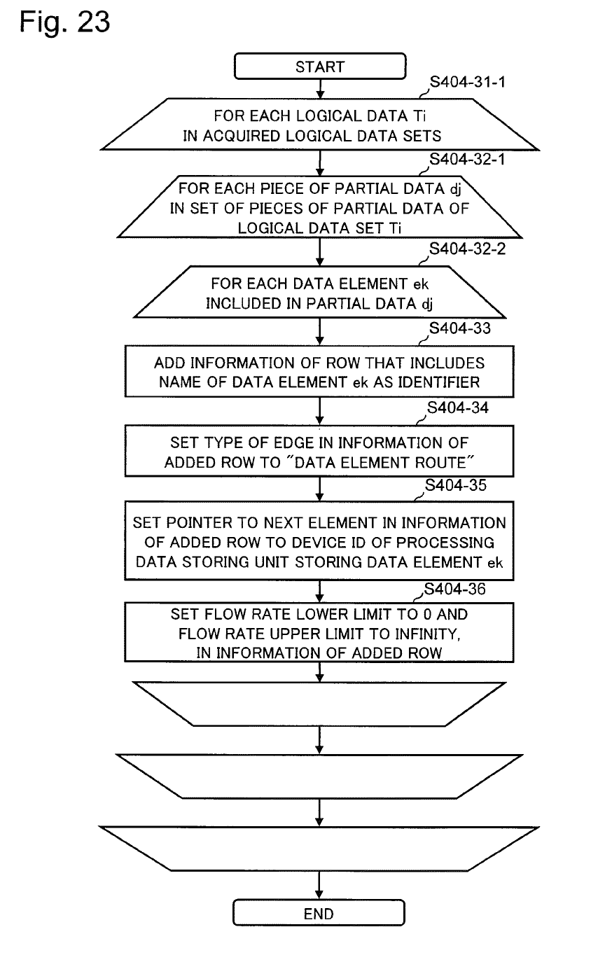

FIG. 23 is a flow chart showing operation of the distributed processing management server 300 in Step S404-30 in the exemplary embodiment. In this exemplary embodiment, in addition to the processing of the first exemplary embodiment, a data element route is specified and added to the model for each of a plurality of data elements.

The model generation unit 301 in the distributed processing management server 300 processes Step S404-32-1 for each logical data set Ti in the set of logical data sets acquired from the data location storing unit 3070 based on the received request information (Step S404-31-1).

The model generation unit 301 processes Step S404-32-2 for each piece of partial data dj in the set of pieces of partial data of logical data set Ti (Step S404-32-1). Here, each piece of partial data dj includes a plurality of data elements ek.

The model generation unit 301 processes Step S404-33 to Step S404-36 for each data element ek included in partial data dj (Step S404-32-2).

The model generation unit 301 adds information of a row that includes the identifier of the data element ek as an identifier on the table of model information 500 (Step S404-33). Next, the model generation unit 301 sets a type of an edge in the added row to “data element route” (Step S404-34). Next, the model generation unit 301 sets a pointer to the next element in the added row to the device ID which indicates the processing data storing unit 342 of the data server 340 storing the data element ek (Step S404-35). Next, the model generation unit 301 sets a flow rate lower limit to 0 and sets a flow rate upper limit to infinity, in the added row (Step S404-36).

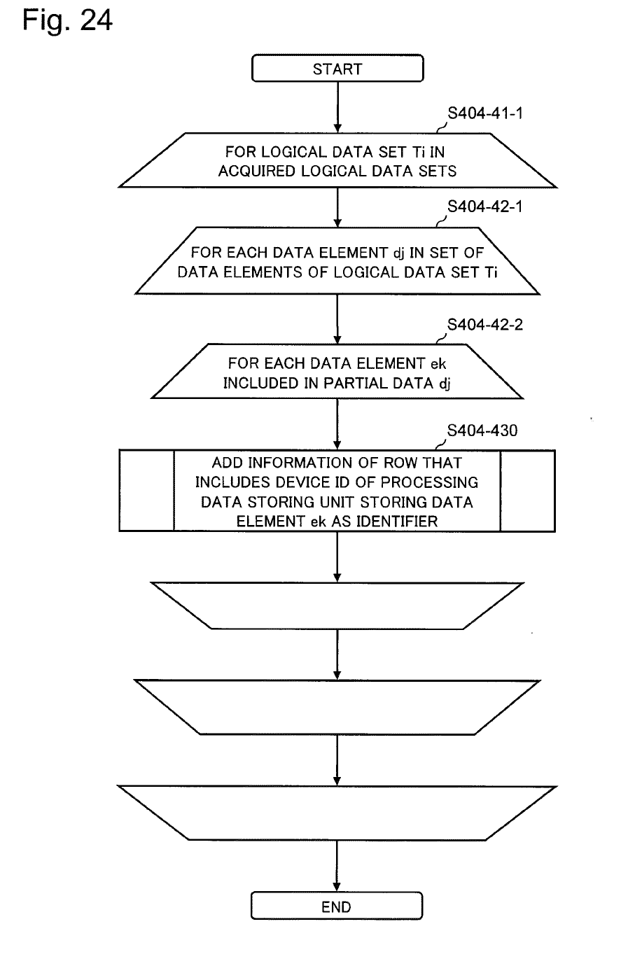

FIG. 24 is a flow chart showing operation of the distributed processing management server 300 in Step S404-40 in the exemplary embodiment. In this exemplary embodiment, in addition to the processing of the first exemplary embodiment, a data element route is specified and added to the model for each of a plurality of data elements.

The model generation unit 301 in the distributed processing management server 300 processes Step S404-42-1 for each logical data set Ti in the set of logical data sets acquired from the data location storing unit 3070 based on the received request information (Step S404-41-1).

The model generation unit 301 processes Step S404-42-2 for each piece of partial data dj in the set of pieces of partial data of logical data set Ti (Step S404-42-1). Here, each piece of partial data dj includes a plurality of data elements ek.

The model generation unit 301 processes Step S404-430 for each data element ek included in partial data dj (Step S404-42-2).

The model generation unit 301 adds information of a row that includes the device ID i which indicates the processing data storing unit 342 storing the data element ek as an identifier, on the table of model information 500 (Step S404-430). The processing of Step S404-430 is similar to the processing by the model generation unit 301 in Step of the same name in the first exemplary embodiment.

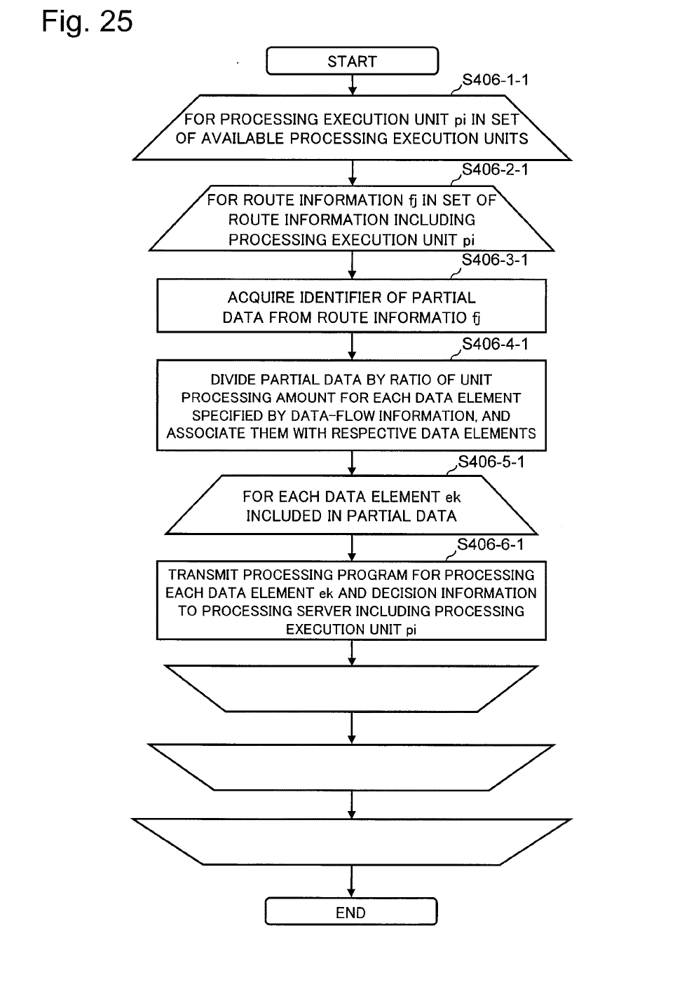

FIG. 25 is a flow chart showing operation of the distributed processing management server 300 in Step S406 of the exemplary embodiment. This exemplary embodiment is changed from the first exemplary embodiment so that a processing execution unit 332 is allocated to plural pieces of partial data. The processing allocation unit 303 in the distributed processing management server 300 processes Step S406-2-1 for each processing execution unit pi in the set of available processing execution units 332 (Step S406-1-1). The processing allocation unit 303 processes Step S406-3-1 to Step S406-5-1 for each piece of route information fj in the set of pieces of route information including the processing execution unit pi (Step S406-2-1).

The processing allocation unit 303 acquires information which shows partial data from the route information fj (Step S406-3-1). Next, the processing allocation unit 303 divides the partial data by the ratio of the unit processing amount for each data element specified by data-flow information which includes a node representing the partial data in a route, and associates the divided partial data regarding the unit processing amount of the route information fj with a data element represented by a node in the route information fj (Step S406-4-1).

Specifically, the processing allocation unit 303 specifies the size of the partial data corresponding to information which shows a partial data acquired in Step S406-3-1, in information stored in the data location storing unit 3070. The processing allocation unit 303 divides the partial data by the ratio of the unit processing amount for each piece of data element specified by data-flow information which includes a node representing the partial data in a route. For example, it is assumed that both of the first route information and the second route information are route information including a node representing a certain partial data, and the unit processing amount for the first route information is 100 MB/s, and the unit processing amount for the second route information is 50 MB/s. In addition, it is assumed that the size of the processed partial data is 300 MB. In this case, a partial data is divided into data (data 1) of 200 MB and data (data 2) of 100 MB based on the ratio (2:1) of the unit processing amount of the first route information and the unit processing amount of the second route information. The information indicating data 1 and the information indicating data 2 are the reception data specification information shown in FIG. 10. The processing allocation unit 303 associates the divided partial data (data 1) regarding the unit processing amount of the route information fj (the first route information, for example) with the data element (ek) regarding the route information fj. That is, the processing allocation unit 303 associates the data element which is included in the route shown by the first route information and data 1.

Next, the processing allocation unit 303 processes Step S406-6-1 for the data element ek (Step S406-5-1).

The processing allocation unit 303 transmits a processing program and decision information to the processing server 330 including the processing execution unit pi (Step S406-6-1). Here the processing program is a processing program for directing to transmit the divided part of the partial data corresponding to ek from the processing data storing unit 342 of the data server 340 including the data element ek with unit processing amount specified by data-flow information. The data server 340, the processing data storing unit 342 and the divided part of the partial data corresponding to the data element ek and unit processing amount are specified by information included in the decision information.

The first effect provided by the second exemplary embodiment is that data transmission/reception between servers which maximizes a processing amount per unit time as a whole when partial data in a logical data set is multiplexed and stored in a plurality of data servers 340, can be realized.

The reason is because the distributed processing management server 300 operates as follows. The distributed processing management server 300 generates a network model required to acquire the multiplexed partial data, taking into consideration a communication bandwidth at the time of the data transmission/reception in the distributed system 350, based on whole of arbitrary combinations of each data server 340 and a processing execution unit 332 of each processing server 330. Then, the distributed processing management server 300 determines the data server 340 and the processing execution unit 332 which perform transmission/reception based on the network model. The distributed processing management server 300 in the second exemplary embodiment provides the above-mentioned effect by these operations.

### Third Exemplary Embodiment

A third exemplary embodiment will be described in detail with reference to drawings. The distributed processing management server 300 of this exemplary embodiment corresponds to the distributed system 350 in case processing servers 330 have different processing performances from each other.

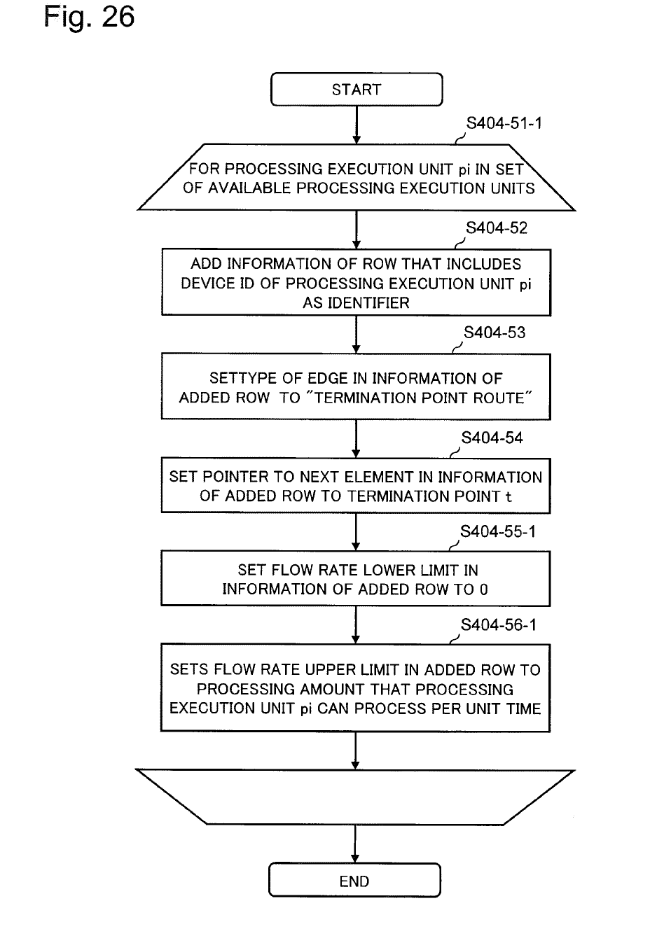

FIG. 26 is a flow chart showing operation of the distributed processing management server 300 in Step S404-50 of the third exemplary embodiment. In this exemplary embodiment, in addition to the processing of the first exemplary embodiment, a throughput determined according to the processing performance of the processing server 330 is added to the model.

The model generation unit 301 in the distributed processing management server 300 processes Step S404-52 to Step S404-56-1 for each processing execution unit pi in a set of available processing execution units 332 (Step S404-51-1).

The model generation unit 301 adds information of a row that includes the device ID which indicates the processing execution unit pi as an identifier on the table of model information 500 (Step S404-52). Next, the model generation unit 301 sets a type of an edge in the added row to “termination point route” (Step S404-53). Next, the model generation unit 301 sets a pointer to the next element in the added row to a termination point t (Step S404-54). The model generation unit 301 sets a flow rate lower limit in the added row to 0 (Step S404-55-1).

Next, the model generation unit 301 sets a flow rate upper limit in the added row to a processing amount that the processing execution unit pi can process per unit time (Step S404-56-1). This processing amount is determined based on the configuration information 3063 or the like of the processing server 330 stored in the server status storing unit 3060. For example, this processing amount is determined based on data processing amount in a unit time per CPU frequency of 1 GHz. The processing amount may be determined based on other information or a plurality of pieces of information.

For example, the model generation unit 301 may determine this processing amount by referring to load information 3062 on the processing server 330 stored in the server status storing unit 3060. This processing amount may be different in every logical data set or every piece of partial data (or data element). In this case, the model generation unit 301 calculates, for every logical data set and every partial piece of data (or data element), the processing amount per unit time of the data, based on the configuration information 3063 or the like of the processing server 330. The model generation unit 301 also generates a conversion table showing a load ratio between the data and other data. The conversion table is referred to by the optimum arrangement calculation unit 302 in Step S405.

The first effect provided by the third exemplary embodiment is that data transmission/reception between servers which maximizes a processing amount per unit time as a whole taking into consideration a difference in a processing performance between processing servers can be realized.

The reason is because the distributed processing management server 300 operates as follows. First, the distributed processing management server 300 generates a network model on which processing amount per unit time determined by the processing performance of each processing server 330 as a restriction is introduced. Then the distributed processing management server 300 determines a data server 340 and a processing execution unit 332 which perform transmission/reception based on the network model. By the above mentioned operation, the distributed processing management server 300 in the third exemplary embodiment provides the above-mentioned effect.

### Fourth Exemplary Embodiment

A fourth exemplary embodiment will be described in detail with reference to drawings. The distributed processing management server 300 of this exemplary embodiment corresponds to a case where an upper limit value or a lower limit value is set to an occupied communication bandwidth for acquiring a partial data (or data element) in the specific logical data set, for a program which is requested to execute in the distributed system 350.

Note that one unit of processing of program which is requested to execute in the distributed system 350 is represented as a job.

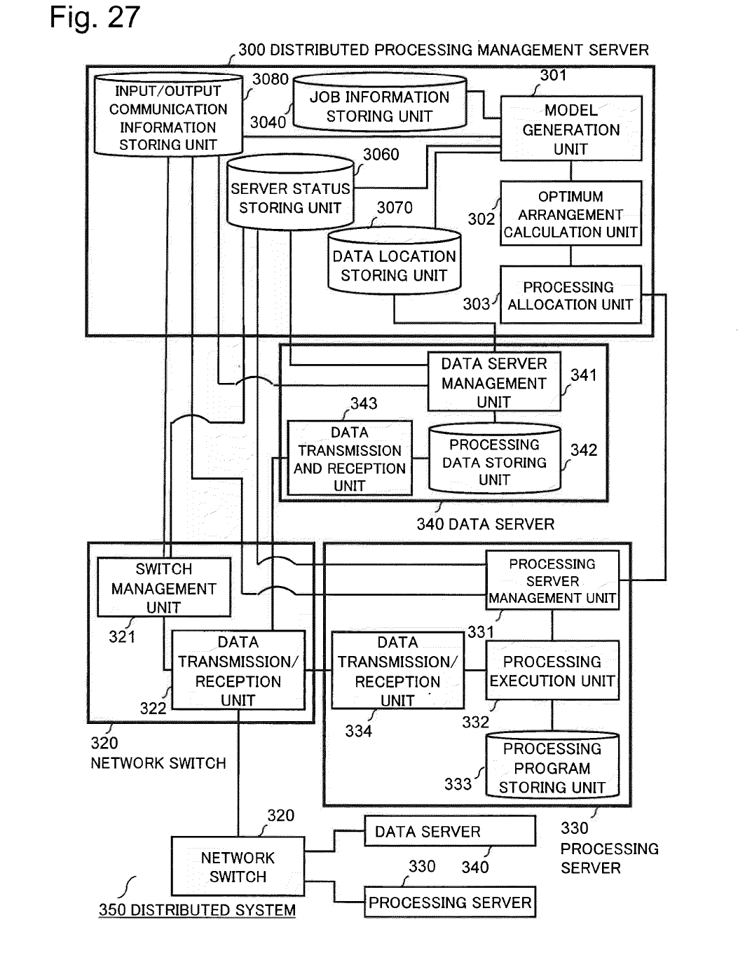

FIG. 27 is a block diagram showing a configuration of the distributed system 350 in the exemplary embodiment. The distributed processing management server 300 in the exemplary embodiment further includes a job information storing unit 3040, in addition to a storing unit and a component included in the distributed processing management server 300 of the first exemplary embodiment.

===Job Information Storing Unit 3040===

The job information storing unit 3040 stores configuration information about a processing of the program which is requested to execute in the distributed system 350.

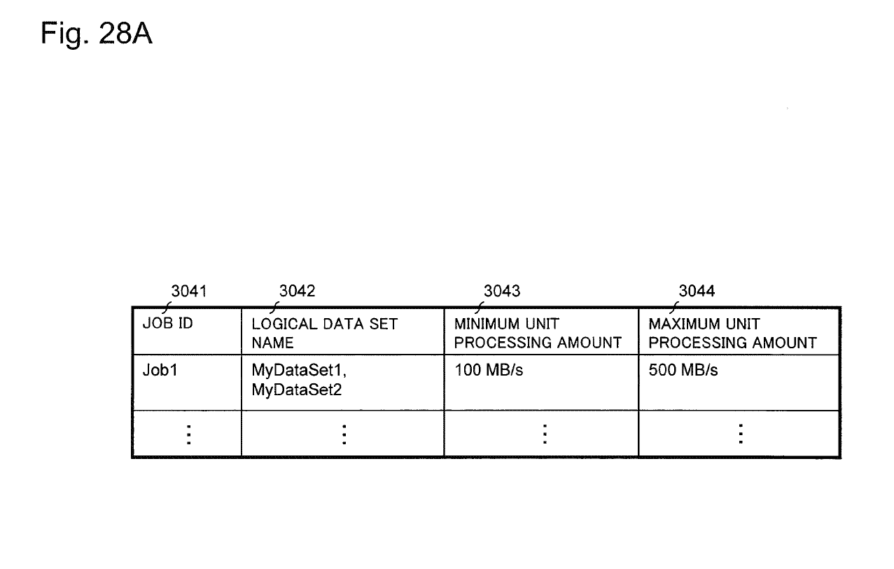

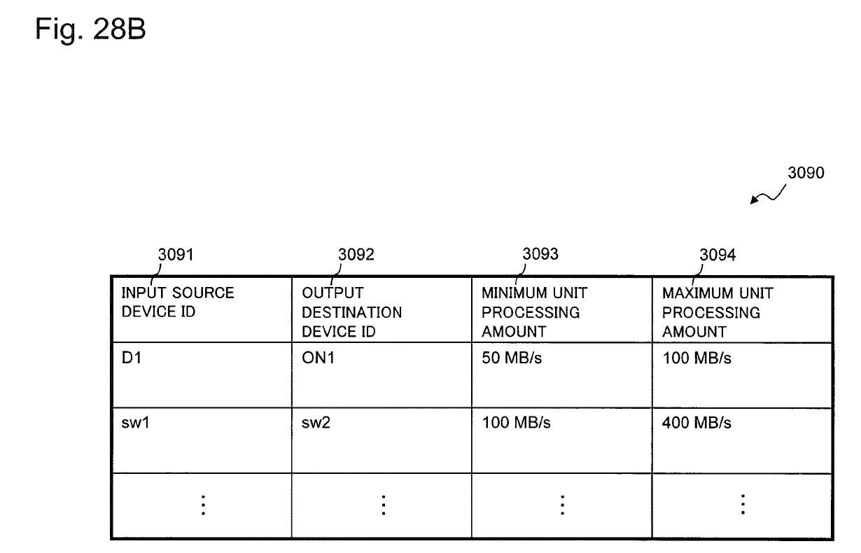

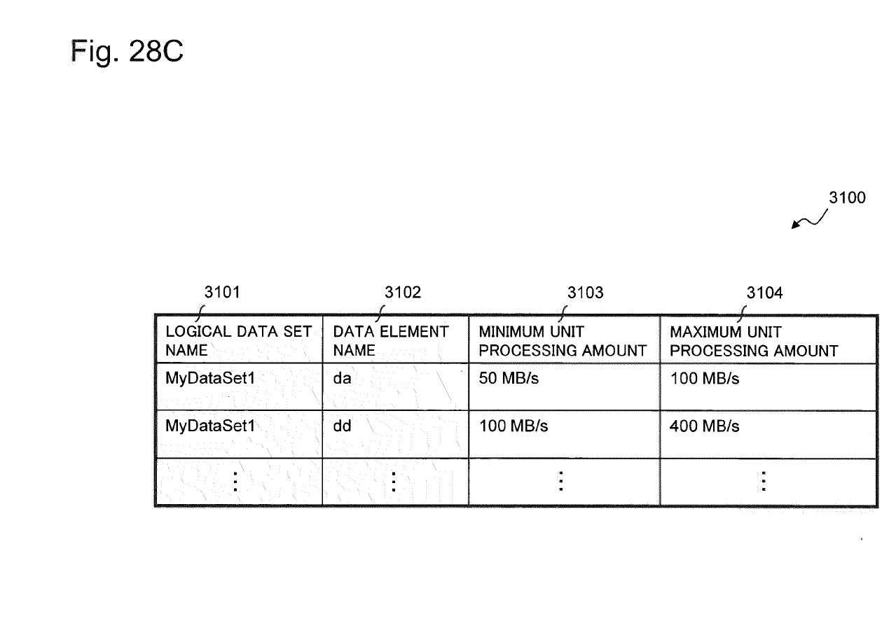

FIG. 28A exemplifies configuration information stored in the job information storing unit 3040. The job information storing unit 3040 includes a job ID 3041, a logical data set name 3042, minimum unit processing amount 3043 and maximum unit processing amount 3044.

The job ID 3041 is an identifier, which is unique in the distributed system 350, and which is allocated for every job executed by the distributed system 350. The logical data set name 3042 is a name (an identifier) of the logical data set handled by the job. The minimum unit processing amount 3043 is a lowest value of processing amount per unit time specified to the logical data set. The maximum unit processing amount 3044 is a maximum value of processing amount per unit time specified to the logical data set.

When one job handles a plurality of logical data sets, there may be a plurality of pieces of information of rows that store different logical data set names 3042, minimum unit processing amount 3043 and maximum unit processing amount 3044 for one job ID.

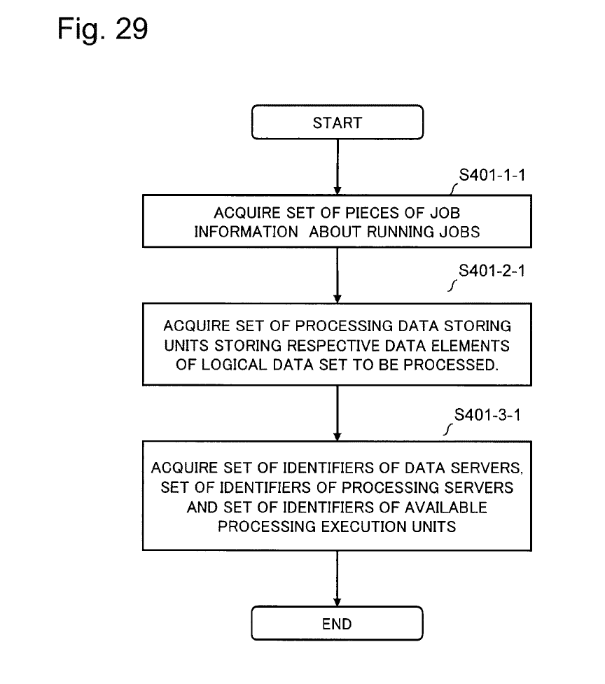

FIG. 29 is a flow chart showing operation of the distributed processing management server 300 in Step S401 of the fourth exemplary embodiment.

The model generation unit 301 acquires a set of jobs which are being executed from the job information storing unit 3040 (Step S401-1-1). Next, the model generation unit 301 acquires a set of identifiers of processing data storing units 342 storing respective data elements of a logical data set to be processed which is specified by a data processing request from the data location storing unit 3070 (Step S401-2-1).

Next, the model generation unit 301 acquires a set of identifiers of processing data storing units 342 in the data server 340, a set of identifiers of processing servers 330 and a set of identifiers of available processing execution units 332 from the server status storing unit 3060 (Step S401-3-1).

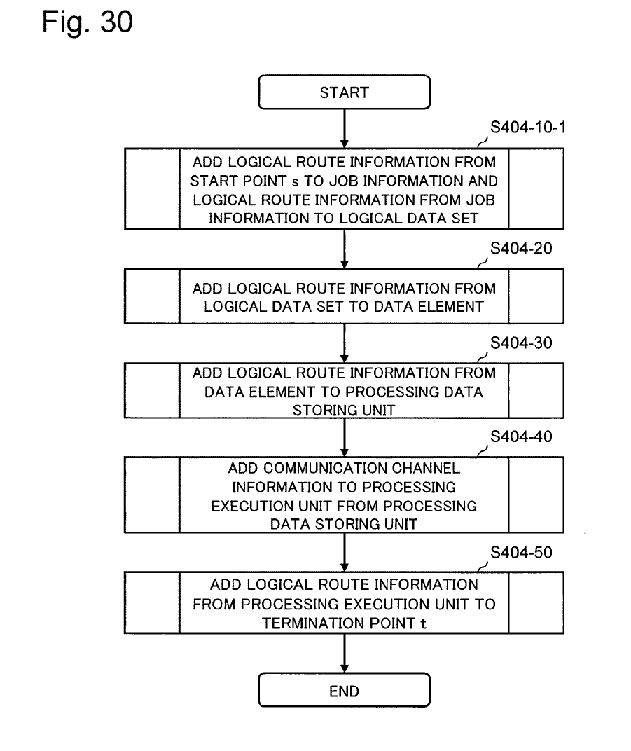

FIG. 30 is a flow chart showing operation of the distributed processing management server 300 in Step S404 of the fourth exemplary embodiment.

The model generation unit 301 adds logical route information from a start point s to the job and logical route information from the job to the logical data set on the table of model information 500 (Step S404-10-1). The logical route information from a start point s to the job is information of a row having a type of an edge as “start point route” in the table of model information 500. The logical route information from the job to the logical data set is information of a row that includes a type of an edge as “job information route” in the table of model information 500.

Next, the model generation unit 301 adds logical route information from the logical data set to a data element on the table of model information 500 (Step S404-20). The logical route information from the logical data set to a data element is information of a row that includes a type of an edge as “logical data set route” in the table of model information 500.

Next, the model generation unit 301 adds logical route information from the data element to the processing data storing unit 342 of the data server 340 storing the data element on the table of model information 500 (Step S404-30). This logical route information is information of a row that includes a type of an edge as “data element route” in the above-mentioned table of model information 500.

The model generation unit 301 acquires input/output route information which indicates information about a communication channel for processing the data element constituting the logical data set by the processing execution unit 332 of the processing server 330, from the input/output communication channel information storing unit 3080. The model generation unit 301 adds information about the communication channel based on the acquired input/output route information on the table of model information 500 (Step S404-40). The information about the communication channel is information of a row having a type of an edge as “input/output route” in the above-mentioned table of model information 500.

Next, the model generation unit 301 adds logical route information from a processing execution unit 332 to a termination point t on the table of model information 500 (Step S404-50). The logical route information is information of a row that includes a type of an edge as “termination point route” in the above-mentioned table of model information 500.

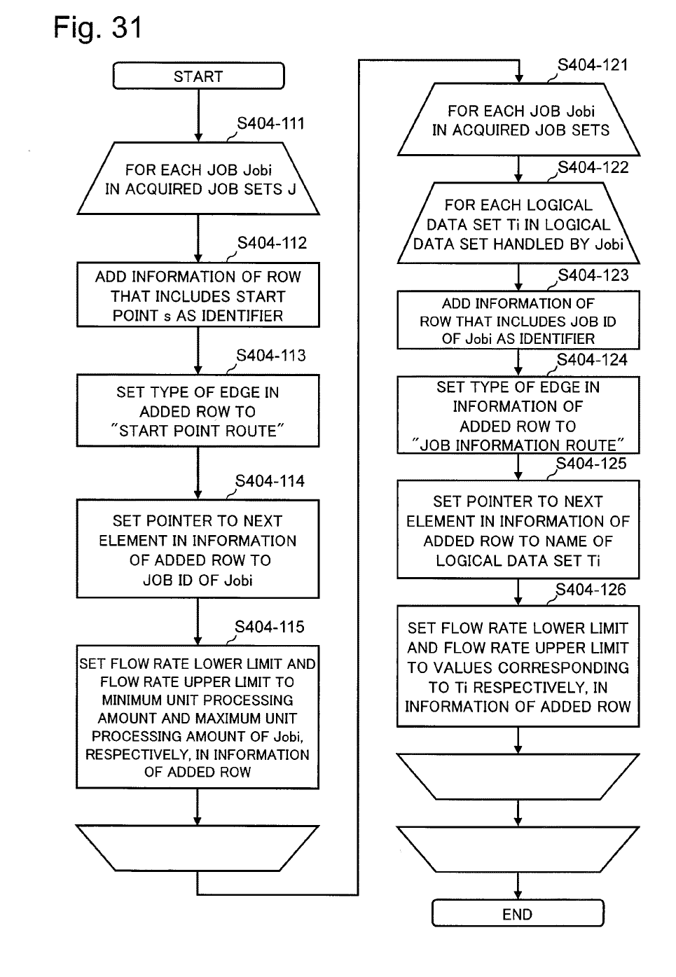

FIG. 31 is a flow chart showing operation of the distributed processing management server 300 in Step S404-10-1 of the fourth exemplary embodiment.

The model generation unit 301 in the distributed processing management server 300 processes Step S404-112 to Step S404-115 for each job Jobi in the acquired set of jobs J (Step S404-111).

The model generation unit 301 adds information of a row that includes s as an identifier on the table of model information 500 (Step S404-112). The model generation unit 301 sets a type of an edge in the added row to “start point route” (Step S404-113). Next, the model generation unit 301 sets a pointer to the next element in the added row to a job ID of Jobi (Step S404-114). Next, the model generation unit 301 sets a flow rate lower limit and a flow rate upper limit in the added row to a minimum unit processing amount and a maximum unit processing amount of Jobi, respectively, based on the information stored in the job information storing unit 3040 (Step S404-115).

Next, the model generation unit 301 processes Step S404-122 for each job Jobi in the set of jobs J (Step S404-121).

The model generation unit 301 processes Step S404-123 to Step S404-126 for each logical data set Ti in the logical data set handled by Jobi (Step S404-122).

The model generation unit 301 adds information of a row that includes Jobi as an identifier on the table of model information 500 (Step S404-123). Next, the model generation unit 301 sets a type of an edge in the added row to “logical data set route” (Step S404-124). Next, the model generation unit 301 sets a pointer to the next element in the added row to the name (logical data set name) of the logical data set Ti (Step S404-125). Next, the model generation unit 301 sets a flow rate lower limit and a flow rate upper limit to a flow rate lower limit and a flow rate upper limit corresponding to information of the row that includes Ti as a logical data set name in the job information storing unit 3040, respectively, in the added row (Step S404-126).

In the exemplary embodiment, the optimum arrangement calculation unit 302 determines s-t-flow F which maximizes an objective function for a network (G, l, u, s, t) which is shown by the model information outputted by the model generation unit 301. Then, the optimum arrangement calculation unit 302 outputs a corresponding table of route information and the flow rate which satisfies the s-t-flow F.

Here, 1 in the network (G, l, u, s, t) is the minimum flow rate function from a communication channel e between devices to the minimum flow rate for the e. u is a capacity function from the communication channel e between devices to an available bandwidth for e. That is, u is a capacity function u: E→R+. Note that R+ is a set which shows a positive real number. E is a set of communication channels e. G in the network (G, l, u, s, t) is a directed graph G=(V, E) restricted by the minimum flow rate function l and the capacity function u.

s-t-flow F is determined by the flow rate function f which satisfies l(e)≦f(e)≦u(e) for all eεE on the graph G except for vertexes s and t.

That is, the constraint expressions of this exemplary embodiment are obtained by replacing Equation (3) of [Mathematical Equation 1] with the following Equation (4) of [Mathematical Equation 2].

[Mathematical Equation 2]

s.t. l(e)≦f(e)≦u(e)(eεE) (4)

In [Mathematical Equation 2], l (e) is the function that shows a lower limit of the flow rate in the edge e.

The first effect provided by the fourth exemplary embodiment is that data transmission/reception between servers which maximizes a processing amount per unit time as a whole taking into consideration an upper limit or a lower limit which is set to an occupied communication bandwidth for acquiring a partial data (or data element) in a specific logical data set can be realized.

The reason is because the distributed processing management server 300 operates as follows. First, the distributed processing management server 300 generates a network model on which an upper limit or a lower limit that is set to an occupied communication bandwidth for acquiring partial data (or data element) is introduced as a restriction. Then the distributed processing management server 300 determines a data server 340 and a processing execution unit 332 which perform transmission/reception based on the network model. By the above mentioned operation, the distributed processing management server 300 in the fourth exemplary embodiment provides the above-mentioned effect.

The second effect provide by the fourth exemplary embodiment is that, when a priority is set to a specific logical data set and a partial data (or data element), data transmission/reception between servers which satisfies a restriction of the set priority and maximizes a processing amount per unit time as a whole can be realized.

The reason is because the distributed processing management server 300 has the following function. That is, the distributed processing management server 300 sets the priority set to the logical data set and the partial data (or data element) as a ratio of an occupied communication bandwidth for acquiring a logical data set and a partial data (or data element). By having the above mentioned function, the distributed processing management server 300 in the fourth exemplary embodiment provides the above-mentioned effect.

### First Modification of Fourth Exemplary Embodiment

The distributed processing management server 300 in the fourth exemplary embodiment may set an upper limit or a lower limit to an edge on the network model which is shown by information of the row that includes “input/output route” as a type of an edge.

In this case, the distributed processing management server 300 further includes a band limit information storing unit 3090. FIG. 28B is a diagram showing an example of information stored by the band limit information storing unit 3090. Referring to FIG. 28B, the band limit information storing unit 3090 stores an input source device ID 3091, an output destination device ID 3092, minimum unit processing amount 3093 and maximum unit processing amount 3094, in association with each other. The input source device ID 3091 and the output destination device ID 3092 are the identifiers that indicates devices represented by nodes connected to “input/output route”. The minimum unit processing amount 3093 is a lowest value of a communication bandwidth specified to the input/output route. The maximum unit processing amount 3094 is a maximum value of a communication bandwidth specified to the input/output route.

An outline of operation of the distributed processing management server 300 in the first modification of the fourth exemplary embodiment will be described by showing a difference in operation of the distributed processing management server 300 in the fourth exemplary embodiment.

In processing of Step S404-439 of Step S404-40 (refer to FIG. 18A), the model generation unit 301 reads the maximum unit processing amount and the minimum unit processing amount which are associated with the device ID i and the output destination device ID j given in a call of Step S404-430 (refer to FIG. 17) from the band limit information storing unit 3090. The model generation unit 301 sets a flow rate lower limit to the above-mentioned read minimum unit processing amount and sets a flow rate upper limit to the above-mentioned read maximum unit processing amount, in the added row.

In processing of Step S404-4355 of Step S404-40 (refer to FIG. 18B), the model generation unit 301 reads the maximum unit processing amount and the minimum unit processing amount which are associated with the device ID i and the output destination device ID j given in a call of Step S404-430 (refer to FIG. 17) from the band limit information storing unit 3090. The model generation unit 301 sets a flow rate lower limit to the above-mentioned read minimum unit processing amount and sets a flow rate upper limit to the above-mentioned read maximum unit processing amount, in the added row.

The distributed processing management server 300 in the first modification of the fourth exemplary embodiment provides the same function as the distributed processing management server 300 in the fourth exemplary embodiment. The distributed processing management server 300 sets an upper limit value and a lower limit of data flow rate different from an available bandwidth of a data transmission/reception route. Therefore, the distributed processing management server 300 can set a communication bandwidth used by the distributed system 350 arbitrary, irrespectively of an available bandwidth. Accordingly, the distributed processing management server 300 provides the same effect as the distributed processing management server 300 in the fourth exemplary embodiment and can control a load which the distributed system 350 gives to a data transmission/reception route.

### Second Modification of Fourth Exemplary Embodiment

The distributed processing management server 300 in the fourth exemplary embodiment may set an upper limit or a lower limit to the edge on the network model which is shown by information of a row that includes “logical data set route” as a type of an edge.

In this case, the distributed processing management server 300 further includes a band limit information storing unit 3100. FIG. 28C is a diagram showing an example of information stored by the band limit information storing unit 3100. Referring to FIG. 28C, the band limit information storing unit 3100 stores a logical data set name 3101, a data element name 3102, minimum unit processing amount 3103 and maximum unit processing amount 3104, in association with each other. The logical data set name 3101 is a name (identifier) of a logical data set handled by a job. The data element name 3102 is a name (identifier) of a data element shown by a node connected to this “logical data set route”. The minimum unit processing amount 3103 is a lowest value of data flow rate specified to the logical data set route. The maximum unit processing amount 3104 is a maximum value of data flow rate specified to the logical data set route.

An outline of operation of the distributed processing management server 300 in the second modification of the fourth exemplary embodiment will be described by showing a difference in operation of the distributed processing management server 300 in the fourth exemplary embodiment.

In processing of Step S404-26 of Step S404-20 (refer to FIG. 15), the model generation unit 301 reads the maximum unit processing amount and the minimum unit processing amount which are associated with the logical data set name Ti and the data element name dj from the band limit information storing unit 3100. The model generation unit 301 sets a flow rate lower limit to the above-mentioned read minimum unit processing amount and sets a flow rate upper limit to the above-mentioned read maximum unit processing amount, in the added row.

The distributed processing management server 300 in the second modification of the fourth exemplary embodiment provides the same function as the distributed processing management server 300 in the fourth exemplary embodiment. The distributed processing management server 300 sets the upper limit of the data flow rate and the lower limit to the logical data set route. Therefore, the distributed processing management server 300 can control the amount of data processed per unit time for each data element. Accordingly, the distributed processing management server 300 provides the same effect as the distributed processing management server 300 in the fourth exemplary embodiment and can control the priority in processing of each data element.

### Fifth Exemplary Embodiment

A fifth exemplary embodiment will be described in detail with reference to drawings. The distributed processing management server 300 of this exemplary embodiment estimates an available bandwidth of an input/output communication channel from the model information generated by itself and information of a bandwidth allocated in each route based on the data-flow information.

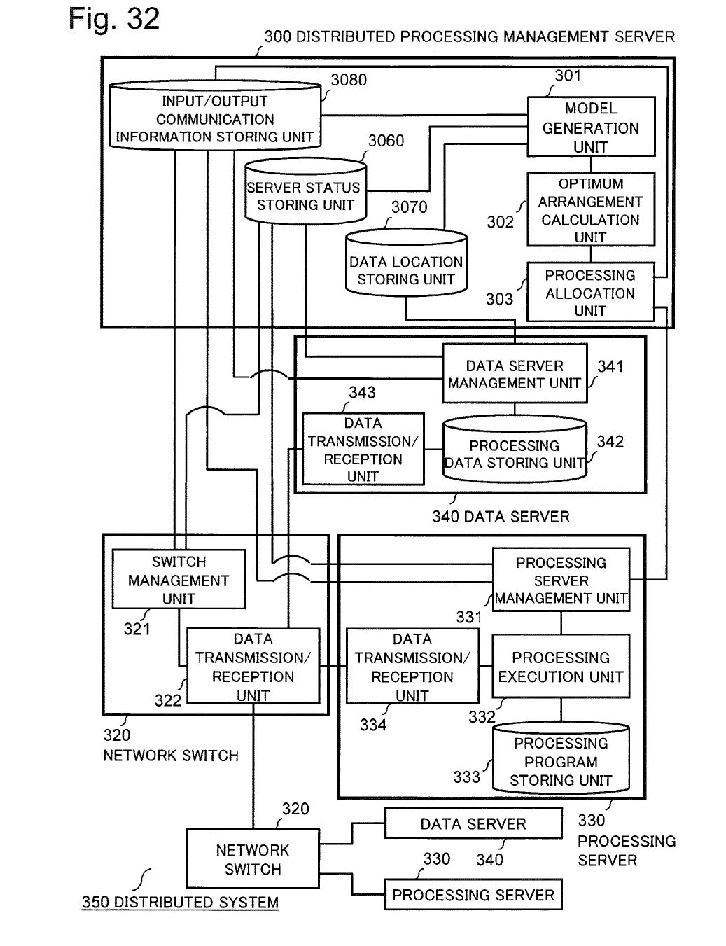

FIG. 32 is a block diagram showing a configuration of the distributed system 350 in the exemplary embodiment. In this exemplary embodiment, the processing allocation unit 303 included in the distributed processing management server 300 further includes a function to update the information showing an available bandwidth of each input/output communication channel stored by the input/output communication channel information storing unit 3080, using information of a bandwidth of the input/output communication channel consumed by allocation of processing to each route.

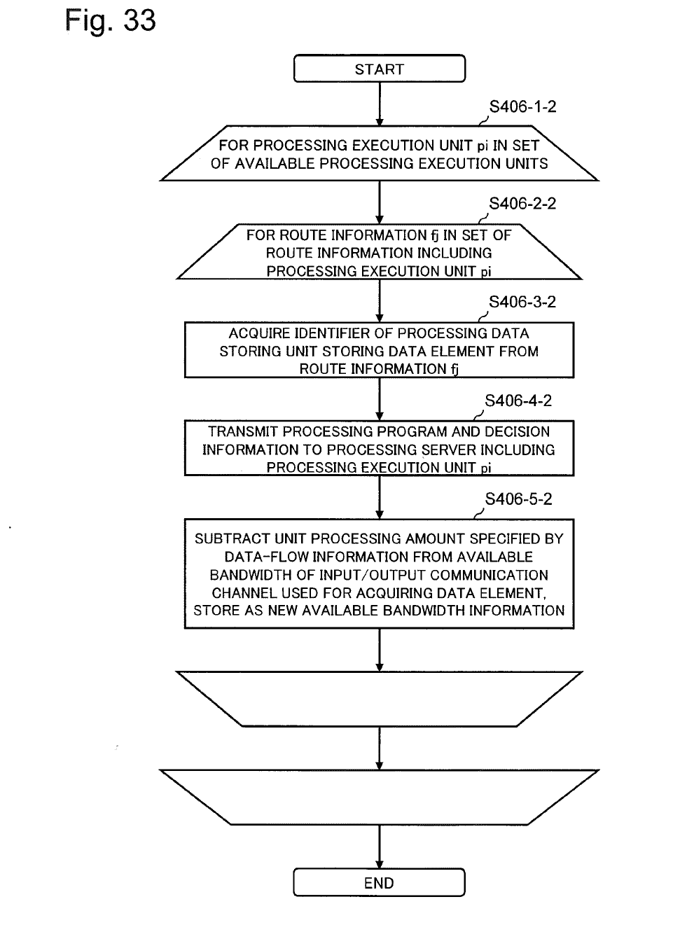

FIG. 33 is a flow chart showing operation of the distributed processing management server 300 in Step S406 of the exemplary embodiment.

The processing allocation unit 303 in the distributed processing management server 300 processes Step S406-2-2 for each processing execution unit pi in the set of available processing execution units 332 (Step S406-1-2).

The processing allocation unit 303 processes Step S406-3-2 for each route information fj in the set of pieces of route information including the processing execution unit pi (Step S406-2-2).

The processing allocation unit 303 acquires information about a data element in the route information from the route information fj (Step S406-3-2).

Next, the processing allocation unit 303 transmits a processing program and decision information to the processing server 330 including the processing execution unit pi (Step S406-4-2). The processing program is a processing program for directing to transmit the data element from the processing data storing unit 342 of the data server 340 including the data element with unit processing amount specified by the data-flow information. The data server 340, the processing data storing unit 342, the data element and the unit processing amount are specified by information included in the decision information.

Next, the processing allocation unit 303 subtracts a unit processing amount specified by the data-flow information from an available bandwidth of the input/output communication channel used for acquiring the data element. And the processing allocation unit 303 stores the value of the subtraction result in the input/output communication channel information storing unit 3080 as new available bandwidth information of the input/output communication channel information for the input/output communication channel (Step S406-5-2).

The first effect provided by the fifth exemplary embodiment is that data transmission/reception between servers which maximizes the processing amount per unit time as a whole, reducing a load for measuring an available bandwidth of an input/output communication channel, can be realized.

The reason is because the distributed processing management server 300 operates as follows. First, the distributed processing management server 300 estimates the current available bandwidth of the communication channel based on the information about the data server 340 and the processing execution unit 332 which perform transmission/reception determined previously. Then, the distributed processing management server 300 generates the network model based on the estimated information. The distributed processing management server 300 determines a data server 340 and a processing execution unit 332 which perform transmission/reception based on the network model. By the above mentioned operation, the distributed processing management server 300 in the fifth exemplary embodiment provides the above-mentioned effect.

### Sixth Exemplary Embodiment

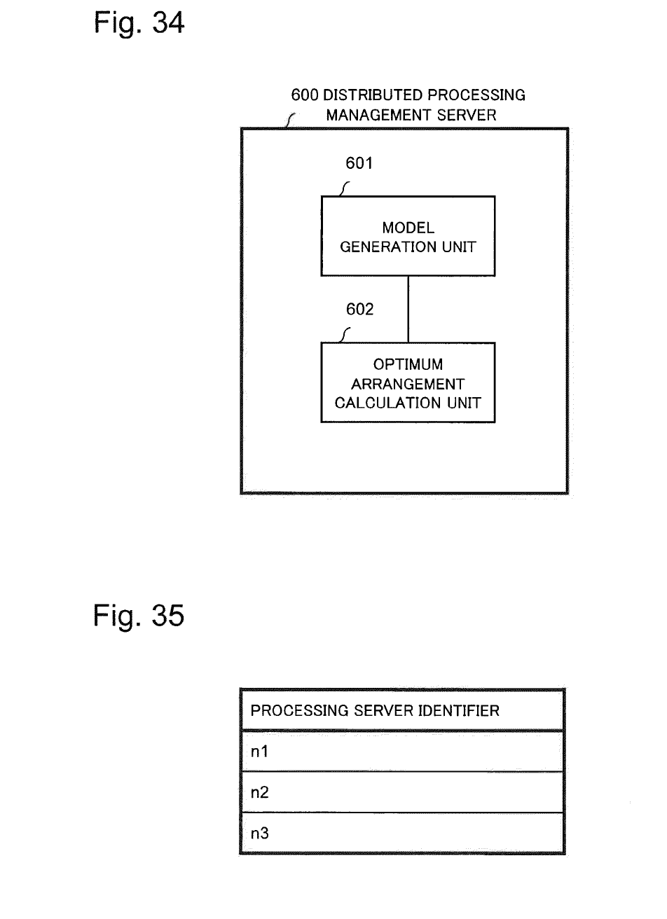

FIG. 34 is a block diagram showing a configuration of a distributed processing management server 600 in a sixth exemplary embodiment.

Referring to FIG. 34, the distributed processing management server 600 includes a model generation unit 601 and an optimum arrangement calculation unit 602.

===Model Generation Unit 601===

The model generation unit 601 generates a network model on which a device constituting a network and a piece of data to be processed are respectively represented by a node. In the network model, a node representing the data and a node representing a data sever storing the data are connected by an edge. In the network model, nodes representing a device constituting the network are also connected an edge, and an available bandwidth for the real communication channel between the devices represented by the nodes connected by the edge is set as a restriction regarding the flow rate of the edge.

The model generation unit 601 may acquire a set of identifiers of processing servers which process data from the server status storing unit 3060 in the first exemplary embodiment, for example. The model generation unit 601 may also acquire a set of pieces of data location information which is information associating a data identifier and a data server identifier storing the data with each other from the data location storing unit 3070 in the first exemplary embodiment, for example. The model generation unit 601 may also acquire a set of pieces of input/output communication channel information which is information associating identifiers of devices constituting a network that connect the data server and the processing server, and bandwidth information which show an available bandwidth in the communication channel between the devices, with each other, from the input/output communication channel information storing unit 3080 in the first exemplary embodiment, for example. In this case, the data server is a data server indicated by the identifier included in a set of pieces of data location information acquired by the model generation unit 601. The processing server is a processing server indicated by a set of pieces of processing server identifiers acquired by the model generation unit 601.

FIG. 35 is a diagram showing an example of a set of identifiers of the processing servers. Referring to FIG. 35, as identifiers of the processing servers, n1, n2 and n3 are shown.

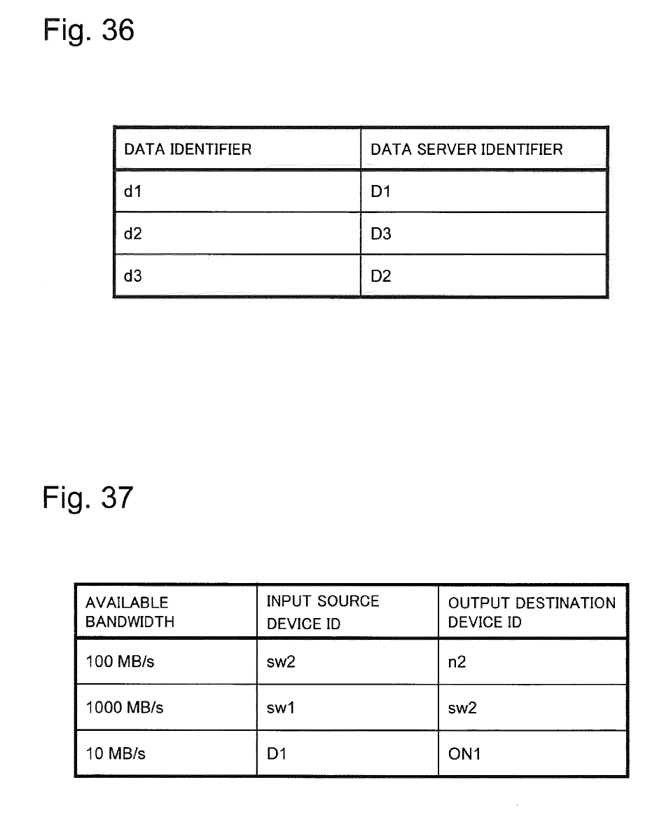

FIG. 36 is a diagram showing an example of a set of pieces of data location information. Referring to FIG. 36, the data indicated by the data identifier d1 is stored in the data server indicated by the data server identifier D1. Similarly, the data indicated by the data identifier d2 is stored in the data server indicated by the data server identifier D3. The data indicated by the data identifier d3 is stored in the data server indicated by the data server identifier D2.

FIG. 37 is a diagram showing an example of a set of pieces of input/output communication channel information. Referring to FIG. 37, an available bandwidth of a communication channel between the device indicated by the input source device ID “sw2” and the device indicated by the output destination device ID “n2” is “100 MB/s”. Similarly, an available bandwidth of a communication channel between the device indicated by the input source device ID “sw1” and the device indicated by the output destination device ID “sw2” is “1000 MB/s”. An available bandwidth of a communication channel between the device indicated by the input source device ID “D1” and the device indicated by the output destination device ID “ON1” is “10 MB/s”.

The model generation unit 601 generates a network model based on the acquired data location information and input/output communication channel information. The network model is a model on which devices and data are respectively represented by a node. The network model is also a model on which a node representing data and a node representing a data server indicated by certain data location information acquired by the model generation unit 601 are connected by an edges. The network model is also a model on which nodes representing devices shown by identifiers included in a certain input/output communication channel information acquired by the model generation unit 601 are connected by an edge, and bandwidth information included in the above-mentioned certain input/output communication channel information is set to the edge as a restriction.

===Optimum Arrangement Calculation unit 602===

The optimum arrangement calculation unit 602 generates data-flow information based on a network model generated by the model generation unit 601. Specifically, when one or more pieces of data are specified among pieces of data shown by a set of pieces of data location information acquired by the model generation unit 601, the optimum arrangement calculation unit 602 generates the data-flow information based on the specified piece of data and the above-mentioned network model.

The data-flow information is information showing a route between the above-mentioned processing server and the above-mentioned specified data and a flow rate on the route, with which sum of the amount of data per unit time received by one or more processing servers becomes the maximum. The one or more above-mentioned processing servers are at least some processing servers shown by a set of identifiers of processing servers acquired by the model generation unit 601.

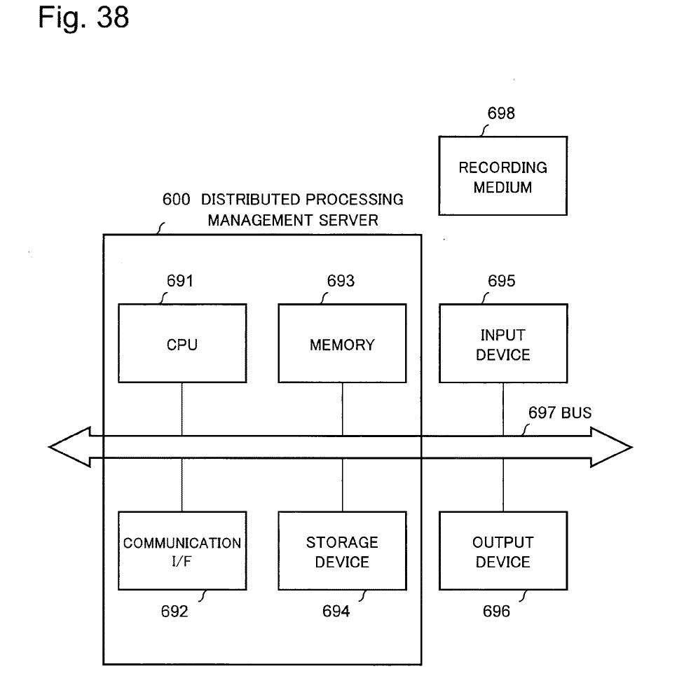

FIG. 38 is a diagram showing a hardware configuration of the distributed processing management server 600 and peripheral devices in the sixth exemplary embodiment of the present invention. As shown in FIG. 38, the distributed processing management server 600 includes a CPU 691, a communication I/F 692 (communication interface 692) for network connections, a memory 693 and a storage device 694 such as a hard disk to store a program. The distributed processing management server 600 is connected to an input device 695 and an output device 696 via a bus 697.

The CPU 691 operates an operating system and controls the whole distributed processing management server 600 according to the sixth exemplary embodiment of the present invention. The CPU 691 reads out a program and data from a recording medium loaded on a drive device, for example, to the memory 693, and the distributed processing management server 600 in the sixth exemplary embodiment executes various processing as a model generation unit 601 and an optimum arrangement calculation unit 602 according to the program and data.

The storage device 694 is an optical disc, a flexible disc, a magnetic optical disc, an external hard disk or a semiconductor memory or the like, for example, and records a computer program in a computer-readable form. The computer program may be downloaded from an external computer not shown connected to a communication network.

The input device 695 is realized by a mouse, a keyboard or a built-in key button, for example, and used for an input operation. The input device 695 is not limited to a mouse, a keyboard or a built-in key button, and it may be a touch panel, an accelerometer, a gyro sensor or a camera, for example.

The output device 696 is realized by a display, for example, and is used in order to confirm the output.

Note that, in the block diagram (FIG. 34) used in a description of the sixth exemplary embodiment, blocks of the function units are shown without showing hardware unit. These function blocks are realized by a hardware configuration shown in FIG. 38. Here, a realization means in each function unit provided in the distributed processing management server 600 is not limited. That is, the distributed processing management server 600 may be realized by one device which coupled physically or may be realized by two or more devices separated physically and connected by a wire or a wireless.

The CPU 691 may read a computer program recorded in the storage device 694 and operate as the model generation unit 601 and the optimum arrangement calculation unit 602 according to the program.

The recording medium (or storage medium) in which a code of the above-mentioned program is recorded may be supplied to the distributed processing management server 600, and the distributed processing management server 600 may read and execute the code of the program stored in the recording medium. That is, the present invention also includes a recording medium 698 which stores temporarily or non-temporarily software (information processing program) executed by the distributed processing management server 600 in the sixth exemplary embodiment.

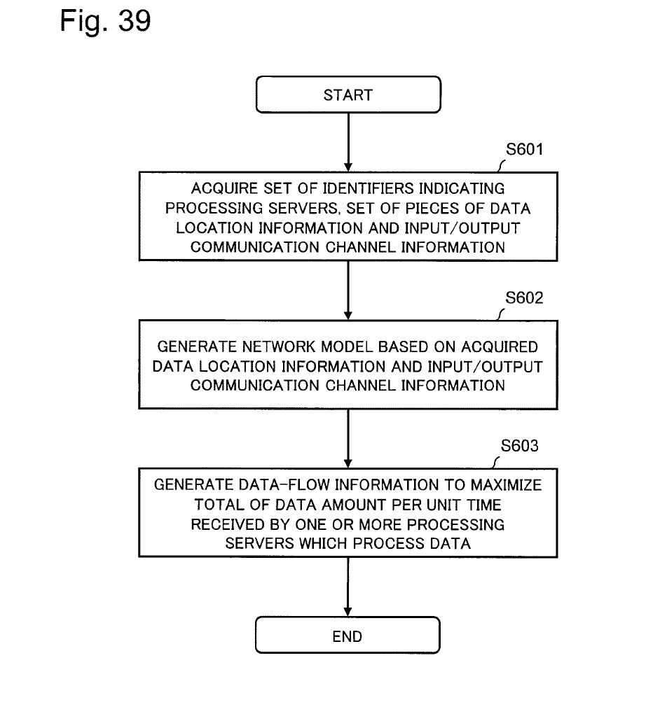

FIG. 39 is a flow chart showing an outline of operation of the distributed processing management server 600 in the sixth exemplary embodiment.

The model generation unit 601 acquires a set of processing server identifiers, a set of pieces of data location information and input/output communication channel information (Step S601).

The model generation unit 601 generates a network model based on the acquired data location information and input/output communication channel information (Step S602).

When one or more pieces of data are specified, the optimum arrangement calculation unit 602 generates data-flow information to maximize the total of the amount of data per the unit time received by one or more processing servers which process the above-mentioned data, based on the network model generated by the model generation unit 601 (Step S603).

The distributed processing management server 600 in the sixth exemplary embodiment generates a network model based on data location information and input/output communication channel information. The data location information is information associating an identifier of data and an identifier of a data server storing the data with each other. The input/output communication channel information is information associating identifiers of devices constituting a network which connects a data server and a processing server, and bandwidth information which shows an available bandwidth on the communication channel between the devices, with each other.

The network model has the following feature. Firstly, in the network model, a device and a piece of data are respectively represented by a node. Secondly, in the network model, a node representing data and a node representing a data server indicated by certain data location information are connected by an edge. Thirdly, in the network model, nodes representing devices indicated by identifiers included in certain input/output communication channel information are connected by an edge, and bandwidth information included in the above-mentioned certain input/output communication channel information is set to the edge as a restriction.

When one or more pieces of data are specified, the distributed processing management server 600 generates data-flow information based on the specified data and the above-mentioned network model. The data-flow information is information which shows a route between the above-mentioned processing server and the above-mentioned specified data, and the amount of data flow rate of the route, which maximize the total amount of data per unit time received by one or more processing servers.

Therefore, the distributed processing management server 600 in the sixth exemplary embodiment can generate information for determining a data transfer route which maximizes a total amount of data to be processed per unit time in one or more processing servers in a system in which a plurality of data servers and a plurality of processing servers are arranged in a distributed manner.

### First Modification of Sixth Exemplary Embodiment

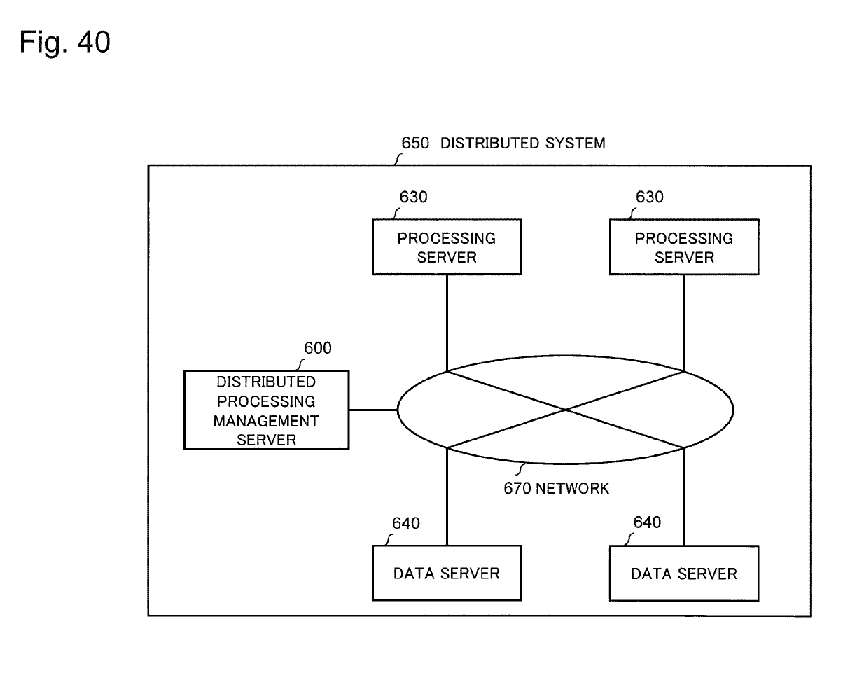

FIG. 40 is a block diagram showing a configuration of a distributed system 650 in a first modification of the sixth exemplary embodiment.

Referring to FIG. 40, the distributed system 650 includes the distributed processing management server 600 in the sixth exemplary embodiment, a plurality of processing servers 630 and a plurality of data servers 640, and they are connected to each other via a network 670. The network 670 may include network switches.

The distributed system 650 in the first modification of the sixth exemplary embodiment has at least similar functions as that of the distributed processing management server 600 in the sixth exemplary embodiment. Therefore, the distributed system 650 in the first modification of the sixth exemplary embodiment provides the similar effect as the distributed processing management server 600 in the sixth exemplary embodiment.

[[Description of Specific Example with respect to Each Exemplary Embodiment]]

### Specific Example of the First Exemplary Embodiment

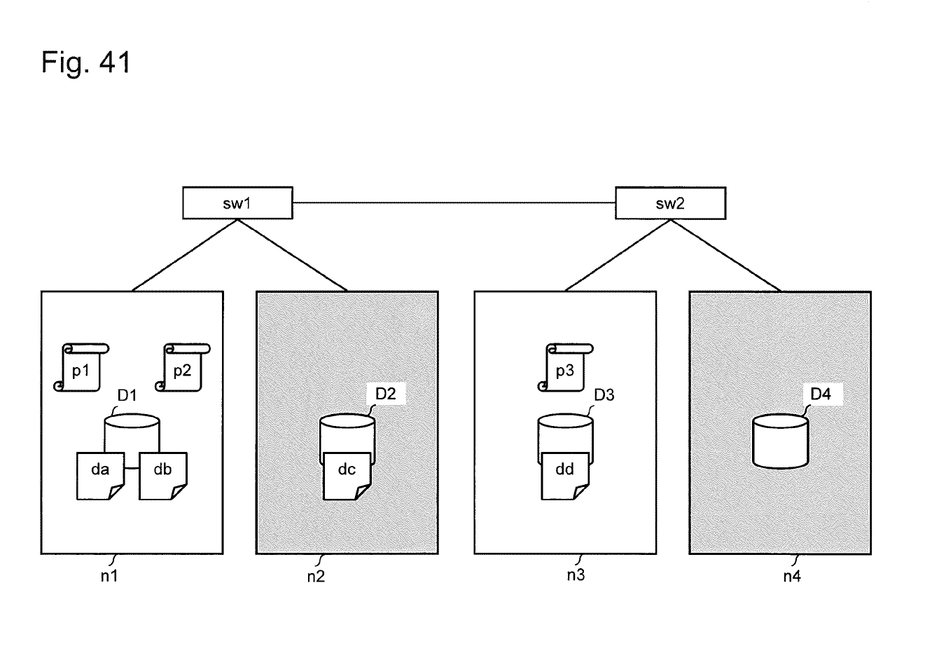

FIG. 41 shows a configuration of the distributed system 350 used in the specific example. The distributed system 350 includes servers n1 to n4 connected by switches sw1 and sw2.

The servers n1 to n4 function as a processing server 330 and a data server 340 according to the situation. The servers n1 to n4 includes disks D1 to D4 respectively as a processing data storing unit 342. Any one of servers n1 to n4 functions as a distributed processing management server 300. The server n1 includes p1 and p2 as an available processing execution unit 332 and the server n3 includes p3 as an available processing execution unit 332.

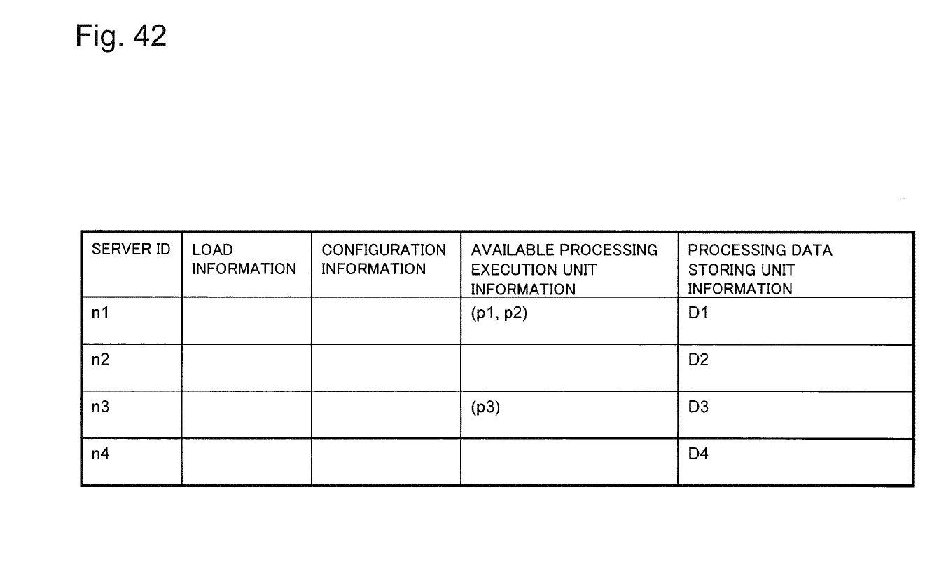

FIG. 42 shows an example of information stored in the server status storing unit 3060 in the distributed processing management server 300. In this specific example, the processing execution units p1 and p2 in the server n1, and the processing execution unit p3 in the server n3 are available.

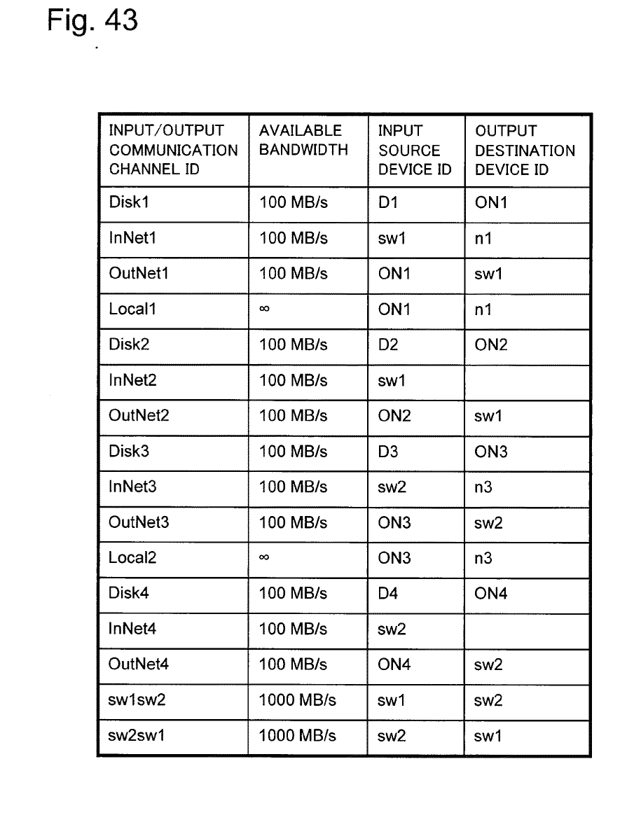

FIG. 43 shows an example of information stored in the input/output communication channel information storing unit 3080 in the distributed processing management server 300. An input/output bandwidth of the disk and a network bandwidth of each server are 100 MB/s, and a network bandwidth between switches sw1 and sw2 is 1000 MB/s. It is assumed that communication in this specific example is performed with full duplex. Therefore, in this specific example, it is assumed that network bandwidths of input side and an output side are independent from each other.

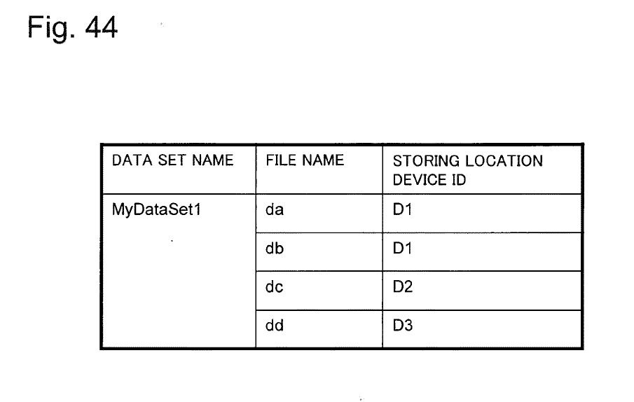

FIG. 44 shows an example of information stored in the data location storing unit 3070 in the distributed processing management server 300. The information is divided into files da, db, dc and dd. The files da and db are stored in the disk D1 of the server n1, the file dc is stored in the disk D2 of the server n2, and the file dd is stored in the disk D3 of the server n3, respectively. The logical data set MyDataSet1 is a data set which is simply arranged in a distributed manner without performing multiplex processing thereon.

It is also assumed that the statuses of the server status storing unit 3060, the input/output communication channel information storing unit 3080 and the data location storing unit 3070 of the distributed processing management server 300 are as shown in FIG. 42, FIG. 43 and FIG. 44, respectively, when execution of a program using MyDataSet1 is directed by a client.

The model generation unit 301 in the distributed processing management server 300 acquires {D1, D2, D3} as a set of identifiers of devices storing data (processing data storing unit 342, for example) from the data location storing unit 3070 of FIG. 44. Next, the model generation unit 301 acquires {n1, n2, n3} as a set of identifiers of data servers 340 and acquires {n1, n3} as a set of identifiers of processing servers 330 from the server status storing unit 3060 of FIG. 42. The model generation unit 301 acquires {p1, p2, p3} as a set of identifiers of available processing execution units 332.

Next, the model generation unit 301 of the distributed processing management server 300 generates a network model (G, u, s, t) based on the set of identifiers of processing servers 330, the set of identifiers of processing execution units 332, the set of identifiers of data servers 340, and the information stored in the input/output communication channel information storing unit 3080 of FIG. 43.

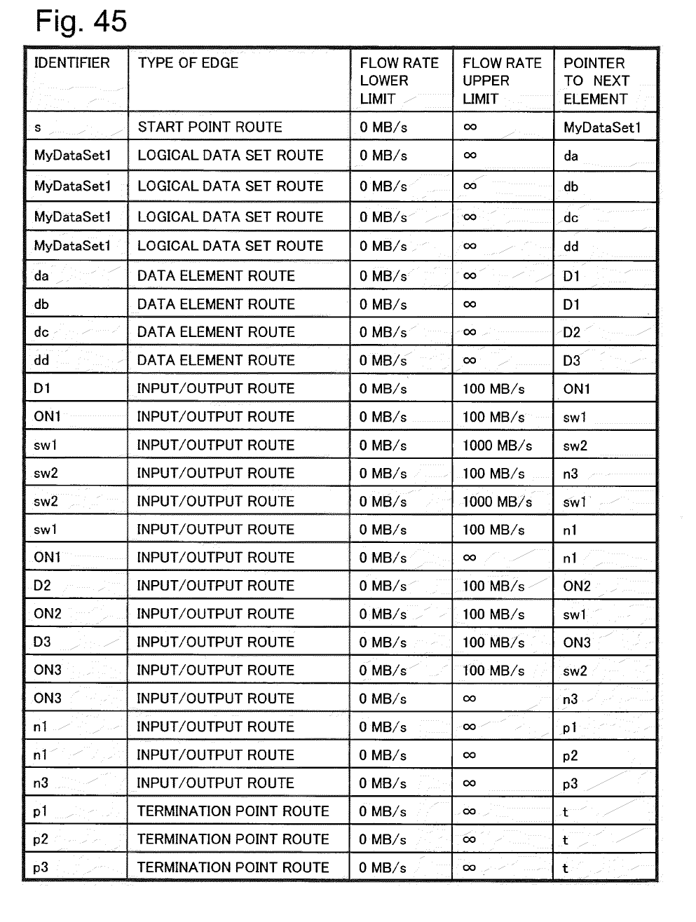

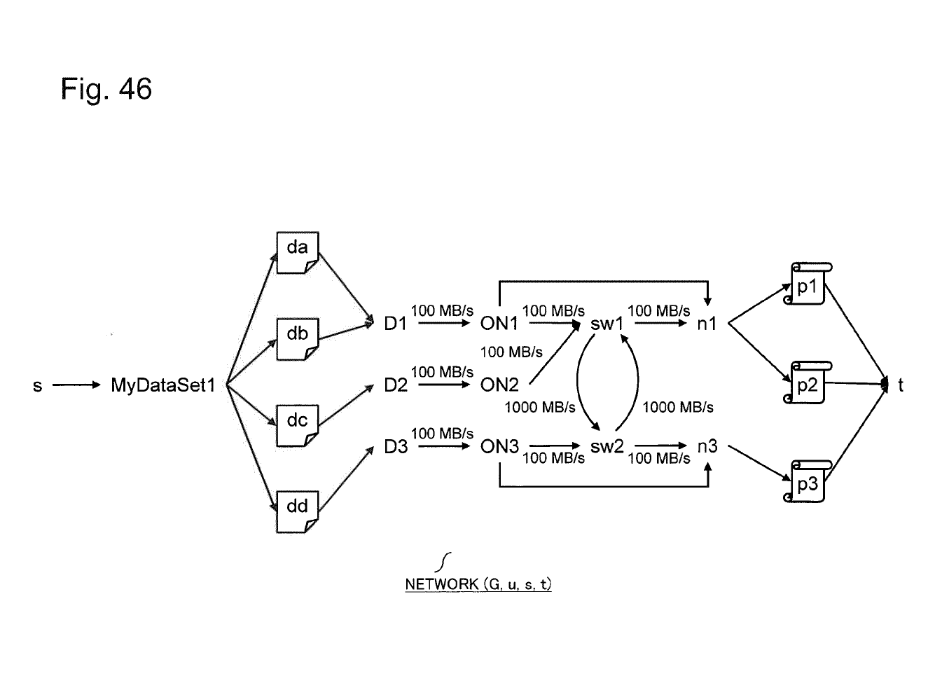

FIG. 45 shows a table of model information generated by the model generation unit 301 in this specific example. FIG. 46 shows a conceptual diagram of the network (G, u, s, t) shown by the table of model information in FIG. 45. The value of each edge on the network (G, u, s, t) shown in FIG. 46 indicates the maximum amount of data per unit time which can be sent on the route at present.

The optimum arrangement calculation unit 302 in the distributed processing management server 300 maximizes the objective function represented by Equation (1) of [Mathematical Equation 1] under the restriction of Equations (2) and (3) of [Mathematical Equation 1] based on the table of model information shown in FIG. 45. FIGS. 47A to 47G are diagrams exemplifying a case when this processing is performed by using the flow increase method in the maximum flow problem.

First, in the network (G, u, s, t) shown in FIG. 47A, the optimum arrangement calculation unit 302 specifies a route of which the number of nodes (end points) included on the route is the minimum among routes from the start point s to the termination point t. That is, the optimum arrangement calculation unit 302 specifies a route of which the number of hops is the minimum among the routes from the start point s to the termination point t. Then the optimum arrangement calculation unit 302 specifies the maximum data flow rate (flow) that can be passed on the specified route and assumes passing the flow on the route.

Specifically, the optimum arrangement calculation unit 302 assumes passing a flow of 100 MB/s on a route (s, MyDataSet1, da, D1, ON1, n1, p1, t) as shown in FIG. 47B. Then, the optimum arrangement calculation unit 302 specifies a residual graph of the network (G, u, s, t) shown in FIG. 47C.

The residual graph of the network (G, u, s, t) is a graph in which each edge e0 with a non-zero flow in the graph G is separated into an edge e1 of the forward direction which indicates an available remaining bandwidth and an edge e2 of the opposite direction which indicates reducible used bandwidth, on the actual or virtual route shown by the edge. The forward direction is a direction identical with a direction which e0 shows. The opposite direction is a direction opposite to the direction which e0 shows. That is, the edge e′ of the opposite direction of the edge e is the edge e′ from a vertex w to a vertex v when the edge e connects from the vertex v to the vertex w, in the graph G.

A flow increased route from the start point s to the termination point t on the residual graph is a route from s to t composed by an edge e with a remaining capacity function uf (e)>0 and an edge e′ with uf (e′)>0, which is the opposite direction of an edge e. The remaining capacity function uf is the function that indicates a remaining capacity of the forward direction edge e and the opposite direction edge e′. The remaining capacity function uf is defined by the following [Mathematical Equation 3].

u_{f}(e):=u(e)−f(e)

u_{f}(e′):=f(e) [Mathematical Equation 3]

Next, the optimum arrangement calculation unit 302 specifies a flow increased route in the residual graph shown in FIG. 47C, and assumes passing a flow on the route. The optimum arrangement calculation unit 302 assumes passing a flow of 100 MB/s on a route (s, MyDataSet1, dd, D3, ON3, n3, p3, t) shown in FIG. 47D based on the residual graph shown in FIG. 47C. Then, the optimum arrangement calculation unit 302 specifies the residual graph of the network (G, u, s, t) shown in FIG. 47E. Next, the optimum arrangement calculation unit 302 specifies another flow increased route in the residual graph shown in FIG. 47E, and assumes passing a flow on the route. The optimum arrangement calculation unit 302 assumes passing a flow of 100 MB/s on a route (s, MyDataSet1, dc, D2, ON2, sw1, n1, p2, t) shown in FIG. 47F based on the residual graph shown in FIG. 47E. Then, the optimum arrangement calculation unit 302 specifies the residual graph of the network (G, u, s, t) shown in FIG. 47G.

Referring to FIG. 47G, any more flow increased route does not exist. Therefore, the optimum arrangement calculation unit 302 ends the processing. The information about the flow and the data flow rate obtained by this processing corresponds to the data-flow information.

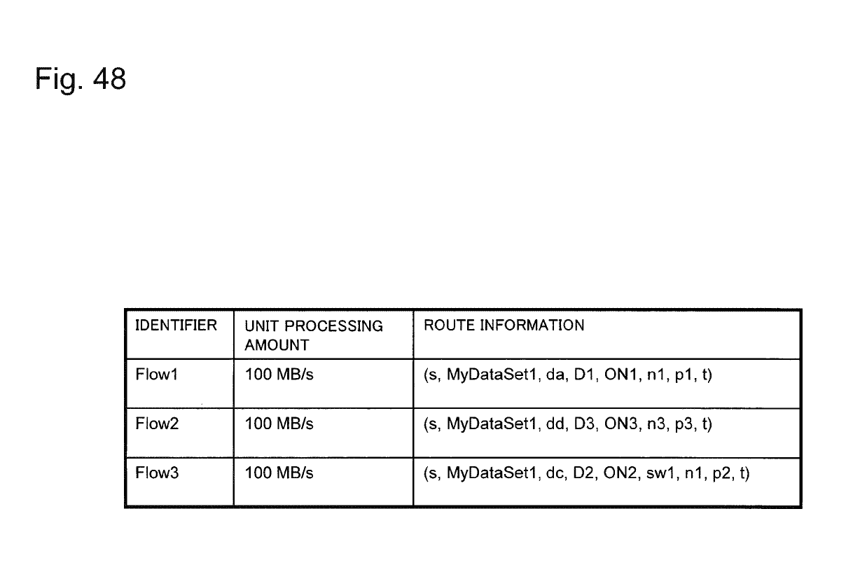

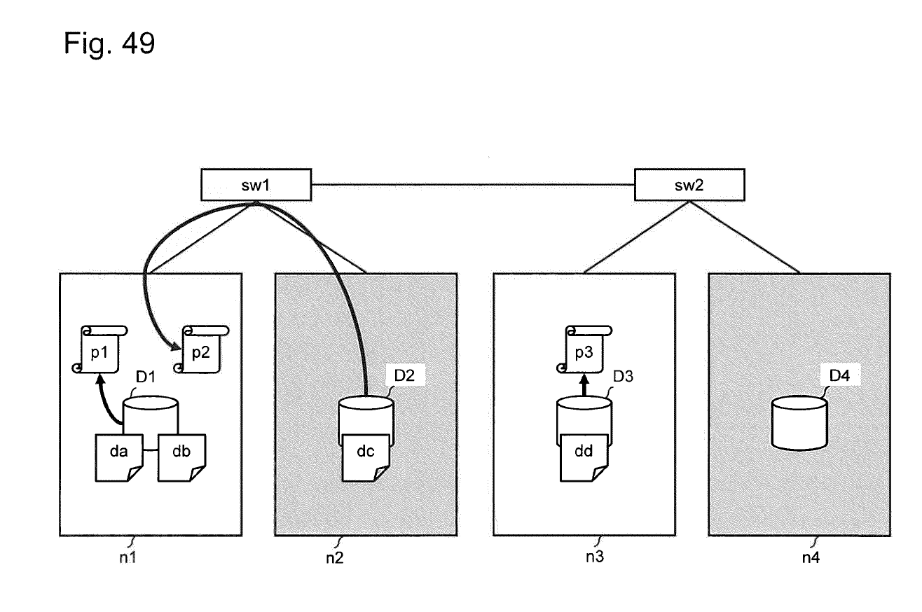

FIG. 48 shows the data-flow information obtained as the result of the maximization of the objective function. The processing allocation unit 303 of the distributed processing management server 300 transmits a processing program to n1 and n3 based on this information. And the processing allocation unit 303 directs data reception and execution of processing by transmitting the decision information for the processing program to the processing servers n1 and n3. The processing server n1, when receiving the decision information, acquires the file da from the processing data storing unit 342 of the data server n1. The processing execution unit p1 executes the processing for the acquired file da. The processing server n1 also acquires the file dc from the processing data storing unit 342 of the data server n2. The processing execution unit p2 executes the processing for the acquired file dc. The processing server n3 acquires the file dd from the processing data storing unit 342 of the data server n3. The processing execution unit p3 executes the processing for the acquired file dd. FIG. 49 shows an example of data transmission/reception determined based on the data-flow information of FIG. 48.

### Specific example of the Second Exemplary Embodiment

A specific example of the second exemplary embodiment will be described. The specific example of this exemplary embodiment will be described by showing a difference from the specific example of the first exemplary embodiment.

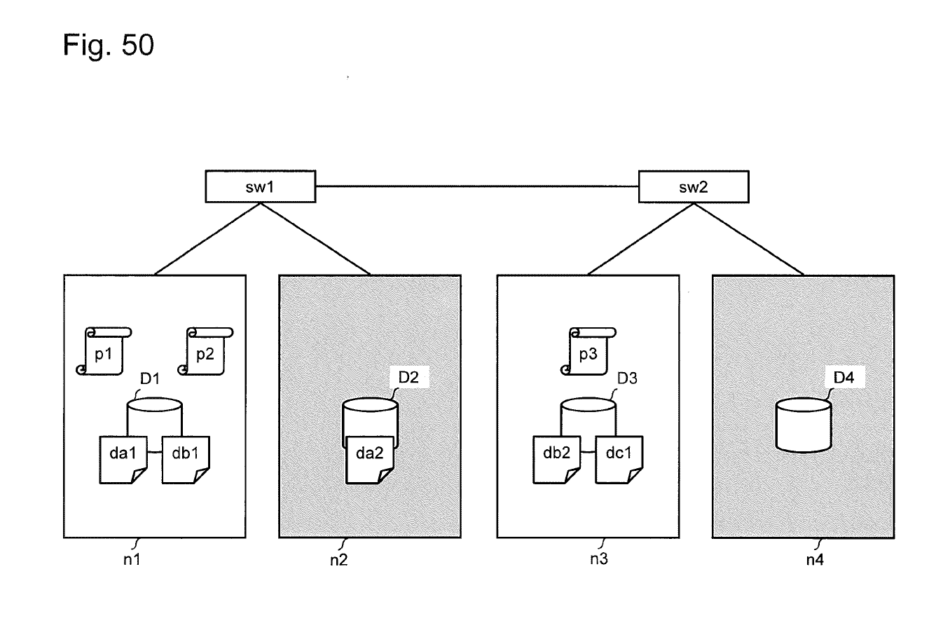

FIG. 50 shows a configuration of the distributed system 350 used in the specific example. The distributed system 350 includes servers n1 to n4 connected by switches sw1 and sw2 as well as the first exemplary embodiment.

It is assumed that the statuses of the server status storing unit 3060 and the input/output communication channel information storing unit 3080 in the distributed processing management server 300 are identical with those in the specific example of the first exemplary embodiment. That is, FIG. 42 shows information stored in the server status storing unit 3060 in the distributed processing management server 300 and FIG. 43 shows information stored in the input/output communication channel information storing unit 3080 in the distributed processing management server 300, respectively.

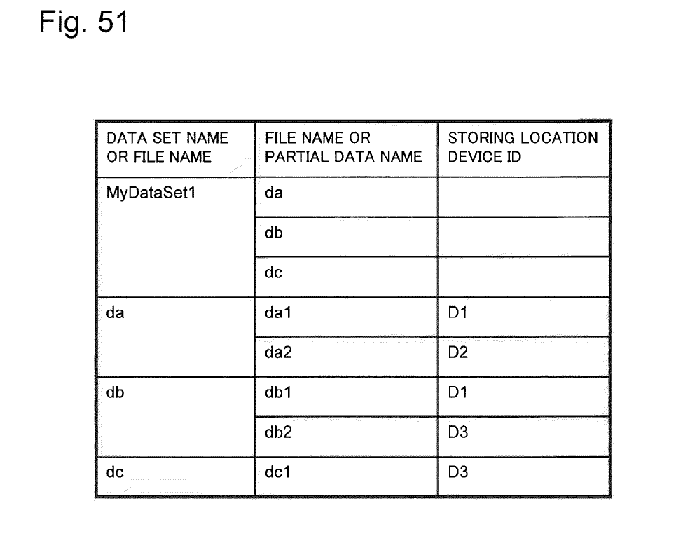

FIG. 51 shows an example of information stored in the data location storing unit 3070 in the distributed processing management server 300. A logical data set MyDataSet1 is given to a program executed in this specific example, as an input. The logical data set is divided into files da, db and dc. The files da and db are duplicated, respectively. A substance of the data of the file da is stored in the disk D1 of the server n1 and the disk D2 of the server n2 respectively. The substance of the data is each of multiplexed pieces of partial data and is a data element. A substance of the data of the file db is stored in the disk D1 of the server n1 and the disk D3 of the server n3 respectively. The file dc is not multiplexed and the file dc is stored in the disk D3 of the server n3.

It is assumed that the statuses of the server status storing unit 3060, the input/output communication channel information storing unit 3080 and the data location storing unit 3070 of the distributed processing management server 300 are as shown in FIG. 42, FIG. 43 and FIG. 51, respectively, when execution of a program using MyDataSet1 is directed by a client.

The model generation unit 301 in the distributed processing management server 300 acquires {D1, D2, D3} as a set of identifiers of devices storing data (processing data storing units 342, for example) from the data location storing unit 3070 of FIG. 51. Next, the model generation unit 301 acquires {n1, n2, n3} as a set of identifiers of data servers 340, and acquires {n1, n3} as a set of identifiers of processing servers 330 from the server status storing unit 3060 of FIG. 42. The model generation unit 301 acquires {p1, p2, p3} as a set of identifiers of available processing execution units 332.

Next, the model generation unit 301 in the distributed processing management server 300 generates a network model (G, u, s, t) based on the set of identifiers of processing servers 330, the set of identifiers of processing execution units 332, the set of identifiers of data servers 340, and the information stored in the input/output communication channel information storing unit 3080 of FIG. 43.

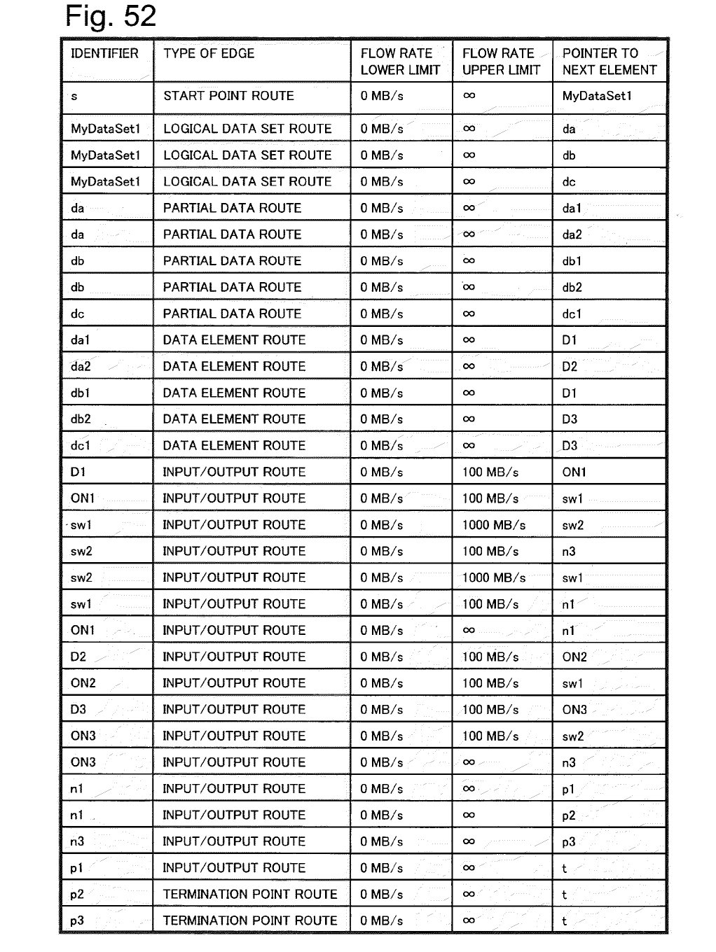

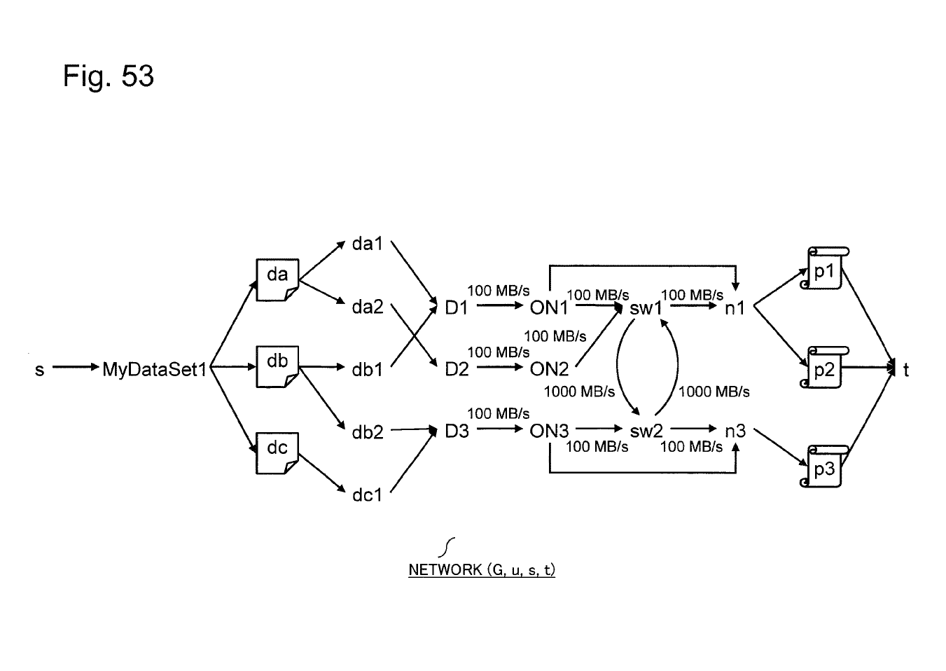

FIG. 52 shows a table of model information generated by the model generation unit 301 in this specific example. FIG. 53 shows a conceptual diagram of the network (G, u, s, t) shown by the table of model information in FIG. 52. The value of each edge on the network (G, u, s, t) shown in FIG. 53 indicates the maximum value of the amount of data per unit time that can be sent at present on the route.

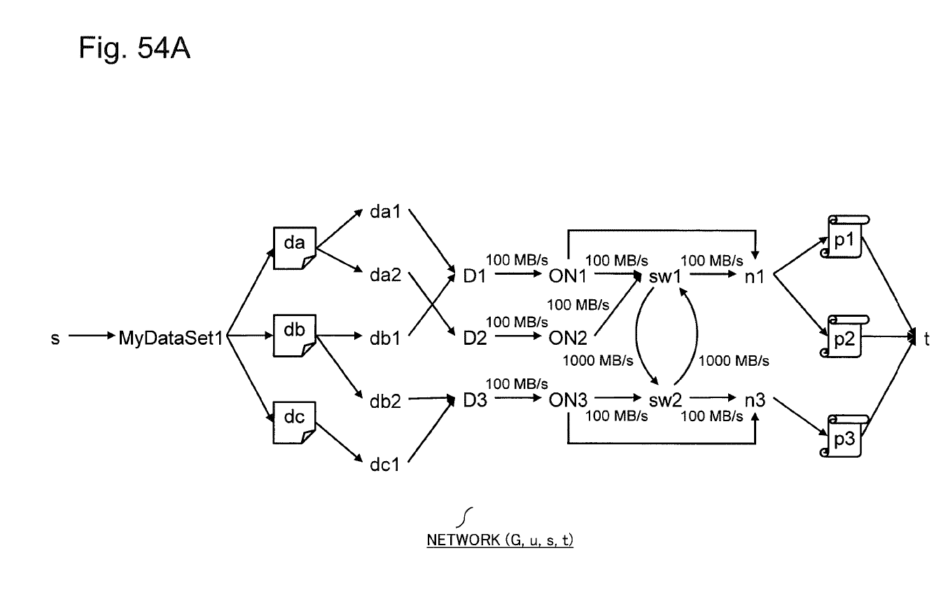

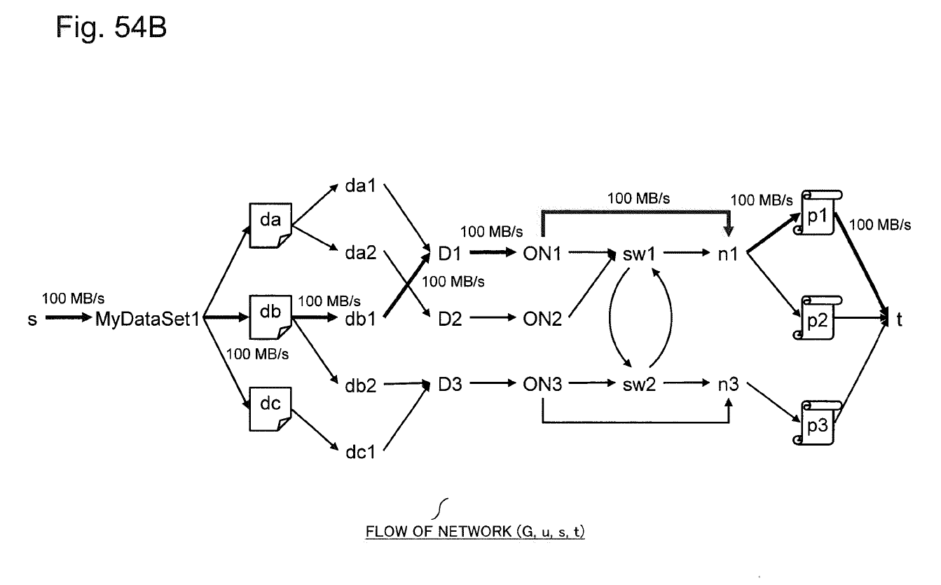

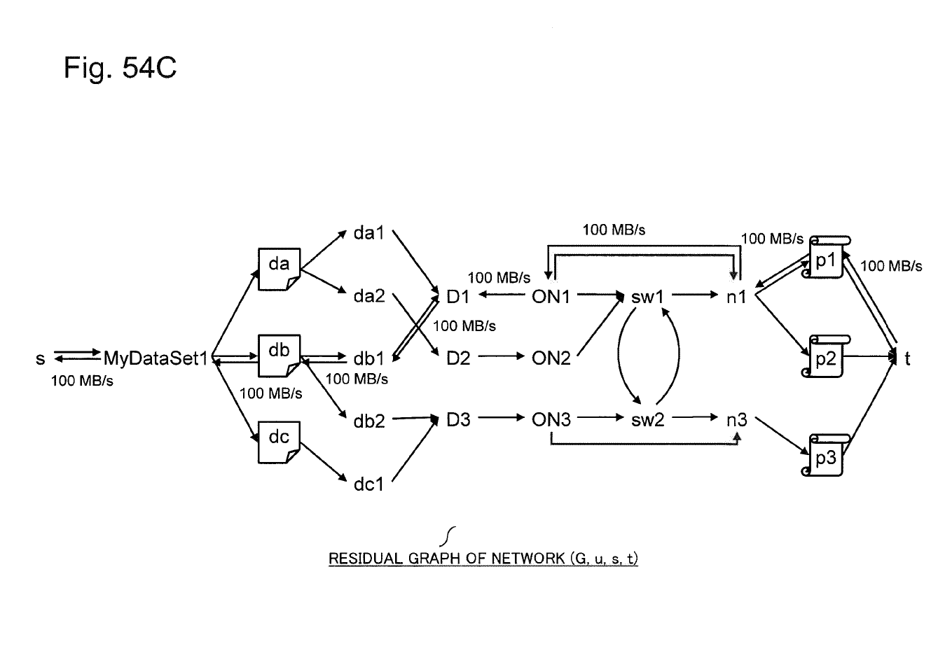

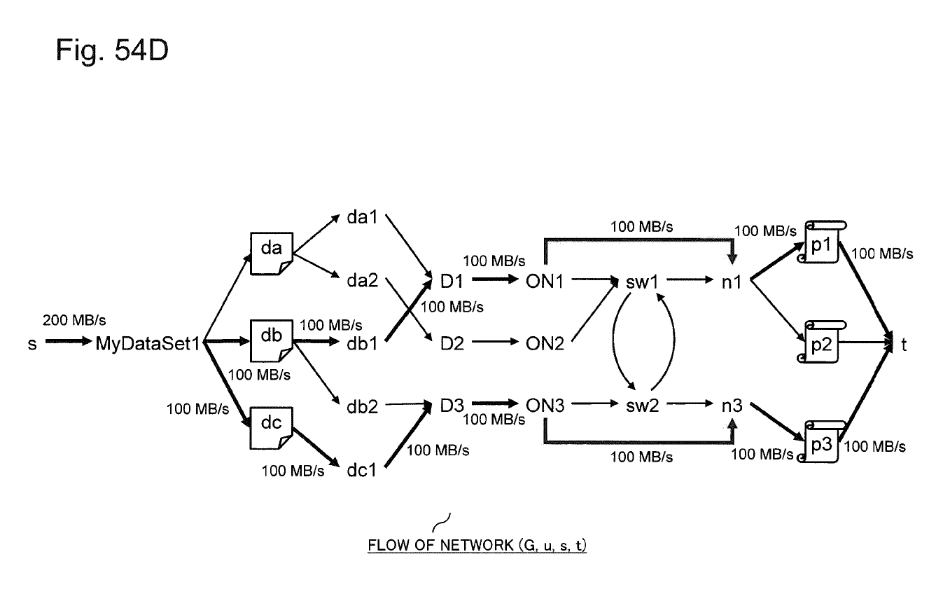

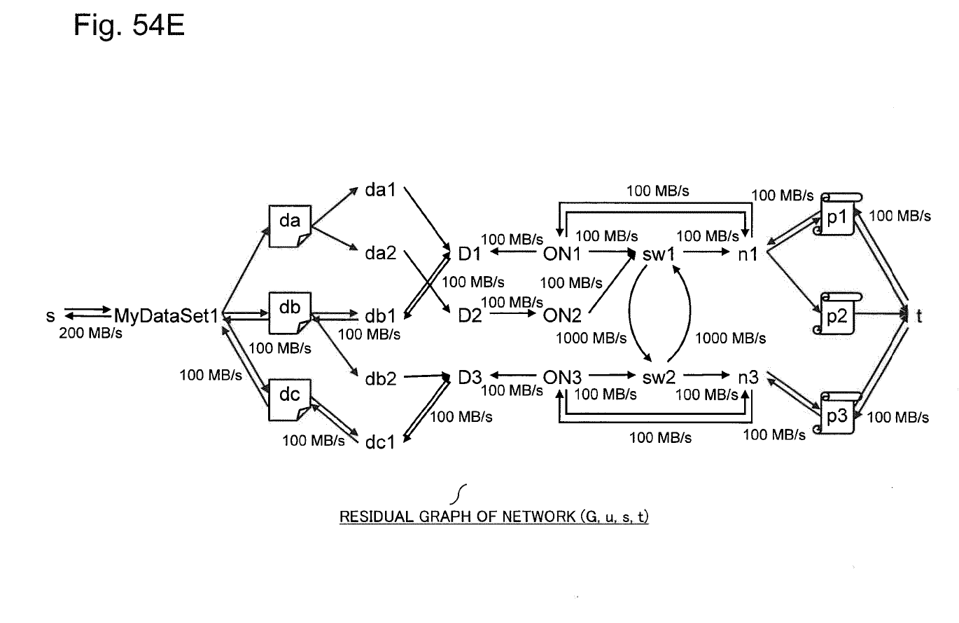

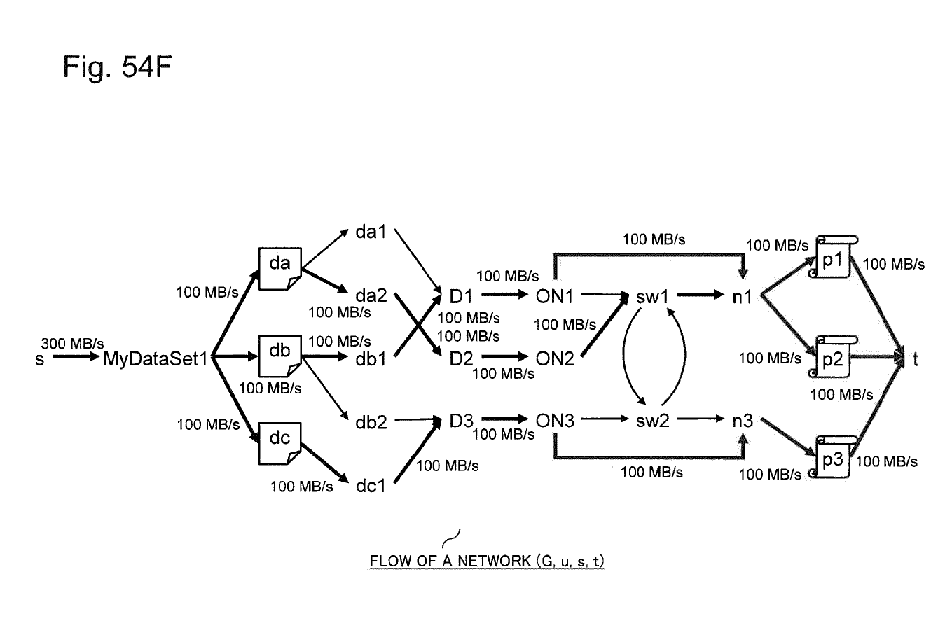

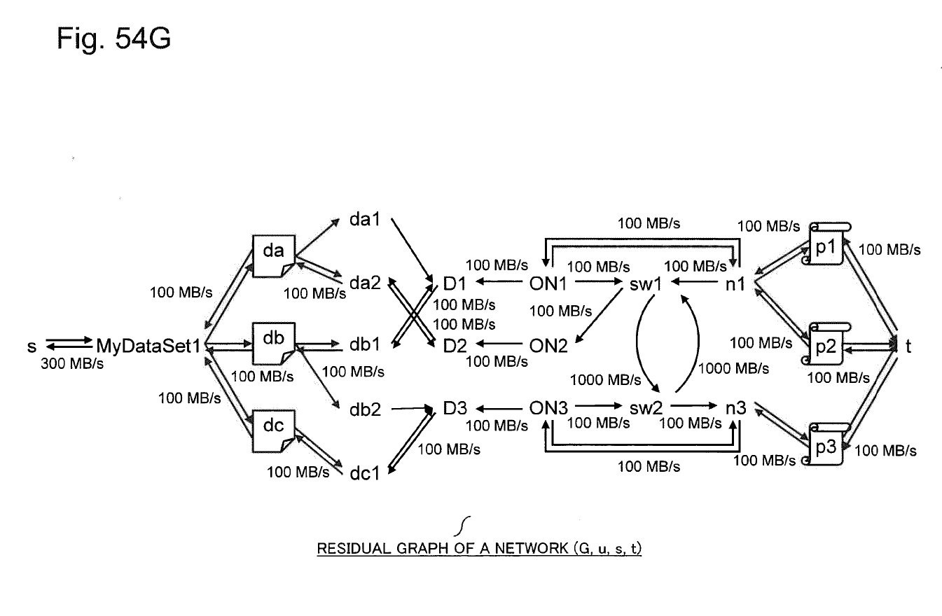

The optimum arrangement calculation unit 302 in the distributed processing management server 300 maximizes the objective function represented by Equation (1) of [Mathematical Equation 1] under the restrictions of Equation (2) and Equation (3) of [Mathematical Equation 1] based on the table of model information of FIG. 52. FIGS. 54A to 54G are diagrams exemplifying a case when this processing is performed by using the flow increase method in the maximum flow problem.

First, the optimum arrangement calculation unit 302 assumes passing a flow of 100 MB/s on a route (s, MyDataSet1, db, db1, D1, ON1, n1, p1, t) as shown in FIG. 54B in the network (G, u, s, t) shown in FIG. 54A. Then, the optimum arrangement calculation unit 302 specifies a residual graph of the network (G, u, s, t) shown in FIG. 54C.

Next, the optimum arrangement calculation unit 302 specifies a flow increased route in the residual graph shown in FIG. 54C, and assumes passing a flow on the route. The optimum arrangement calculation unit 302 assumes passing a flow of 100 MB/s on a route (s, MyDataSet1, dc, dc1, D3, ON3, n3, p3, t) shown in FIG. 54D based on the residual graph shown in FIG. 54C. Then, the optimum arrangement calculation unit 302 specifies the residual graph of the network (G, u, s, t) shown in FIG. 54E.

Next, the optimum arrangement calculation unit 302 specifies another flow increased route in the residual graph shown in FIG. 54E, and assumes passing a flow on the route. The optimum arrangement calculation unit 302 assumes passing a flow of 100 MB/s on a route (s, MyDataSet1, da, da2, D2, ON2, sw1, n1, p2, t) as shown in FIG. 54F based on the residual graph shown in FIG. 54E. Then, the optimum arrangement calculation unit 302 specifies the residual graph of the network (G, u, s, t) shown in FIG. 54G.

Referring to FIG. 54G, any more flow increased route does not exist. Therefore, the optimum arrangement calculation unit 302 ends the processing. The information about the flow and the data flow rate obtained by this processing corresponds to data-flow information.

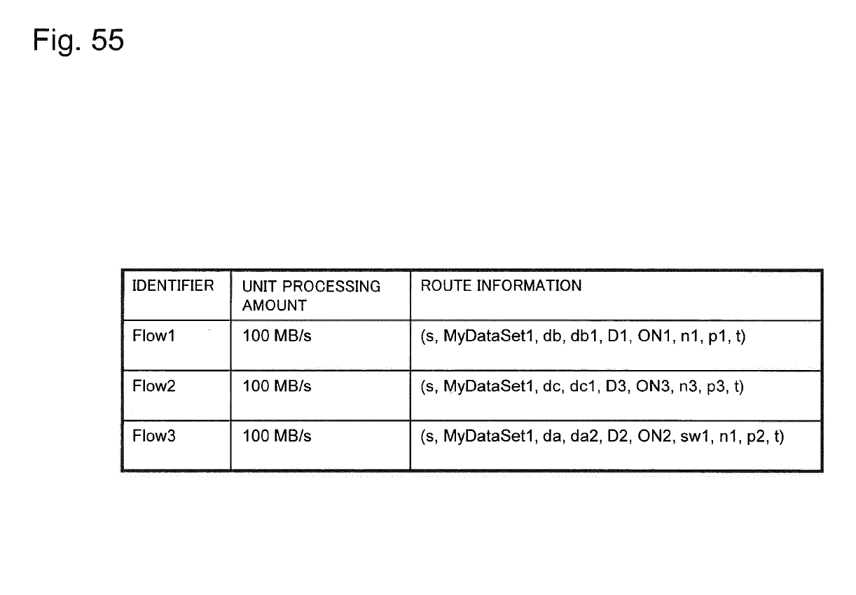

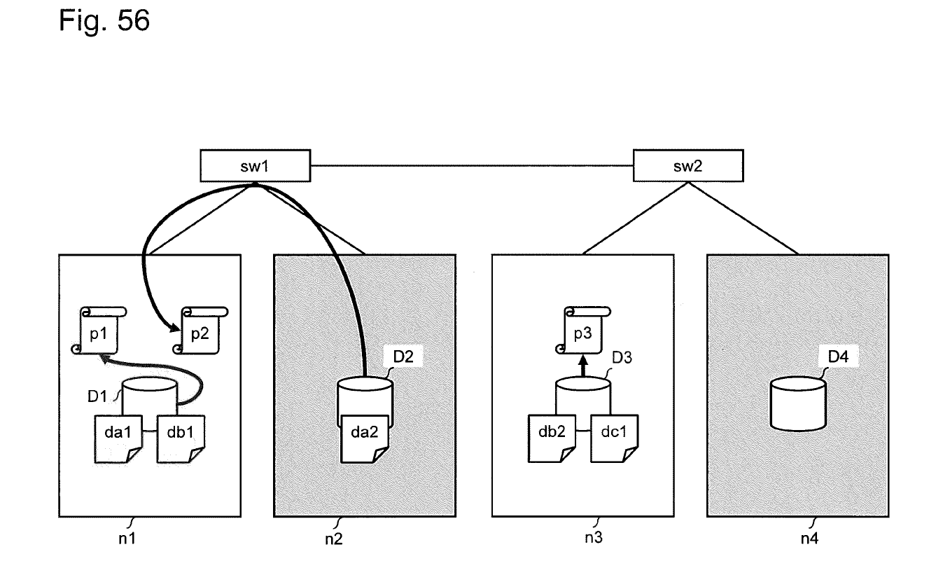

FIG. 55 shows data-flow information obtained as the result of the maximization of the objective function. The processing allocation unit 303 of the distributed processing management server 300 transmits a processing program to n1 and n3 based on this information. The processing allocation unit 303 directs data reception and execution of processing to the processing servers n1 and n3 by transmitting the decision information for the processing program. The processing server n1, when receiving the decision information, acquires the substance db1 of data of the file db from the processing data storing unit 342 of the data server n1. The processing execution unit p1 executes the processing for the substance db1 of the acquired data. The processing server n1 acquires the substance da2 of data of the file da from the processing data storing unit 342 of the data server n2. The processing execution unit p2 executes the processing for the substance da2 of the acquired data. The processing server n3 acquires the file dc from the processing data storing unit 342 of the data server n3. The processing execution unit p3 executes the processing for the acquired file dc. FIG. 56 shows an example of data transmission/reception determined based on the data-flow information of FIG. 55.

### Specific Example of the Third Exemplary Embodiment

A specific example of the third exemplary embodiment will be described. The specific example of this exemplary embodiment will be described by showing a difference from the specific example of the first exemplary embodiment.

It is assumed that the configuration of the distributed system 350 used in this specific example and the status of the input/output communication channel information storing unit 3080 in the distributed processing management server 300 are identical with those in the specific example of the first exemplary embodiment. That is, FIG. 41 shows a configuration of the distributed system 350 and FIG. 43 shows information stored in the input/output communication channel information storing unit 3080 in the distributed processing management server 300, respectively.

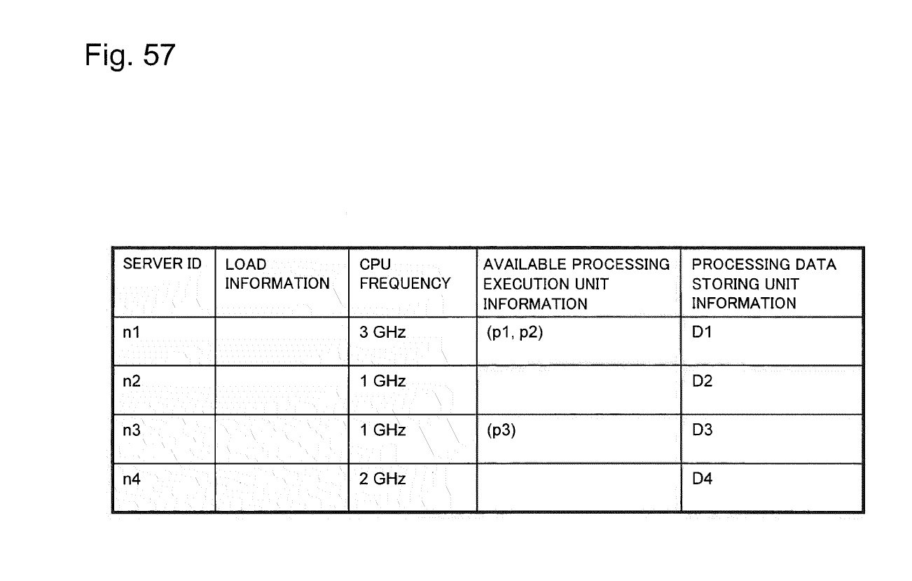

FIG. 57 shows an example of information stored in the server status storing unit 3060 in the distributed processing management server 300. In this specific example, the processing execution units p1 and p2 of the server n1 and the processing execution unit p3 of the server n3 are available. In this specific example, a CPU frequency of each processing server is used as configuration information 3063 of the server status storing unit 3060.

In this specific example, configurations of processing servers are not identical. With respect to processing servers n1 and n2 including available processing execution units p1, p2 and p3, a CPU frequency of the processing server n1 is 3 GHz, and a CPU frequency of the processing server n2 is 1 GHz. In this specific example, the processing amount of the unit time per 1 GHz is set as 50 MB/s. That is, the processing server n1 can execute processing with 150 MB/s in total and the processing server n3 can execute processing with 50 MB/s in total.

It is assumed that the statuses of the server status storing unit 3060, the input/output communication channel information storing unit 3080 and the data location storing unit 3070 of the distributed processing management server 300 are as shown in FIG. 57, FIG. 43 and FIG. 44, respectively, when execution of a program using MyDataSet1 is directed by a client.

The model generation unit 301 in the distributed processing management server 300 acquires {D1, D2, D3} as a set of devices storing data from the data location storing unit 3070 of FIG. 44. Next, the model generation unit 301 acquires {n1, n2, n3} as a set of data servers 340 and acquires {n1, n3} as a set of processing servers 330 from the server status storing unit 3060 of FIG. 57. The model generation unit 301 acquires {p1, p2, p3} as a set of available processing execution units 332.

Next, the model generation unit 301 in the distributed processing management server 300 generates a network model (G, u, s, t) based on the set of identifiers of processing servers 330, the set of identifiers of processing execution units 332, the set of identifiers of data servers 340, and the information stored in the input/output communication channel information storing unit 3080 of FIG. 43.

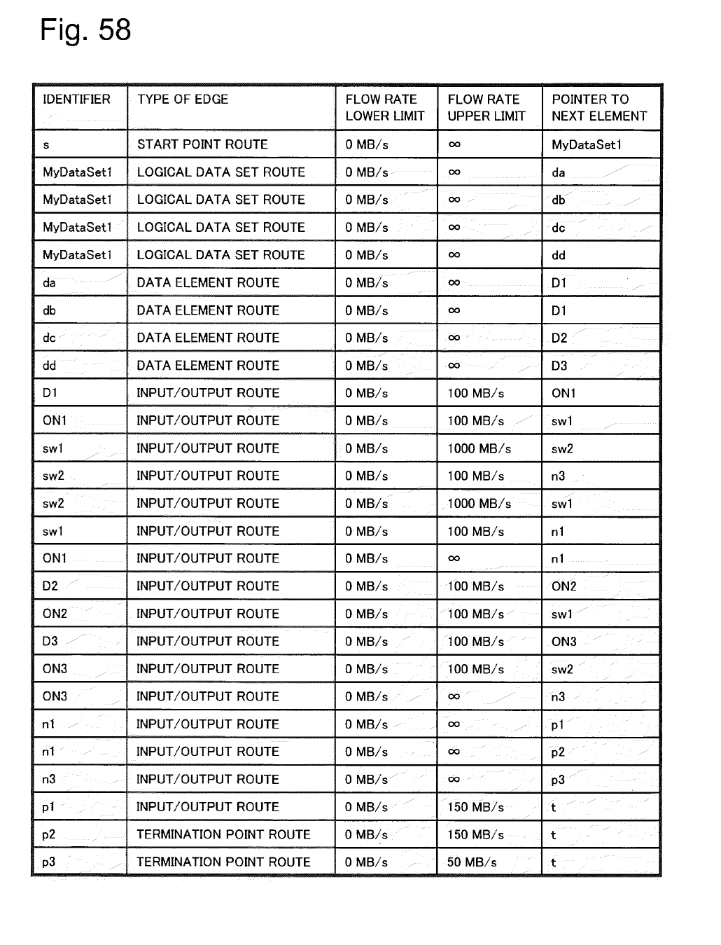

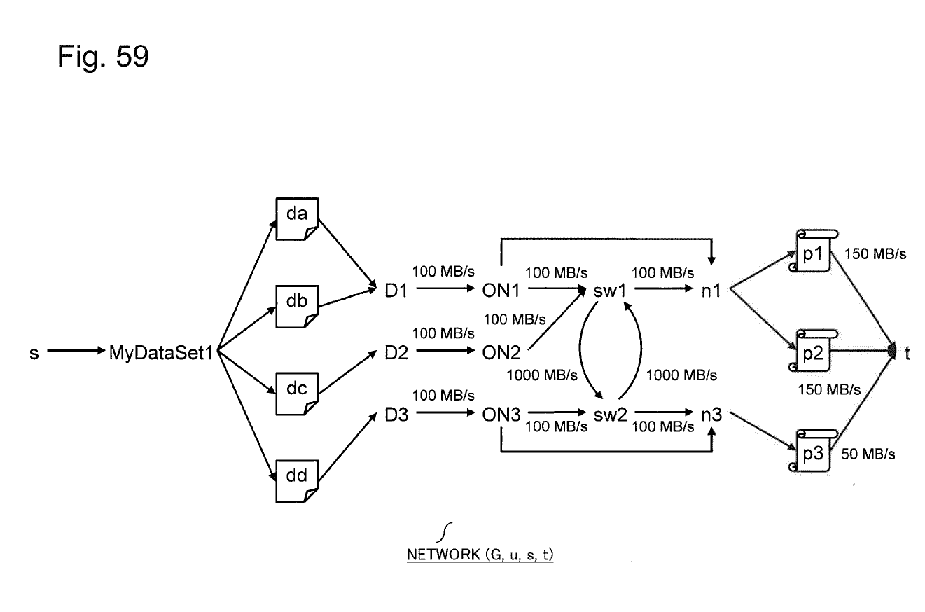

FIG. 58 shows a table of model information generated by the model generation unit 301 in this specific example. FIG. 59 shows a conceptual diagram of the network (G, u, s, t) shown by the table of model information in FIG. 58. The value of each edge on the network (G, u, s, t) shown in FIG. 59 indicates the maximum value of the amount of data per unit time that can be sent at present on the route.

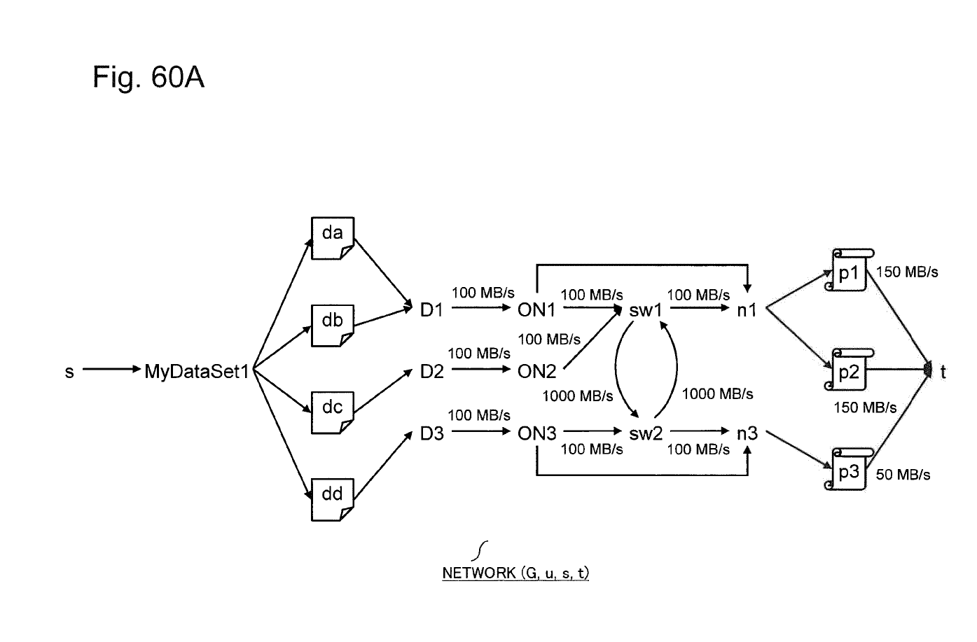

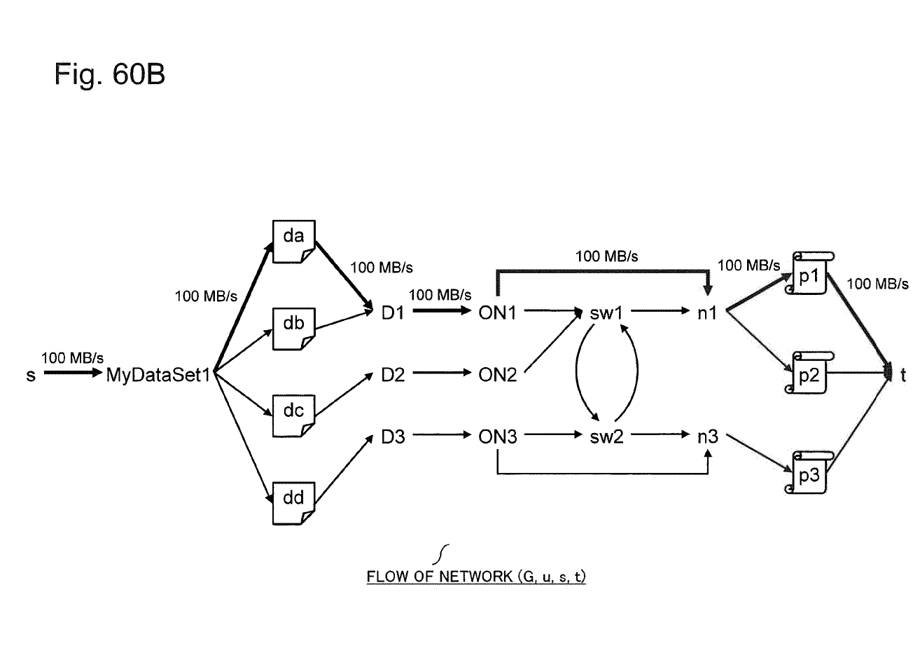

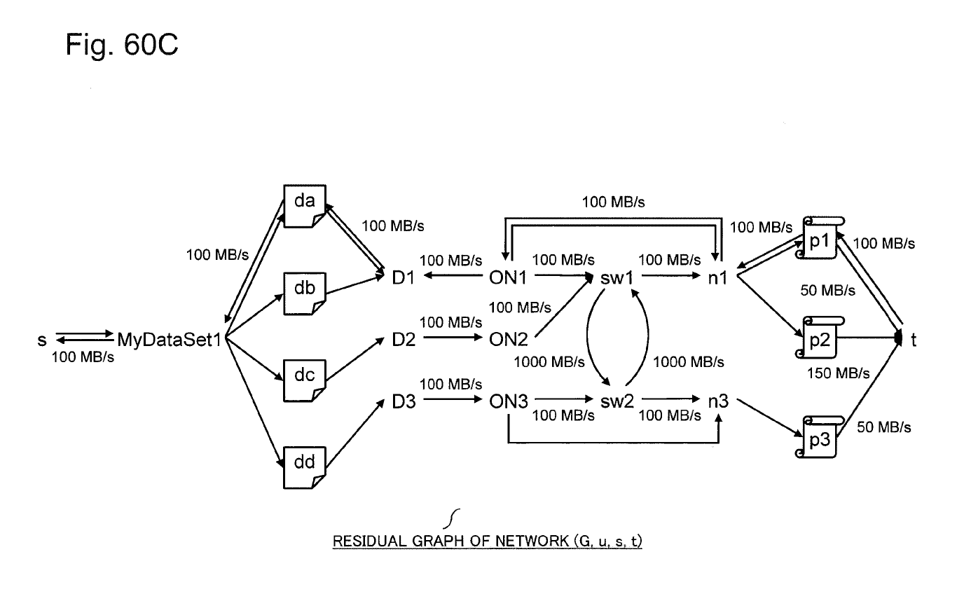

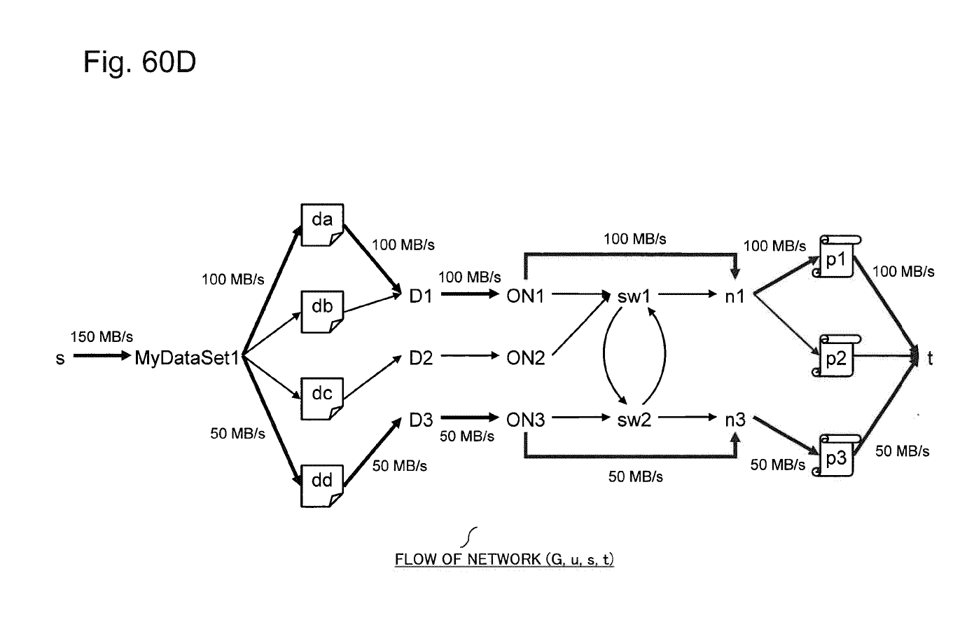

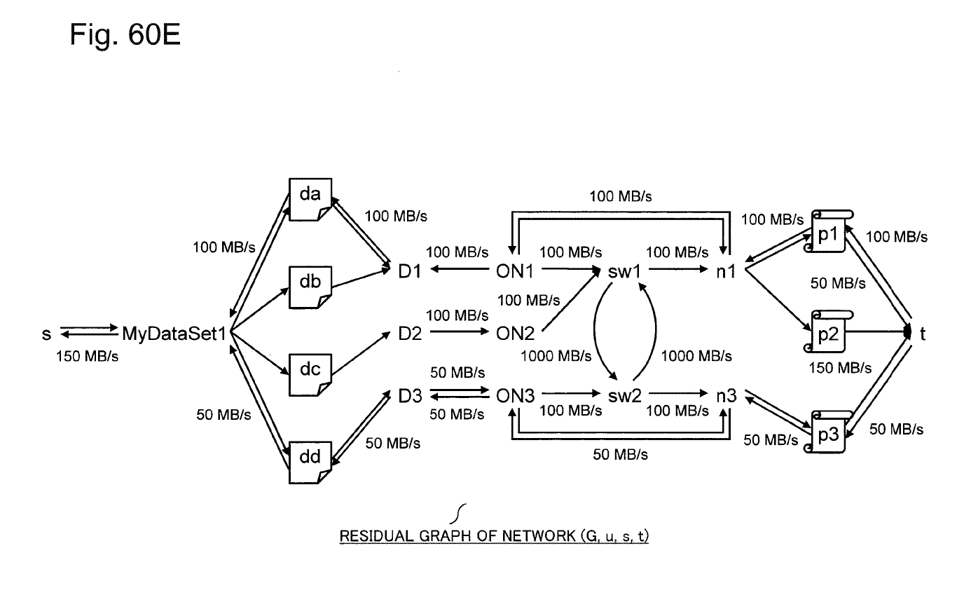

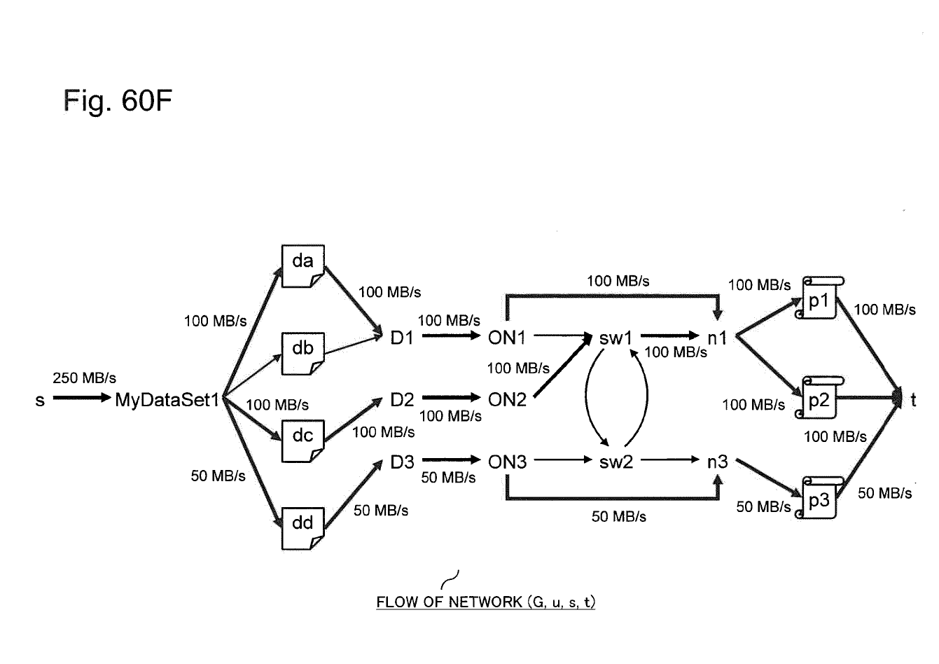

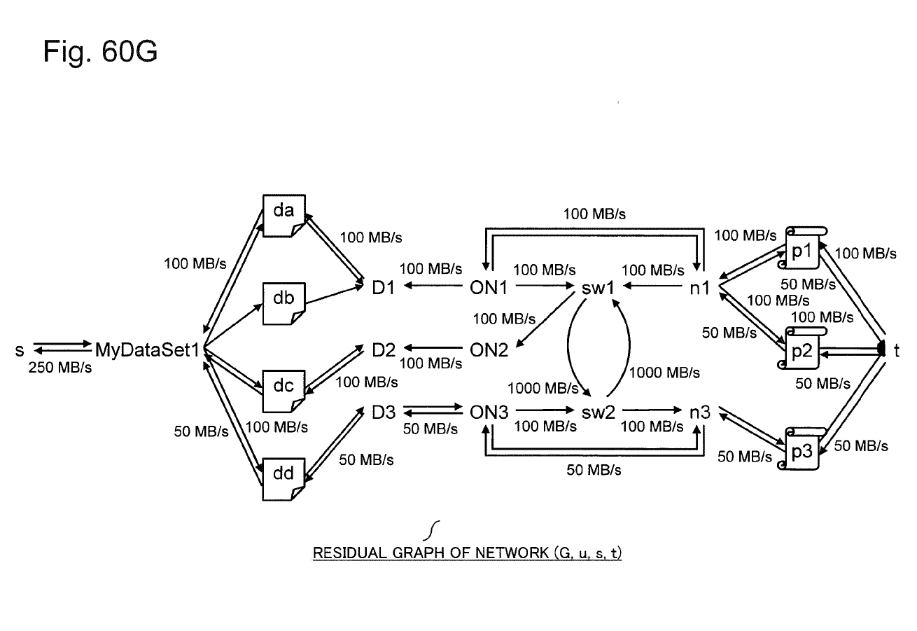

The optimum arrangement calculation unit 302 of the distributed processing management server 300 maximizes the objective function represented by Equation (1) of [Mathematical Equation 1] under the restrictions of Equation (2) and Equation (3) of [Mathematical Equation 1] based on the table of model information of FIG. 58. FIGS. 60A to 60G are diagrams exemplifying a case when this processing is performed by using the flow increase method in the maximum flow problem.

First, the optimum arrangement calculation unit 302 assumes passing a flow of 100 MB/s on a route (s, MyDataSet1, da, D1, ON1, n1, p1, t) as shown in FIG. 60B in the network (G, u, s, t) shown in FIG. 60A. Then, the optimum arrangement calculation unit 302 specifies a residual graph of the network (G, u, s, t) shown in FIG. 60C.

Next, the optimum arrangement calculation unit 302 specifies a flow increased route in the residual graph shown in FIG. 60C, and assumes passing a flow on the route. The optimum arrangement calculation unit 302 assumes passing a flow of 50 MB/s on a route (s, MyDataSet1, dd, D3, ON3, n3, p3, t) as shown in FIG. 60D based on the residual graph shown in FIG. 60C. Then, the optimum arrangement calculation unit 302 specifies the residual graph of the network (G, u, s, t) shown in FIG. 60E.

Next, the optimum arrangement calculation unit 302 specifies another flow increased route in the residual graph shown in FIG. 60E, and assumes passing a flow on the route. The optimum arrangement calculation unit 302 assumes passing a flow of 100 MB/s on a route (s, MyDataSet1, dc, D2, ON2, sw1, n1, p2, t) as shown in FIG. 60F based on the residual graph shown in FIG. 60E. Then, the optimum arrangement calculation unit 302 specifies the residual graph of the network (G, u, s, t) shown in FIG. 60G.

Referring to FIG. 60G, any more flow increased route does not exist. Therefore, the optimum arrangement calculation unit 302 ends the processing. The information about the flow and data flow rate obtained by this processing corresponds to the data-flow information.

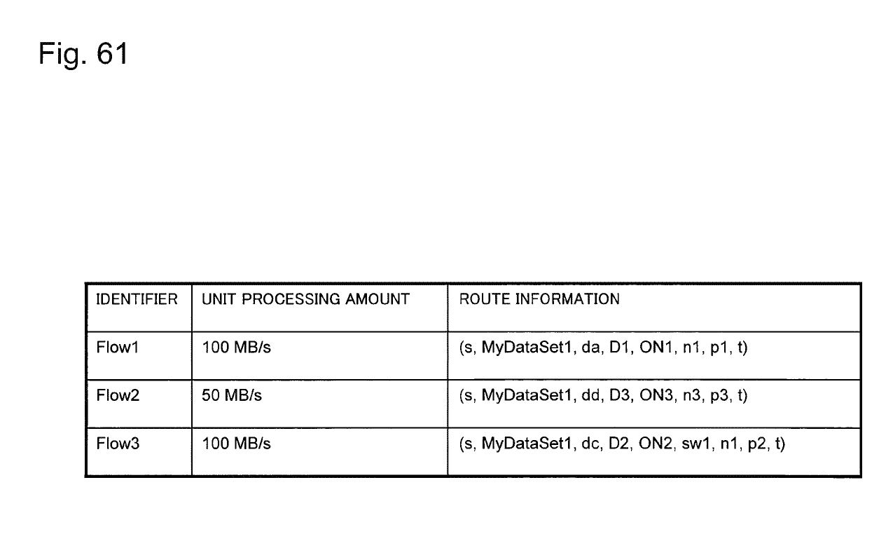

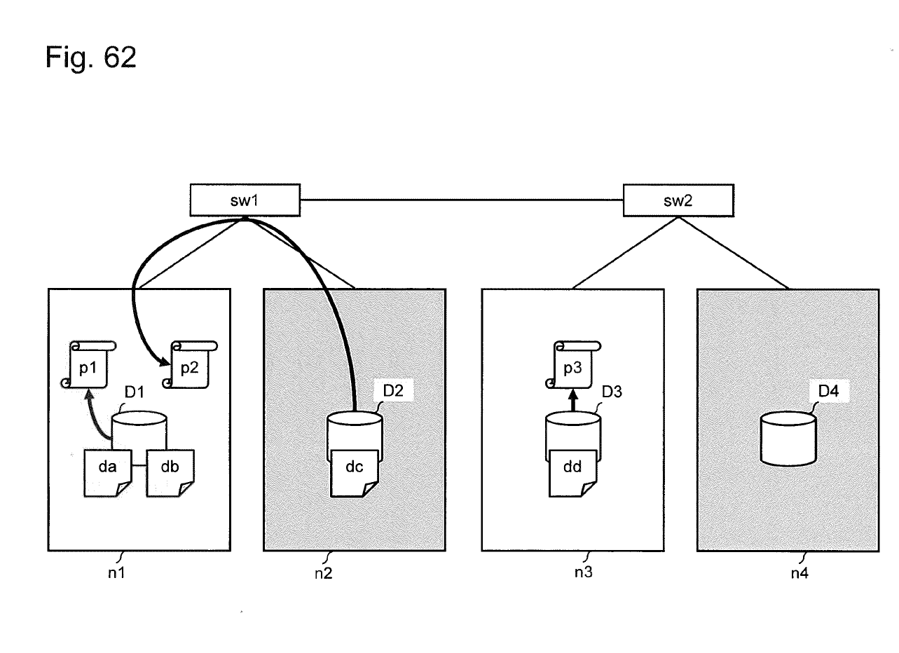

FIG. 61 shows the data-flow information obtained as the result of the maximization of the objective function. The processing allocation unit 303 of a distributed processing management server 300 transmits a processing program to n1 and n3 based on this information. The processing allocation unit 303 directs data reception and execution of processing to the processing servers n1 and n3 by transmitting the decision information for the processing program. The processing server n1, when receiving the decision information, acquires the file da from the processing data storing unit 342 of the data server n1. The processing execution unit p1 executes the processing for the acquired file da. The processing server n1 acquires the file dc from the processing data storing unit 342 of the data server n2. The processing execution unit p2 executes the processing for the acquired file dc. The processing server n3 acquires the file dd from the processing data storing unit 342 of the data server n3. The processing execution unit p3 executes the processing for the acquired file dd. FIG. 62 shows an example of data transmission/reception determined based on the data-flow information of FIG. 61.

### Specific Example of the Fourth Exemplary Embodiment

A specific example of the fourth exemplary embodiment will be described. The specific example of this exemplary embodiment will be described by showing a difference from the specific example of the first exemplary embodiment.

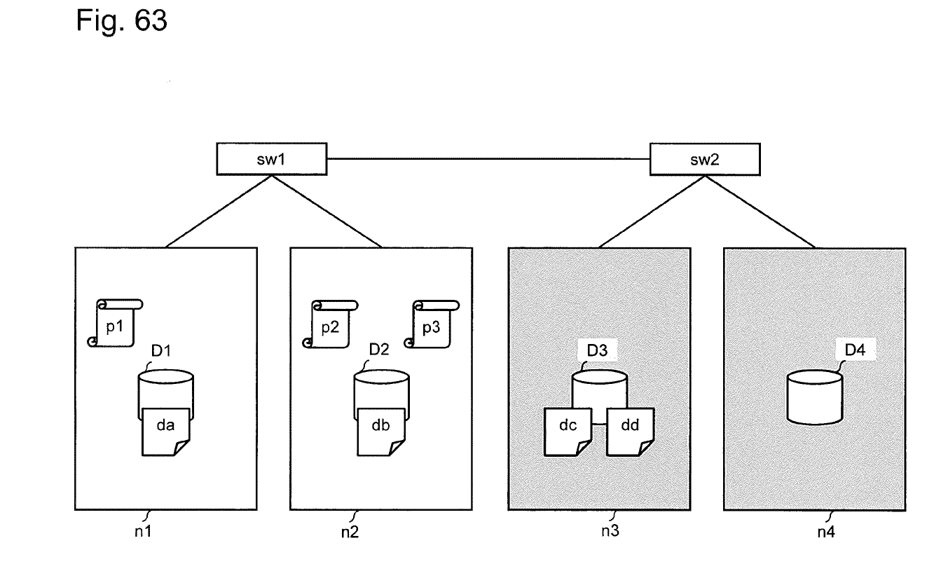

FIG. 63 shows a configuration of the distributed system 350 used in the specific example. The distributed system 350 includes servers n1 to n4 connected by switches sw1 and sw2 as well as the first exemplary embodiment.

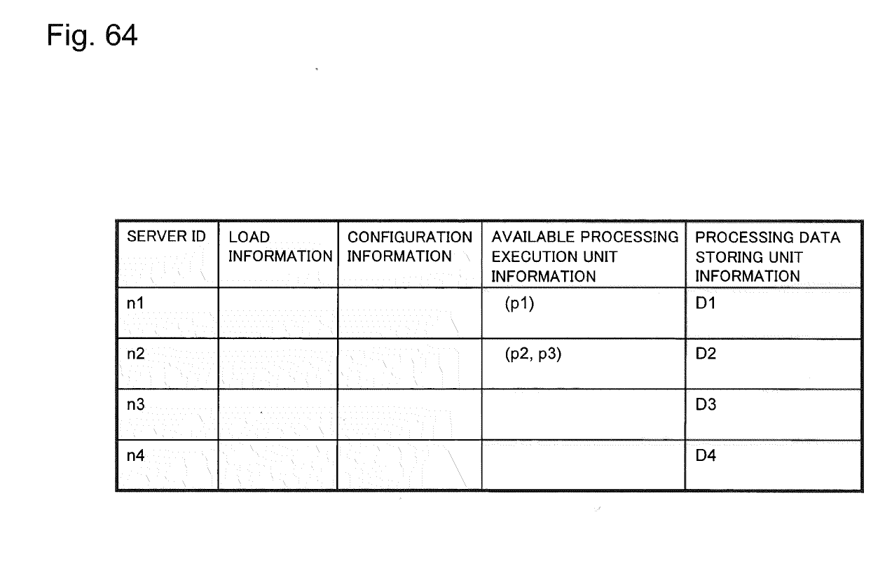

FIG. 64 shows information stored in the server status storing unit 3060 in the distributed processing management server 300. In this specific example, the processing execution unit p1 of the server n1 and the processing execution units p2 and p3 of the server n2 are available.

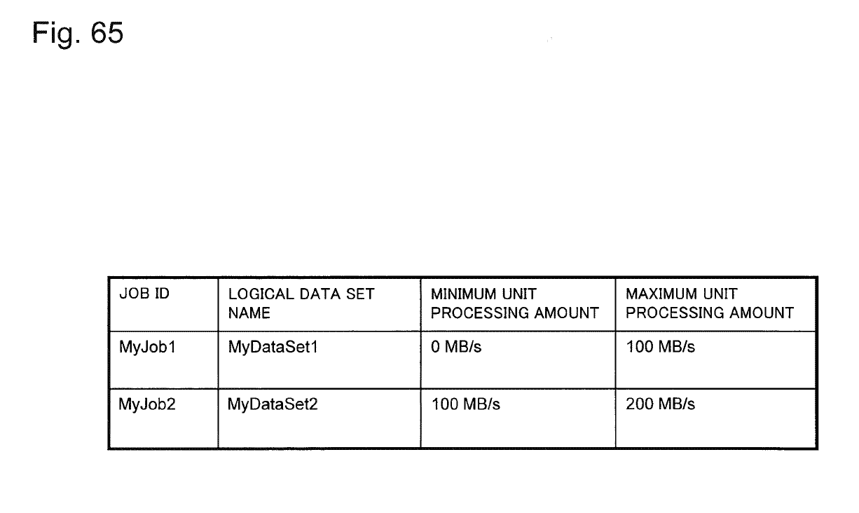

FIG. 65 shows information stored in the job information storing unit 3040 in the distributed processing management server 300. In this specific example, as a unit of executing a program, job MyJob1 and job MyJob2 are used.

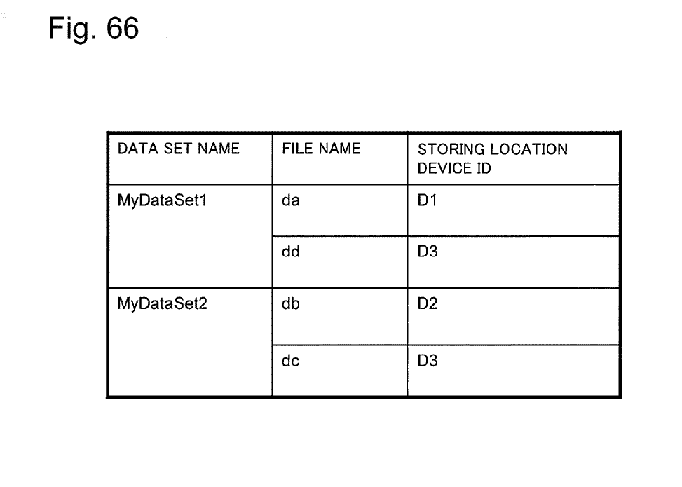

FIG. 66 shows information stored in the data location storing unit 3070 in the distributed processing management server 300. Referring to FIG. 66, the data location storing unit 3070 stores logical data sets MyDataSet1 and MyDataSet2, respectively. MyDataSet1 is divided into files da and db and MyDataSet2 is divided into dc and dd, respectively. The file da is stored in the disk D1 of the server n1, the file db is stored in the disk D2 of the server n2, and the files dc and dd are stored in the disk D3 of the server n3, respectively. MyDataSet1 and MyDataSet2 are simply arranged simply in a distributed manner without performing multiplex processing thereon.

It is assumed that the status of the input/output communication channel information storing unit 3080 in the distributed processing management server 300 used in this specific example is identical with the specific example of the first exemplary embodiment. That is, FIG. 43 shows information stored in the input/output communication channel information storing unit 3080 in the distributed processing management server 300.

It is also assumed that the statuses of the job information storing unit 3040, the server status storing unit 3060, the input/output communication channel information storing unit 3080 and the data location storing unit 3070 of the distributed processing management server 300 are as shown in FIG. 65, FIG. 64, FIG. 43 and FIG. 66, respectively, when execution of job MyJob1 using MyDataSet1 and job MyJob2 using MyDataSet2 are directed by a client.

The model generation unit 301 in the distributed processing management server 300 acquires {MyJob1, MyJob2} as a set of jobs to which execution is directed at present from the job information storing unit 3040 of FIG. 65. The model generation unit 301 acquires a logical data set name, minimum unit processing amount and maximum unit processing amount used by the job for each job.

Next, the model generation unit 301 of the distributed processing management server 300 acquires {D1, D2, D3} as a set of identifiers of devices storing data from the data location storing unit 3070 of FIG. 66. Next, the model generation unit 301 acquires {n1, n2, n3} as a set of identifiers of data servers 340 and acquires {n1, n2} as a set of identifiers of processing servers 330 from a server status storing unit 3060 of FIG. 64. The model generation unit 301 acquires {p1, p2, p3} as a set of identifiers of available processing execution units 332.

Next, the model generation unit 301 of the distributed processing management server 300 generates a network model (G, l, u, s, t) based on the set of jobs, the set of identifiers of processing servers 330, the set of identifiers of processing execution units 332, the set of identifiers of data servers 340, and the information stored in the input/output communication channel information storing unit 3080 of FIG. 43.

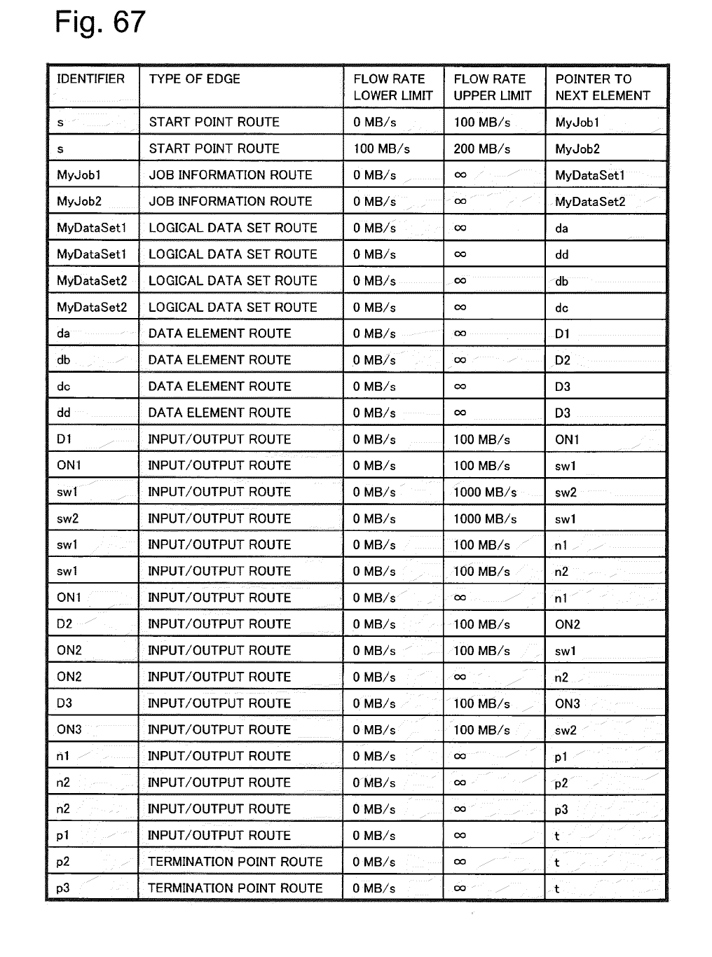

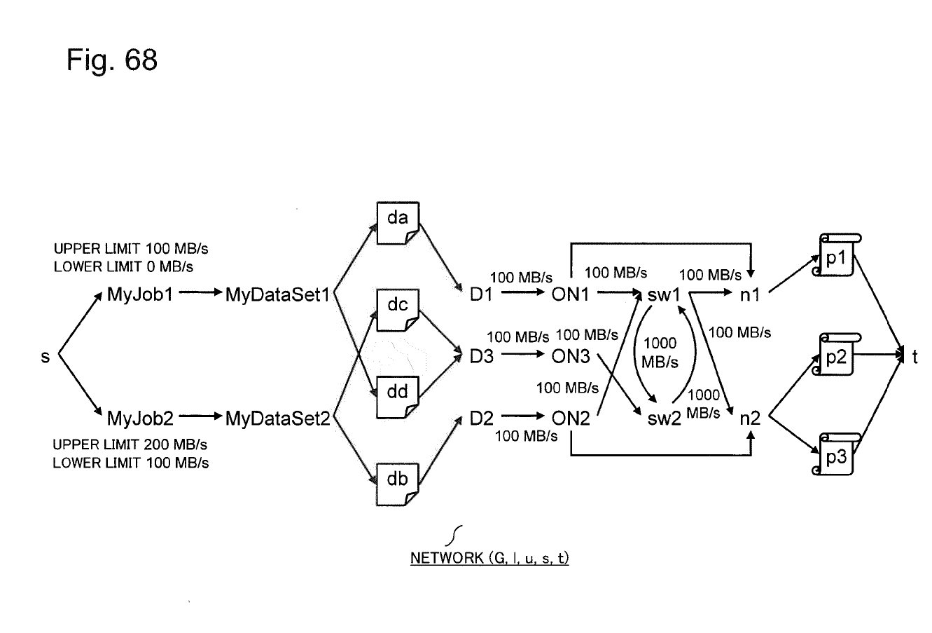

FIG. 67 shows a table of model information generated by the model generation unit 301 in this specific example. FIG. 68 shows a conceptual diagram of the network (G, l, u, s, t) shown by the table of model information in FIG. 67. The value of each edge on the network (G, 1, u, s, t) shown in FIG. 68 indicates the maximum value of the amount of data per unit time that can be sent at present on the route.

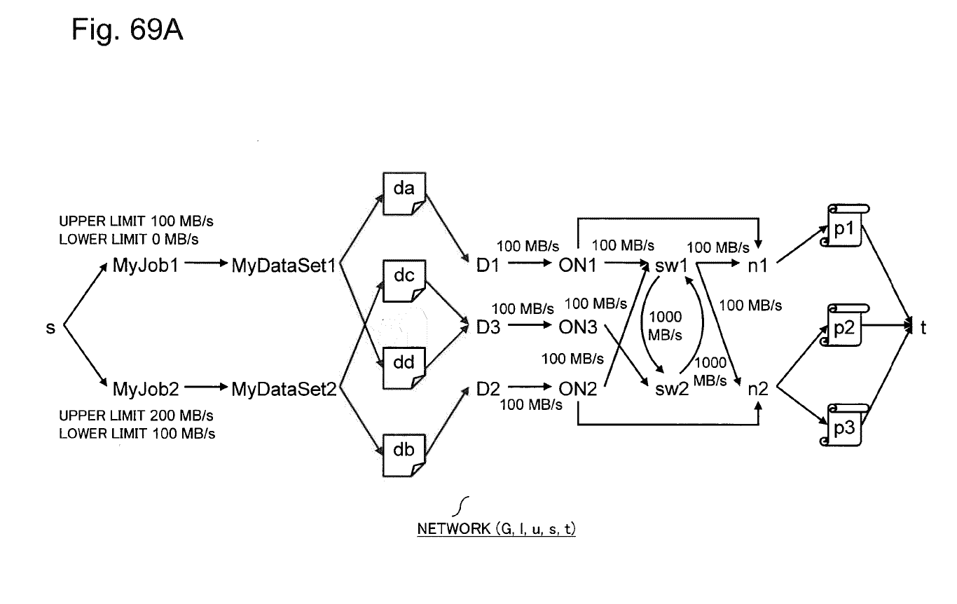

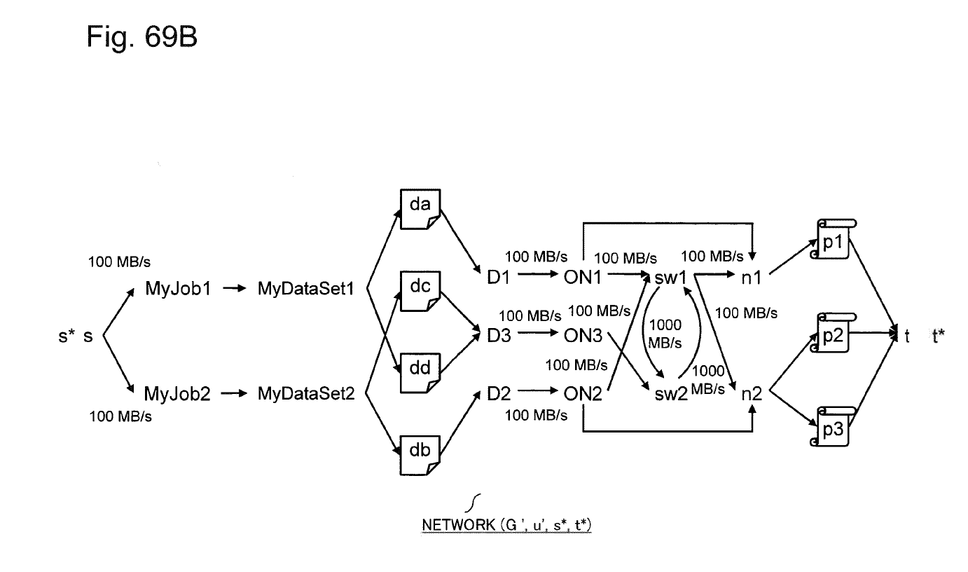

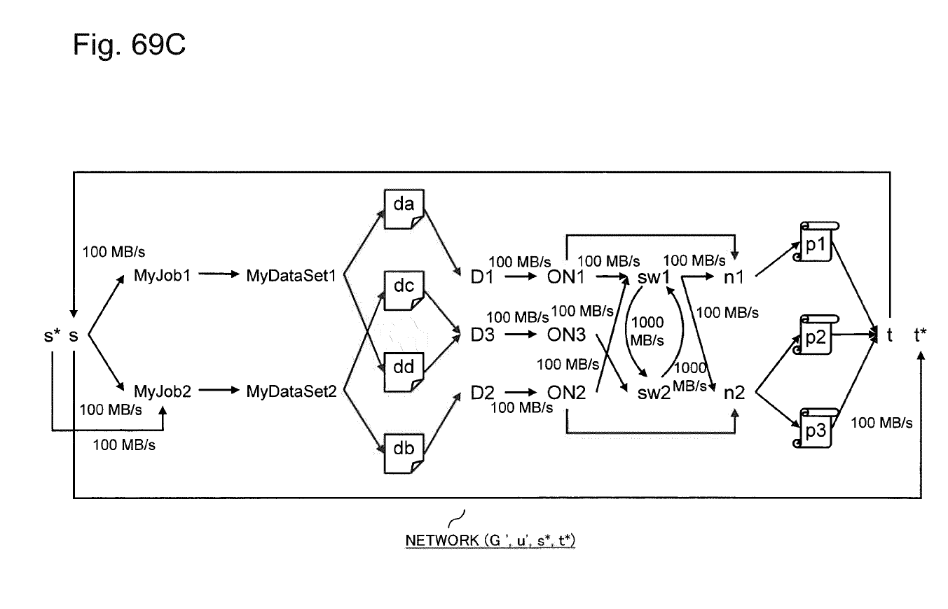

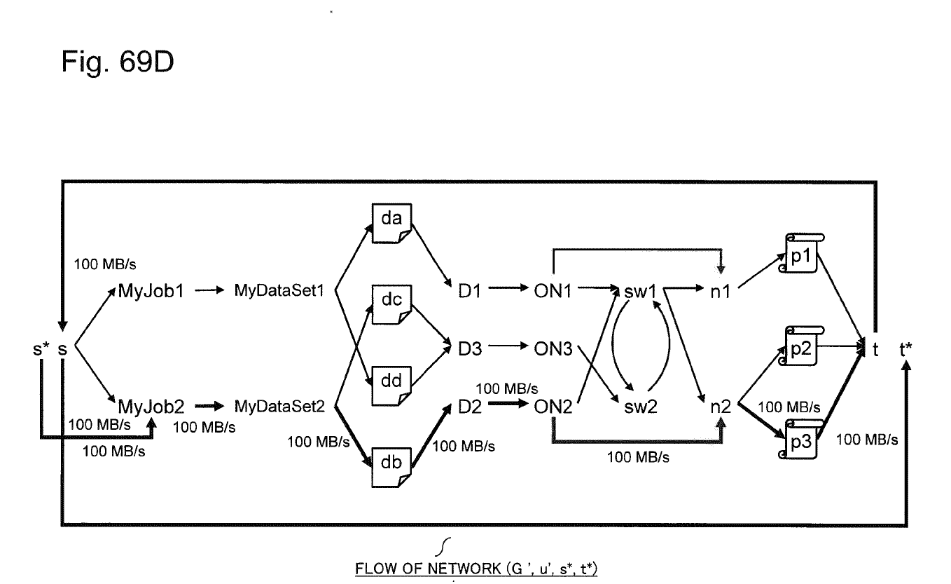

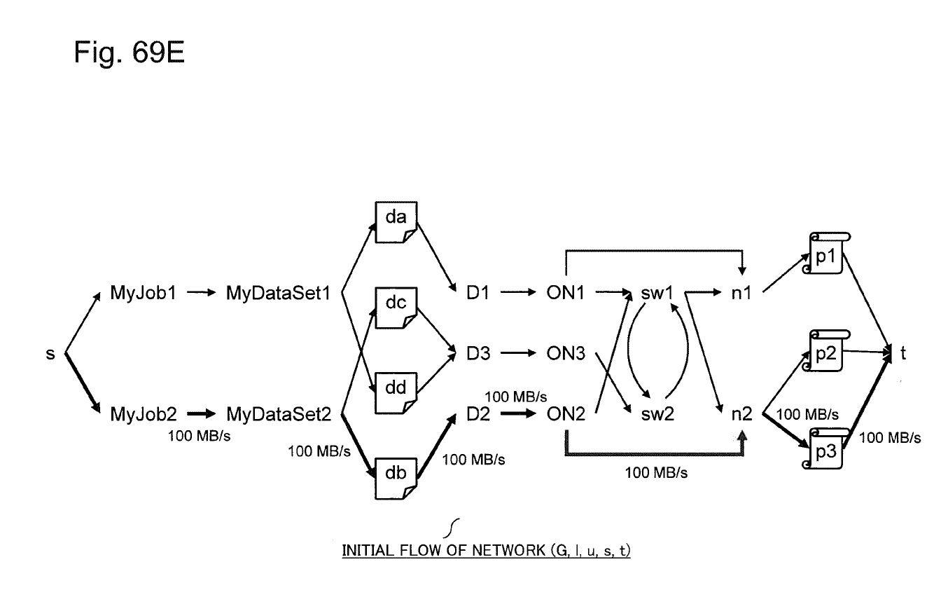

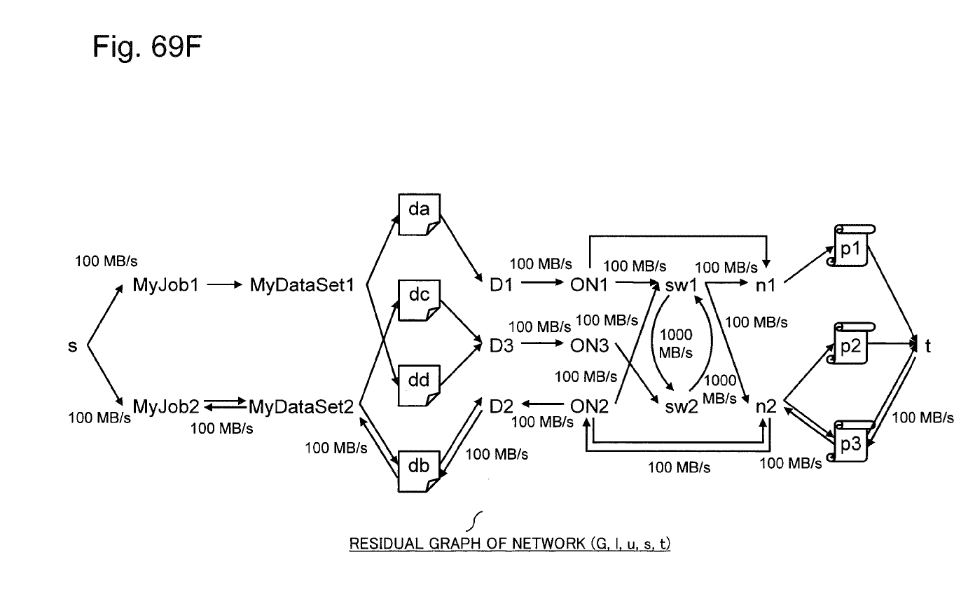

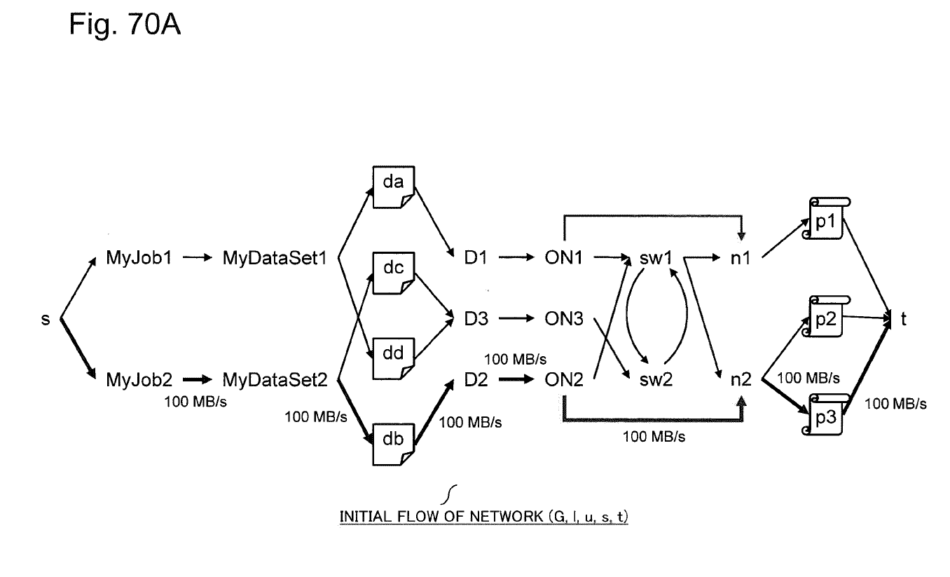

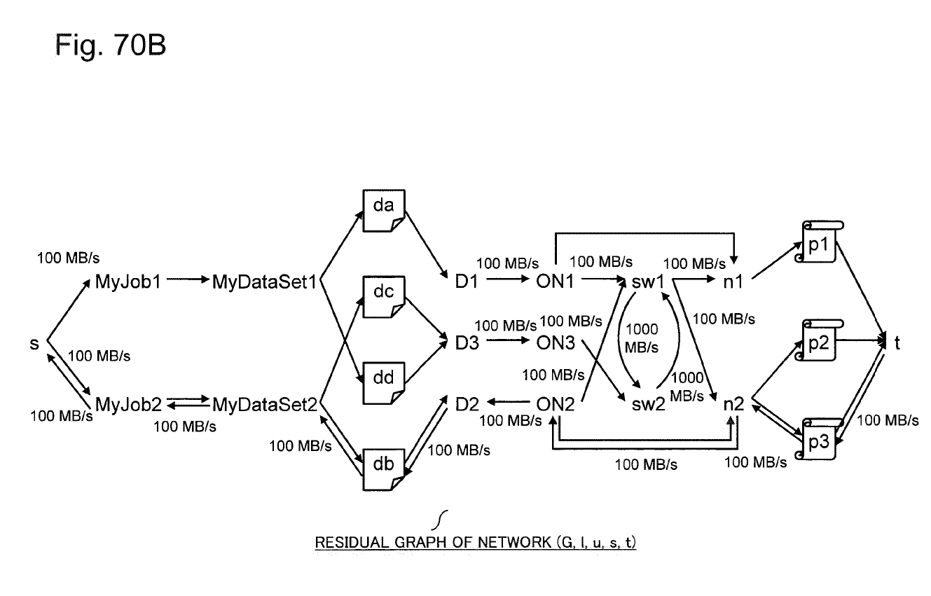

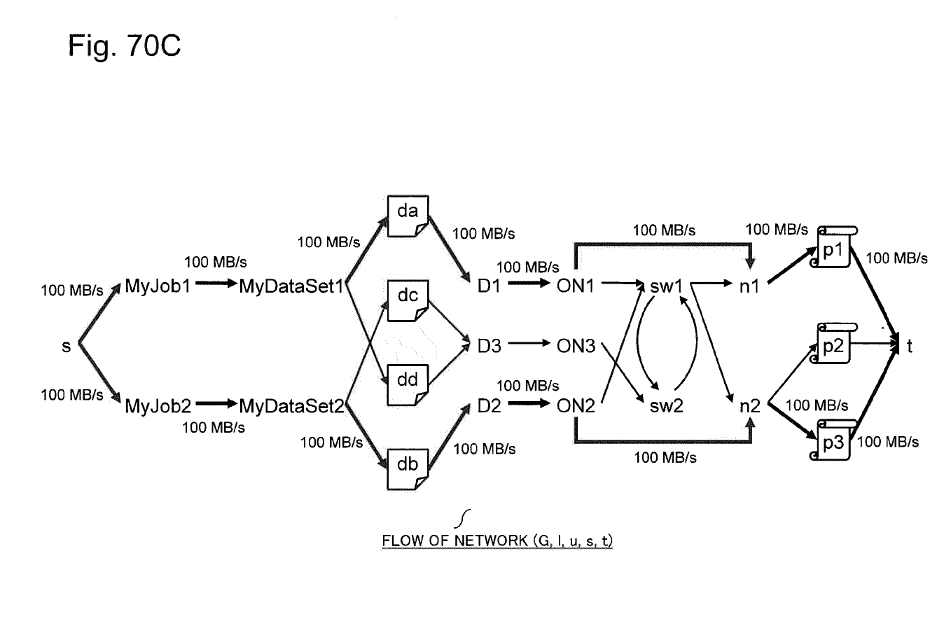

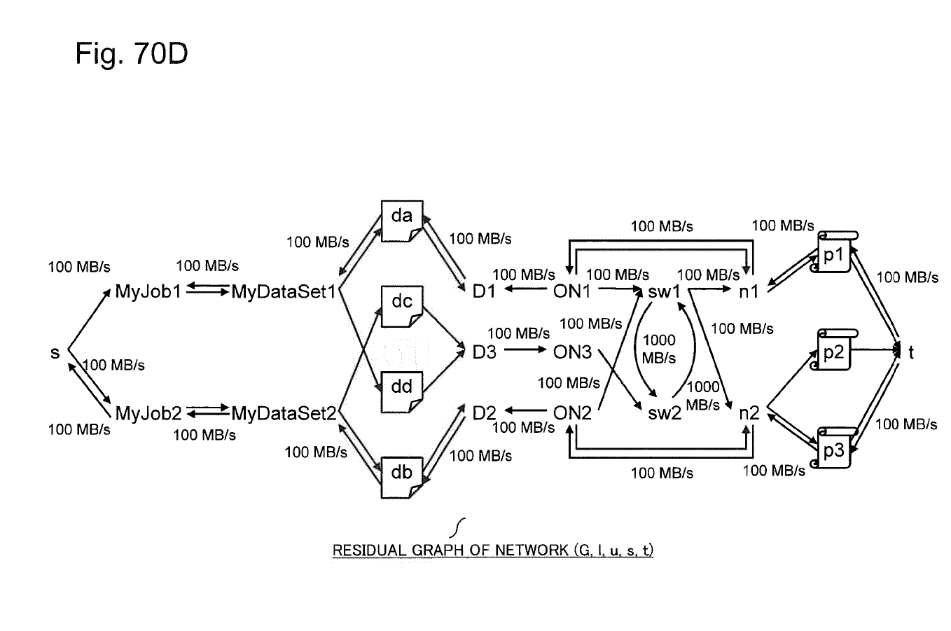

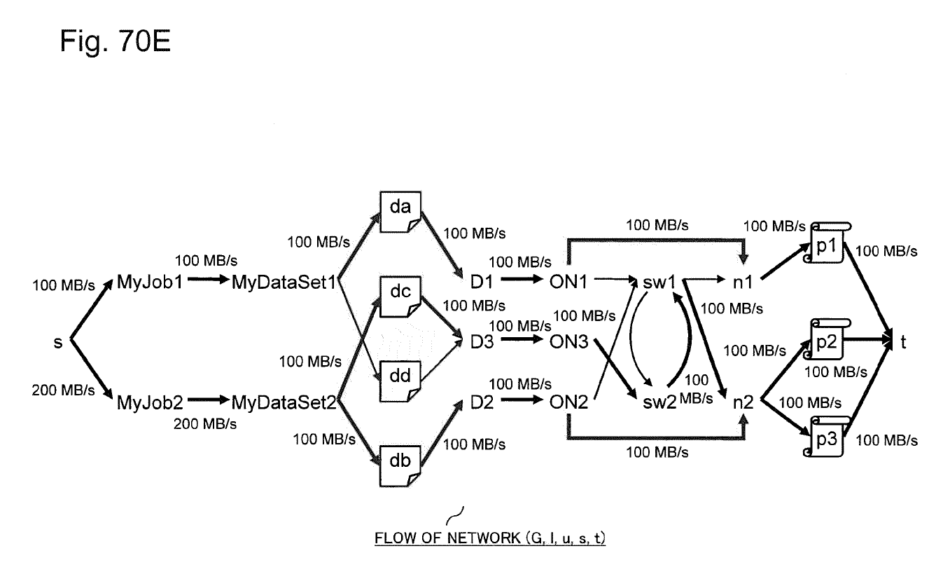

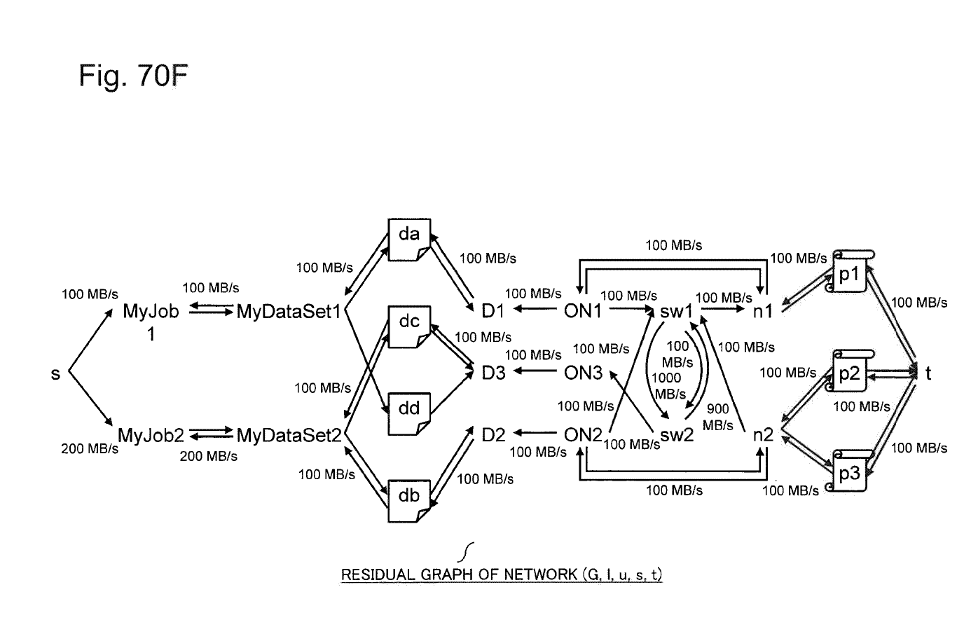

The optimum arrangement calculation unit 302 in the distributed processing management server 300 maximizes the objective function represented by Equation (1) of [Mathematical Equation 1] under the restrictions of Equation (2) and Equation (3) of [Mathematical Equation 1] based on the table of model information shown in FIG. 67. FIGS. 69A to 69F and FIGS. 70A to 70F are diagrams exemplifying a case when this processing is performed by using the flow increase method in the maximum flow problem.

FIGS. 69A to 69F are diagrams showing an example of a calculation procedure of an initial flow which satisfies the lower limit flow rate restriction.

First, the optimum arrangement calculation unit 302 sets virtual start point s* and virtual termination point t* to the network (G, l, u, s, t) shown in FIG. 69A. The optimum arrangement calculation unit 302 sets a new flow rate upper limit of the edge having flow rate restriction to a difference value of the flow rate upper limit and the flow rate lower limit before change. The optimum arrangement calculation unit 302 also sets a new flow rate lower limit of the edge to 0. The optimum arrangement calculation unit 302 acquires the network (G′, u′, s*, t*) shown in FIG. 69B by performing the above mentioned processing to the network (G, l, u, s, t).

The optimum arrangement calculation unit 302 connects between the termination point of the edge having the flow rate restriction and the virtual start point s* and between the start point of the edge having the flow rate restriction and the virtual termination point t*, respectively. Specifically, edges having a predetermined flow rate upper limit are added between above-mentioned vertexes. The predetermined flow rate upper limit is the flow rate lower limit before change which was set to the edge having flow rate restriction. The optimum arrangement calculation unit 302 also connects between the termination point t and the start point s. Specifically, an edge having a flow rate upper limit being infinity is added between the termination point t and the start point s. The optimum arrangement calculation unit 302 acquires the network (G′, u′, s*, t*) shown in FIG. 69C by performing the above mentioned processing to the network shown in FIG. 69B.

The optimum arrangement calculation unit 302 searches for s*-t*-flow in which the flow rate of the edge from s* and the flow rate of the edge to t* are saturated in the network (G′, u′, s*, t*) shown in FIG. 69C. Note that no existing of such flow indicates that there are no solutions which satisfy restriction of the lower limit flow rate in the original network. In this example, a route (s*, MyJob2, MyDataSet2, db, D2, ON2, n2, p3, t, s, t*) shown in FIG. 69D corresponds to the route.

The optimum arrangement calculation unit 302 deletes the added vertex and edge from the network (G′, u′ and s*, t*) and sets the flow rate limiting value of the edge having the flow rate restriction to the original value before change. The optimum arrangement calculation unit 302 assumes passing the flow only of the flow rate lower limit on the edge having the flow rate restriction. Specifically, the optimum arrangement calculation unit 302 leaves only an actual flow in the above-mentioned route in the network (G, l, u, s, t) shown in FIG. 69A, as shown in FIG. 69E, and specifies the route (s, MyJob2, MyDataSet2, db, D2, ON2, n2, p3, t) in which the edge having the flow rate restriction is added to the above-mentioned actual flow. The optimum arrangement calculation unit 302 assumes passing a flow of 100 MB/s on the route (s, MyJob2, MyDataSet2, db, D2, ON2, n2, p3, t). Then, the optimum arrangement calculation unit 302 specifies a residual graph of the network (G, u, s, t) shown in FIG. 69F. The route (s, MyJob2, MyDataSet2, db, D2, ON2, n2, p3, t) is an initial flow (FIG. 70A) which satisfies the lower limit flow rate restriction.

Next, the optimum arrangement calculation unit 302 specifies a flow increased route in the residual graph shown in FIG. 70B (it is similar to FIG. 69F), and assumes passing a flow on the route. The optimum arrangement calculation unit 302 assumes passing a flow of 100 MB/s on a route (s, MyJob1, MyDataSet1, da, D1, ON1, n1, p1, t) as shown in FIG. 70C based on the residual graph shown in FIG. 70B. Then, the optimum arrangement calculation unit 302 specifies the residual graph of the network (G, l, u, s, t) shown in FIG. 70D.

Next, the optimum arrangement calculation unit 302 specifies another flow increased route in the residual graph shown in FIG. 70D, and assumes passing a flow on the route. The optimum arrangement calculation unit 302 assumes passing a flow of 100 MB/s on a route (s, MyJob2, MyDataSet2, dc, D3, ON3, sw2, sw1, n2, p2, t) as shown in FIG. 70E based on the residual graph shown in FIG. 70D. Then, the optimum arrangement calculation unit 302 specifies the residual graph of the network (G, l, u, s, t) shown in FIG. 70F.

Referring to FIG. 70F, any more flow increased route does not exist. Therefore, the optimum arrangement calculation unit 302 ends the processing. The information about the flow and data flow rate obtained by this processing corresponds to the data-flow information.

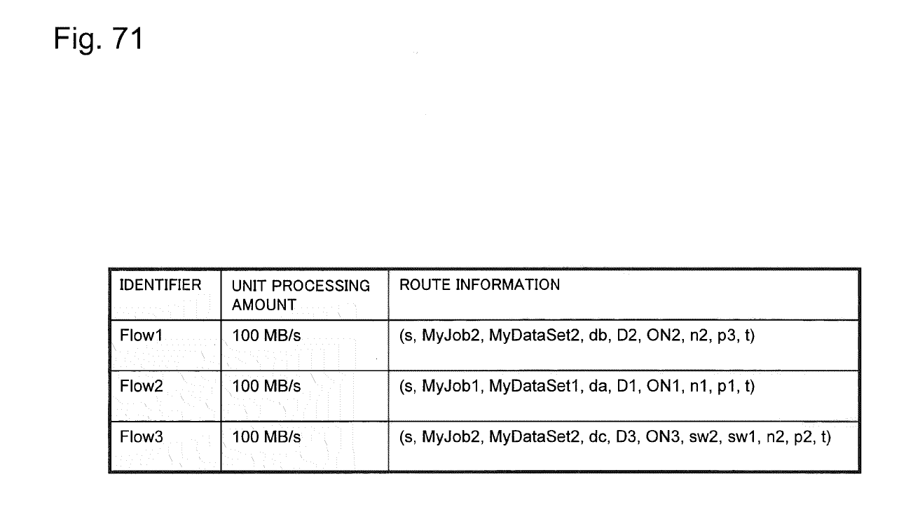

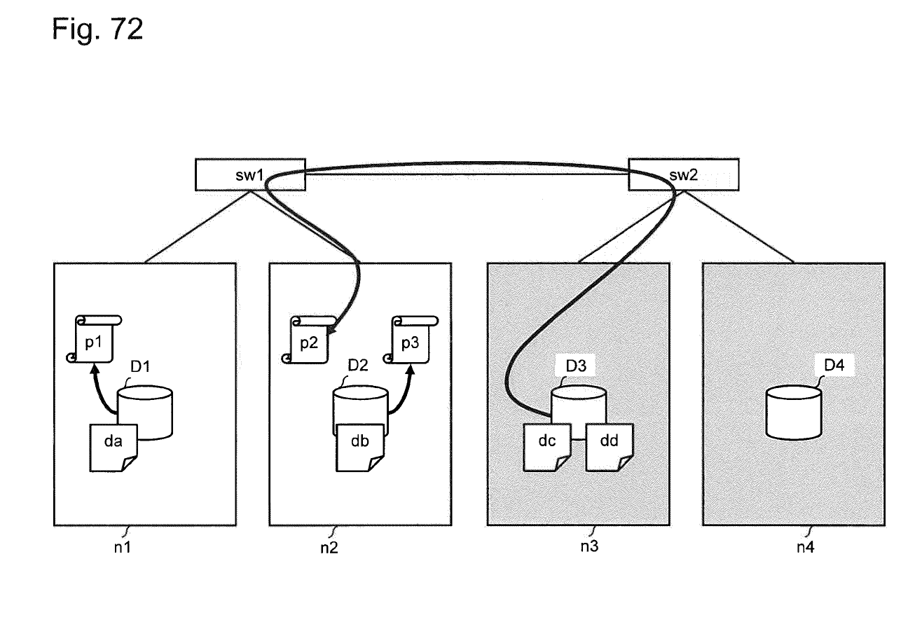

FIG. 71 shows the data-flow information obtained as the result of the maximization of the objective function. The processing allocation unit 303 of the distributed processing management server 300 transmits a processing program to n1 and n2 based on this information. The processing allocation unit 303 directs data reception and execution of processing for the processing servers n1 and n2 by transmitting the decision information for the processing program. The processing server n1, when receiving the decision information, acquires the file da from the processing data storing unit 342 of the data server n1. The processing execution unit p1 executes the processing for the acquired file da. The processing server n2 acquires the file dc from the processing data storing unit 342 of the data server n3. The processing execution unit p2 executes the processing for the acquired file dc. The processing server n2 also acquires the file db from the processing data storing unit 342 of the data server n2. The processing execution unit p3 executes the processing for the acquired file db. FIG. 72 shows an example of data transmission/reception determined based on the data-flow information of FIG. 71.

### Specific Example of Fifth Exemplary Embodiment

A specific example of the fifth exemplary embodiment will be described. The specific example of this exemplary embodiment will be described by showing a difference from the specific example of the first exemplary embodiment.

In the specific example, after the reception data allocation to the processing server 330 is performed in the specific example of the first exemplary embodiment, stored information in the input/output communication channel information storing unit 3080 is updated.

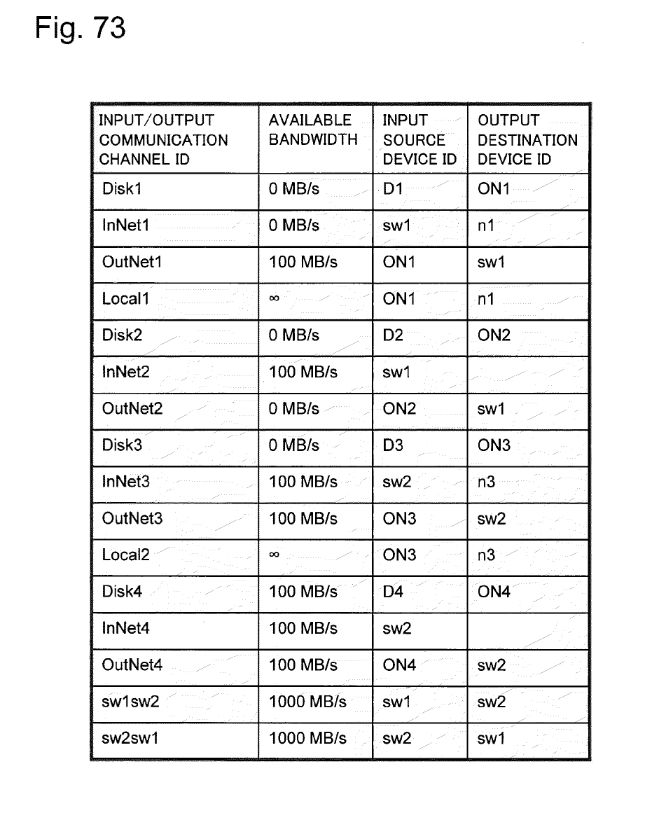

FIG. 73 shows an example of information stored by the input/output communication channel information storing unit 3080, which is updated from the data-flow information of FIG. 48, after the reception data allocation to the processing server 330 is performed by the processing allocation unit 303 of the distributed processing management server 300, in the specific example. After data transfer of 100 MB/s is directed in data-flow Flow1, the processing allocation unit 303 changes the available bandwidth of the input/output route Disk 1 connecting D1 and ON1 from 100 MB/s to 0 MB/s. Next, after data transfer of 100 MB/s is directed in data-flow Flow2, the processing allocation unit 303 changes the available bandwidth of the input/output route Disk 2 connecting D3 and ON3 from 100 MB/s to 0 MB/s. Next, after data transfer of 100 MB/s is directed in data-flow Flow3, the processing allocation unit 303 changes data as follows. First, the processing allocation unit 303 changes the available bandwidth of the input/output route Disk 3 connecting D2 and ON2 from 100 MB/s to 0 MB/s. Secondly, the processing allocation unit 303 changes the input/output route OutNet2 connecting ON2 and sw1 from 100 MB/s to 0 MB/s. Thirdly, the processing allocation unit 303 changes the available bandwidth of the input/output route InNet1 connecting sw1 and n1 from 100 MB/s to 0 MB/s.

An example of the effect of the present invention is that, in a system in which a plurality of data servers storing data and a plurality of processing servers which process the data are arranged in a distributed manner, a data transfer route which maximizes the total processing data amount of all processing servers per unit time can be determined.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

Each component in each exemplary embodiment of the present invention can be realized by a computer and a program as well as realizing the function in hardware. The program is recorded in a computer-readable recording medium such as a magnetic disk or a semiconductor memory and provided, and is read by the computer at a time of starting of the computer. This read program makes the computer function as a component in each exemplary embodiment mentioned above by controlling operation of the computer.

A part or the whole of the above-described exemplary embodiment can be described as, but not limited to, the following supplementary notes.

(Supplementary Note 1)

A distributed processing management server comprising:

a model generation means for generating a network model in which a device in a network and a piece of data to be processed is respectively represented by a node, the node representing the piece of data and the node representing a data server storing the piece of data are connected by an edge, the nodes representing the device in the network are connected by an edge, and an available bandwidth for a communication channel among the devices are set as a restriction of the edge connecting the nodes representing the devices; and

an optimum arrangement calculation means for generating, when one or more pieces of data are specified, data-flow information that indicates a route between a processing server and each of the specified pieces of data and a data-flow rate of the route to maximize a total amount of data received per unit time by at least a part of the processing servers indicated by a set of processing server identifiers, on the basis of the network model.

(Supplementary Note 2)

The distributed processing management server according to (Supplementary note 1), wherein

the model generation means generates the network model in which the node representing a start point and the node representing the piece of data are connected by an edge, the node representing a termination point and the node representing the processing server or a processing execution means which processes data in the processing server are connected by an edge, and the processing server and the processing execution means in the processing server are connected by an edge; and

the optimum arrangement calculation means generates the data-flow information by calculating the maximum amount of data per unit time that is able to be passed from the start point to the termination point.

(Supplementary Note 3)

The distributed processing management server according to (Supplementary note 1 or 2), wherein

the model generation means generates the network model in which a logical data set including one or more data elements and a data element are respectively represented by a node, and the node representing the logical data set and the node representing the data element included in the logical data set are connected by an edge; and

the optimum arrangement calculation means, when one or more logical data sets are specified, generates the data-flow information that indicates a route between the processing server and each of the specified logical data sets and a data-flow rate of the route to maximize the total amount of data received per unit time by at least a part of the processing servers indicated by the set of processing server identifiers, on the basis of the network model.

(Supplementary Note 4)

The distributed processing management server according to (Supplementary note 3) further comprising a processing allocation means for transmitting decision information indicating the piece of data to be acquired by the processing server and a data processing amount per unit time to the processing server on the basis of the data-flow information generated by the optimum arrangement calculation means, wherein

the logical data set includes one or more pieces of partial data, the piece of partial data being each of pieces of data obtained by multiplexing the piece of data, the piece of partial data including one or more data elements;

the model generation means generates the network model in which the piece of partial data including one or more data elements and the data element are respectively represented by a node, and the node representing the partial data and the node representing the data element included in the partial data are connected by an edge; and

the processing allocation means specifies the data processing amount per unit time with respect to the piece of data acquired by each processing server based on the data flow rate of the route including the node indicating one piece of partial data among routes indicated by the data-flow information.

(Supplementary Note 5)

The distributed processing management server according to any one of (Supplementary notes 1 to 4), wherein

the model generation means generates the network model in which a processing execution means in each of the processing servers and the processing server are respectively represented by a node, the node representing the processing server and the node representing the processing execution means included in the processing server are connected by an edge, the node representing the processing execution means and the node representing the termination point are connected by an edge, and a value of a data processing amount per unit time processed by the processing execution means is set as a restriction of the edge connecting the node representing the processing execution means and the node representing the termination point.

(Supplementary Note 6)

The distributed processing management server according to (Supplementary note 2), wherein

the model generation means generates the network model in which one or more jobs associated with the logical data set are respectively represented by a node, the node representing the job and the node representing the logical data set associated with the job are connected by an edge, the node representing the start point and the node representing each of the jobs are connected by an edge, and at least one of a maximum value and a minimum value of a data processing amount per unit time allocated to the job is set as a restriction of the edge connecting the node representing the start point and the node representing the job.

(Supplementary Note 7)

The distributed processing management server according to (Supplementary note 1 or 2) further comprising a processing allocation means for transmitting decision information indicating the piece of data to be acquired by the processing server and a data processing amount per unit time to the processing server on the basis of the data-flow information generated by the optimum arrangement calculation means, wherein

the processing allocation means subtracts data flow rate in each route indicated by the data-flow information from the available bandwidth on the route, and updates the available bandwidth used by the model generation means by setting the value of the subtracted result as a new available bandwidth on the route.

(Supplementary Note 8)

The distributed processing management server according to (Supplementary note 6), wherein

the model generation means generates the network model in which, as a restriction of the edge on which at least one of a maximum value and a minimum value of a data processing amount per unit time allocated to the job is set, the difference of the maximum value and the minimum value is set as an upper limit and 0 is set as a lower limit, respectively, the node representing a virtual start point and the node representing the job is connected by a virtual edge, the minimum value is set as a restriction of the virtual edge, the node representing the start point and the node representing a virtual termination point are connected by an edge, the minimum value is set as a restriction of the edge connecting the node representing the start point and the node representing the virtual termination point, and the termination point and the start point are connected by an edge; and

the optimum arrangement calculation means specifies a flow on which data flow rate of the edge from the virtual start point and data flow rate of the edge to the virtual termination point are saturated based on the network model, and generates a flow except for the edge between the node representing the virtual start point and the node representing the job, the edge between the node representing the start point and the node representing the virtual termination point, and the edge between the node representing the termination point and the node representing the start point, as an initial flow to be included in the data-flow information.

(Supplementary Note 9)

The distributed processing management server according to any one of (Supplementary notes 1 to 8), wherein

the model generation means sets a minimum unit processing amount and a maximum unit processing amount stored in a band limit information storing means on the edge connecting the nodes representing the devices in the network, as a restriction, the band limit information storing means storing device identifications indicating nodes connected by an edge respectively, the minimum unit processing amount and the maximum unit processing amount set on the edge as a restriction, in association with each other.

(Supplementary Note 10)

The distributed processing management server according to (Supplementary note 3), wherein

the model generation means sets a minimum unit processing amount and a maximum unit processing amount stored in a band limit information storing means on the edge connecting the node representing the logical data set and the node representing the data element included in the logical data set, as a restriction, the band limit information storing means storing identifications of the logical data set and the data element connected by an edge, the minimum unit processing amount and the maximum unit processing amount set on the edge as a restriction, in association with each other.

(Supplementary Note 11)

A distributed system comprising:

a data server for storing a piece of data;

a processing server for processing the piece of data; and

a distributed processing management server, wherein

the distributed processing management server includes:

a model generation means for generating a network model in which a device in a network and the piece of data to be processed is respectively represented by a node, the node representing the piece of data and the node representing the data server storing the piece of data are connected by an edge, the nodes representing the device in the network are connected by an edge, and an available bandwidth for a communication channel among the devices are set as a restriction of the edge connecting the nodes representing the devices;

an optimum arrangement calculation means for generating, when one or more pieces of data are specified, data-flow information that indicates a route between the processing server and each of the specified pieces of data and a data-flow rate of the route to maximize a total amount of data received per unit time by at least a part of the processing servers indicated by a set of processing server identifiers, on the basis of the network model; and

a processing allocation means for transmitting decision information indicating the piece of data to be acquired by the processing server and a data processing amount per unit time to the processing server on the basis of the data-flow information generated by the optimum arrangement calculation means,

the processing server includes a processing execution means for receiving the piece of data specified by the decision information from the data server via a route based on the decision information, with a speed indicated by a data amount per unit time based on the decision information, and executing the received piece of data, and

the data server includes a processing data storing means for storing the piece of data.

(Supplementary Note 12)

A distributed processing management method comprising:

generating a network model in which a device in a network and a piece of data to be processed is respectively represented by a node, the node representing the piece of data and the node representing a data server storing the piece of data are connected by an edge, the nodes representing the device in the network are connected by an edge, and an available bandwidth for a communication channel among the devices are set as a restriction of the edge connecting the nodes representing the devices; and

generating, when one or more pieces of data are specified, data-flow information that indicates a route between a processing server and each of the specified pieces of data and a data-flow rate of the route to maximize a total amount of data received per unit time by at least a part of the processing servers indicated by a set of processing server identifiers, on the basis of the network model.

(Supplementary Note 13)

A computer readable storage medium recording thereon a distributed processing management program, causing a computer to perform a method comprising:

generating a network model in which a device in a network and a piece of data to be processed is respectively represented by a node, the node representing the piece of data and the node representing a data server storing the piece of data are connected by an edge, the nodes representing the device in the network are connected by an edge, and an available bandwidth for a communication channel among the devices are set as a restriction of the edge connecting the nodes representing the devices; and

generating, when one or more pieces of data are specified, data-flow information that indicates a route between a processing server and each of the specified pieces of data and a data-flow rate of the route to maximize a total amount of data received per unit time by at least a part of the processing servers indicated by a set of processing server identifiers, on the basis of the network model.

This application is based upon and claims the benefit of priority from Japanese Patent Application No. 2011-168203, filed on Aug. 1, 2011, the disclosure of which is incorporated herein in its entirety by reference.

### INDUSTRIAL APPLICABILITY

The distributed processing management server according to the present invention is applicable to a distributed system in which data stored in a plurality of data servers are processed in parallel by a plurality of processing servers. The distributed processing management server according to the present invention is also applicable to a database system and a batch processing system which perform distributed processing.

### REFERENCE SIGNS LIST

101, 102, 103 switch
111, 112 computer
121, 122 rack
131, 132 data center
141 inter-base communication network
202, 203 switch.
204, 205, 206 memory disk
207, 208, 209, 221 computer.
210, 211, 212, 213 data to be processed
214, 215, 216 process
217, 218, 219, 230, 231, 232 data transmission/reception route
220 table
300 distributed processing management server
301 model generation unit
302 optimum arrangement calculation unit
303 processing allocation unit
320 network switch
321 switch management unit
322 data transmission/reception unit
330 processing server
331 processing server management unit
332 processing execution unit
333 processing program storing unit
334 data transmission/reception unit
340 data server
341 data server management unit
342 processing data storing unit
343 data transmission/reception unit
350 distributed system
360 client
370 network
399 other server
3040 job information storing unit
3041 job ID
3042 logical data set name
3043 minimum unit processing amount
3044 maximum unit processing amount
3060 server status storing unit
3061 server ID
3062 load information
3063 configuration information
3064 available processing execution unit information
3065 processing data storing unit information
3070 data location storing unit
3071 logical data set name
3072 partial data name
3073 distributed form
3074 data description
3075 data element ID
3076 device ID
3077 partial data name
3078 size
3080 input/output communication channel information storing unit
3081 input/output route ID
3082 available bandwidth
3083 input source device ID
3084 output destination device ID
3090 band limit information storing unit
3091 input source device ID
3092 output destination device ID
3093 minimum unit processing amount
3094 maximum unit processing amount
3100 band limit information storing unit
3101 logical data set name
3102 data element name
3103 minimum unit processing amount
3104 maximum unit processing amount
500 table of model information
600 distributed processing management server
601 model generation unit
602 optimum arrangement calculation unit
630 processing server
640 data server
650 distributed system
670 network
691 CPU
692 communication I/F
693 memory
694 storage device
695 input device
696 output device
697 bus
698 recording medium

1. A distributed processing management server comprising:
a model generation unit which generates a network model in which a device in a network and a piece of data to be processed is respectively represented by a node, the node representing the piece of data and the node representing a data server storing the piece of data are connected by an edge, the nodes representing the device in the network are connected by an edge, and an available bandwidth for a communication channel among the devices are set as a restriction of the edge connecting the nodes representing the devices; and
an optimum arrangement calculation unit which generates, when one or more pieces of data are specified, data-flow information that indicates a route between a processing server and each of the specified pieces of data and a data-flow rate of the route to maximize a total amount of data received per unit time by at least a part of the processing servers indicated by a set of processing server identifiers, on the basis of the network model.

2. The distributed processing management server according to claim 1, wherein
the model generation unit generates the network model in which the node representing a start point and the node representing the piece of data are connected by an edge, the node representing a termination point and the node representing the processing server or a processing execution unit which processes data in the processing server are connected by an edge, and the processing server and the processing execution unit in the processing server are connected by an edge; and
the optimum arrangement calculation unit generates the data-flow information by calculating the maximum amount of data per unit time that is able to be passed from the start point to the termination point.

3. The distributed processing management server according to claim 1, wherein
the model generation unit generates the network model in which a logical data set including one or more data elements and a data element are respectively represented by a node, and the node representing the logical data set and the node representing the data element included in the logical data set are connected by an edge; and
the optimum arrangement calculation unit, when one or more logical data sets are specified, generates the data-flow information that indicates a route between the processing server and each of the specified logical data sets and a data-flow rate of the route to maximize the total amount of data received per unit time by at least a part of the processing servers indicated by the set of processing server identifiers, on the basis of the network model.

4. The distributed processing management server according to claim 3 further comprising a processing allocation unit which transmits decision information indicating the piece of data to be acquired by the processing server and a data processing amount per unit time to the processing server on the basis of the data-flow information generated by the optimum arrangement calculation unit, wherein
the logical data set includes one or more pieces of partial data, the piece of partial data being each of pieces of data obtained by multiplexing the piece of data, the piece of partial data including one or more data elements;
the model generation unit generates the network model in which the piece of partial data including one or more data elements and the data element are respectively represented by a node, and the node representing the partial data and the node representing the data element included in the partial data are connected by an edge; and
the processing allocation unit specifies the data processing amount per unit time with respect to the piece of data acquired by each processing server based on the data flow rate of the route including the node indicating one piece of partial data among routes indicated by the data-flow information.

5. The distributed processing management server according to claim 1, wherein
the model generation unit generates the network model in which a processing execution unit in each of the processing servers and the processing server are respectively represented by a node, the node representing the processing server and the node representing the processing execution unit included in the processing server are connected by an edge, the node representing the processing execution unit and the node representing the termination point are connected by an edge, and a value of a data processing amount per unit time processed by the processing execution unit is set as a restriction of the edge connecting the node representing the processing execution unit and the node representing the termination point.

6. The distributed processing management server according to claim 2, wherein
the model generation unit generates the network model in which one or more jobs associated with the logical data set are respectively represented by a node, the node representing the job and the node representing the logical data set associated with the job are connected by an edge, the node representing the start point and the node representing each of the jobs are connected by an edge, and at least one of a maximum value and a minimum value of a data processing amount per unit time allocated to the job is set as a restriction of the edge connecting the node representing the start point and the node representing the job.

7. The distributed processing management server according to claim 1 further comprising a processing allocation unit which transmits decision information indicating the piece of data to be acquired by the processing server and a data processing amount per unit time to the processing server on the basis of the data-flow information generated by the optimum arrangement calculation unit, wherein
the processing allocation unit subtracts data flow rate in each route indicated by the data-flow information from the available bandwidth on the route, and updates the available bandwidth used by the model generation unit by setting the value of the subtracted result as a new available bandwidth on the route.

8. The distributed processing management server according to claim 6, wherein
the model generation unit generates the network model in which, as a restriction of the edge on which at least one of a maximum value and a minimum value of a data processing amount per unit time allocated to the job is set, the difference of the maximum value and the minimum value is set as an upper limit and 0 is set as a lower limit, respectively, the node representing a virtual start point and the node representing the job is connected by a virtual edge, the minimum value is set as a restriction of the virtual edge, the node representing the start point and the node representing a virtual termination point are connected by an edge, the minimum value is set as a restriction of the edge connecting the node representing the start point and the node representing the virtual termination point, and the termination point and the start point are connected by an edge; and
the optimum arrangement calculation unit specifies a flow on which data flow rate of the edge from the virtual start point and data flow rate of the edge to the virtual termination point are saturated based on the network model, and generates a flow except for the edge between the node representing the virtual start point and the node representing the job, the edge between the node representing the start point and the node representing the virtual termination point, and the edge between the node representing the termination point and the node representing the start point, as an initial flow to be included in the data-flow information.

9. A distributed system comprising:
a data server which stores a piece of data;
a processing server which processes the piece of data; and
a distributed processing management server, wherein
the distributed processing management server includes:
a model generation unit which generates a network model in which a device in a network and the piece of data to be processed is respectively represented by a node, the node representing the piece of data and the node representing the data server storing the piece of data are connected by an edge, the nodes representing the device in the network are connected by an edge, and an available bandwidth for a communication channel among the devices are set as a restriction of the edge connecting the nodes representing the devices;
an optimum arrangement calculation unit which generates, when one or more pieces of data are specified, data-flow information that indicates a route between the processing server and each of the specified pieces of data and a data-flow rate of the route to maximize a total amount of data received per unit time by at least a part of the processing servers indicated by a set of processing server identifiers, on the basis of the network model; and
a processing allocation unit which transmits decision information indicating the piece of data to be acquired by the processing server and a data processing amount per unit time to the processing server on the basis of the data-flow information generated by the optimum arrangement calculation unit,
the processing server includes a processing execution unit which receives the piece of data specified by the decision information from the data server via a route based on the decision information, with a speed indicated by a data amount per unit time based on the decision information, and executes the received piece of data, and
the data server includes a processing data storing unit which stores the piece of data.

10. A distributed processing management method comprising:
generating a network model in which a device in a network and a piece of data to be processed is respectively represented by a node, the node representing the piece of data and the node representing a data server storing the piece of data are connected by an edge, the nodes representing the device in the network are connected by an edge, and an available bandwidth for a communication channel among the devices are set as a restriction of the edge connecting the nodes representing the devices; and
generating, when one or more pieces of data are specified, data-flow information that indicates a route between a processing server and each of the specified pieces of data and a data-flow rate of the route to maximize a total amount of data received per unit time by at least a part of the processing servers indicated by a set of processing server identifiers, on the basis of the network model.

11. A distributed processing management server comprising:
a model generation means for generating a network model in which a device in a network and a piece of data to be processed is respectively represented by a node, the node representing the piece of data and the node representing a data server storing the piece of data are connected by an edge, the nodes representing the device in the network are connected by an edge, and an available bandwidth for a communication channel among the devices are set as a restriction of the edge connecting the nodes representing the devices; and
an optimum arrangement calculation means for generating, when one or more pieces of data are specified, data-flow information that indicates a route between a processing server and each of the specified pieces of data and a data-flow rate of the route to maximize a total amount of data received per unit time by at least a part of the processing servers indicated by a set of processing server identifiers, on the basis of the network model.

12. A distributed system comprising:
a data server for storing a piece of data;
a processing server for processing the piece of data; and
a distributed processing management server, wherein
the distributed processing management server includes:
a model generation means for generating a network model in which a device in a network and the piece of data to be processed is respectively represented by a node, the node representing the piece of data and the node representing the data server storing the piece of data are connected by an edge, the nodes representing the device in the network are connected by an edge, and an available bandwidth for a communication channel among the devices are set as a restriction of the edge connecting the nodes representing the devices;
an optimum arrangement calculation means for generating, when one or more pieces of data are specified, data-flow information that indicates a route between the processing server and each of the specified pieces of data and a data-flow rate of the route to maximize a total amount of data received per unit time by at least a part of the processing servers indicated by a set of processing server identifiers, on the basis of the network model; and
a processing allocation means for transmitting decision information indicating the piece of data to be acquired by the processing server and a data processing amount per unit time to the processing server on the basis of the data-flow information generated by the optimum arrangement calculation means,
the processing server includes a processing execution means for receiving the piece of data specified by the decision information from the data server via a route based on the decision information, with a speed indicated by a data amount per unit time based on the decision information, and executing the received piece of data, and
the data server includes a processing data storing means for storing the piece of data.
